(19) United States
(12) Patent Application Publication
(10) Pub. No.: US 2026/0226290 A1
(43) Pub. Date: Aug. 6, 2026

(54) ARTICLE, AND METHOD OF PRODUCING ARTICLE

(71) Applicant: AGC Inc., Tokyo (JP)

(72) Inventors: Masayuki HARAGUCHI, Tokyo (JP); Kohei YASUDA, Tokyo (JP); Masako TADA, Tokyo (JP)

(73) Assignee: AGC Inc., Tokyo (JP)

(21) Appl. No.: 19/636,052

(22) Filed: Apr. 1, 2026

Related U.S. Application Data
(63) Continuation of application No. PCT/JP2024/035859, filed on Oct. 7, 2024.

(30) Foreign Application Priority Data
Oct. 6, 2023 (JP) 2023-174764

(51) Int. Cl. C09D 5/16; C08G 77/54; C09D 183/14

(52) U.S. Cl. CPC C09D 5/1675; C08G 77/54; C09D 183/14

(57) ABSTRACT

An article that includes a substrate, and a surface treatment layer arranged on the substrate and having a surface treated with a surface treatment agent, wherein the surface treatment layer has a surface roughness Sdr of 30% or larger within a measurement area of any of 5 to 50 μm squares, and the surface treatment agent contains a compound having a chain group and a reactive silyl group.

### CROSS-REFERENCE TO RELATED APPLICATION

This application is a Continuation of International Application No. PCT/JP2024/035859, filed Oct. 7, 2024, which claims priority to Japanese Patent Application No. 2023-174764 filed Oct. 6, 2023. Each of the above applications is hereby expressly incorporated by reference, in its entirety, into the present application.

### TECHNICAL FIELD

The present disclosure relates to an article, and a method of producing the article.

### BACKGROUND ART

In order to improve appearance or performances including visibility, there is a demand in recent years for a technique of making the surface of an article less likely to catch fingerprint, or easy to clean dirt. As specific methods, there is a known method of treating the surface of article, with use of a surface treatment agent.

For example, Patent Document 1 describes an article that includes a substrate, and a layer formed of a composition that contains a siloxane group-containing silane compound, formed on the substrate.

### PRIOR ART DOCUMENT

### Patent Document

Patent Document 1: WO 2023/017830 A

### SUMMARY OF THE INVENTION

### Technical Problem

There is a demand for improving liquid repellency of a surface treatment layer formed with use of the surface treatment agent.

The present disclosure has been made in view of such circumstances, in which a problem to be solved by an embodiment of the present invention relates to provide an article having a surface treatment layer that excels in liquid repellency, and a method of producing the article.

### Solution to Problem

The present disclosure includes the following aspects.

<1>

An article that includes a substrate, and a surface treatment layer arranged on the substrate and having a surface treated with a surface treatment agent, wherein
the surface treatment layer has a surface roughness Sdr of 30% or larger within any measurement area of from 5 to 50 μm squares, and
the surface treatment agent contains a compound having a chain group and a reactive silyl group.
   <2>

The article according to <1>, wherein the compound having a chain group and a reactive silyl group is a compound having a linear organo(poly)siloxane residue and a reactive silyl group.

<3>

The article according to <1> or <2>, wherein the reactive silyl group is represented by the following formula (S1) or (S3) below:

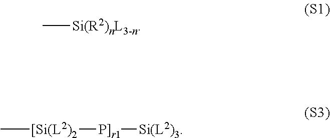

In formula (S1),
each R² independently represents a hydrocarbon group;
each L independently represents a hydrolyzable group, a group having a hydrolyzable group, or a hydroxy group; and
n represents an integer from 0 to 2.

In formula (S3),
each L² independently represents a hydrolyzable group, a group having a hydrolyzable group, hydroxy group, or hydrocarbon group;
each of at least four L²s among all L²s represents a hydrolyzable group, a group having a hydrolyzable group, or a hydroxy group; and
each P independently represents an oxygen atom, or an organic group having one carbon atom bonded to both neighboring Si; and
r1 represents an integer from 1 to 3.
   <4>

The article according to <2>, wherein the linear organo(poly)siloxane residue is represented by the following formula (B1):

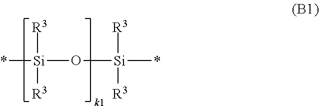

In formula (B1),
each R³ independently represents a hydrocarbon group;
k1 represents a number of 1 or larger; and
* indicates a bonding site with a neighboring atom.
   <5>

The article according to any one of <1> to <4>, wherein the compound having a chain group and a reactive silyl group is represented by the following formula (C), (C2), (D), (D2), (E), or (E2).

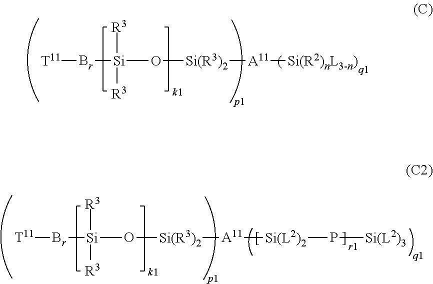

In formula (C),
T¹¹ represents a monovalent group that does not contain a reactive silyl group;
each B independently represents —O— or —C(═O)—;
each r independently represents 0 or 1;
each R³ independently represents a hydrocarbon group;
each k1 independently represents a number of 1 or larger;
p1 represents an integer of 1 or larger,
A¹¹ represents a (p1+q1)-valent linking group;
q1 represents an integer of 1 or larger,
each R² independently represents a hydrocarbon group;
each L independently represents a hydrolyzable group, a group having a hydrolyzable group, or a hydroxy group; and
each n independently represents an integer from 0 to 2.

In formula (C2),
each L² independently represents a hydrolyzable group, a group having a hydrolyzable group, a hydroxy group, or a hydrocarbon group;
each of at least four pieces of L² among all L² represents a hydrolyzable group, a group having a hydrolyzable group, or a hydroxy group;
each P independently represents an oxygen atom, or an organic group having one carbon atom bonded to both neighboring Si; and
r1 represents an integer from 1 to 3.

Definitions of T¹¹, B, r, R³, k1, p1, A¹¹, and q1 are same as definitions thereof in formula (C).

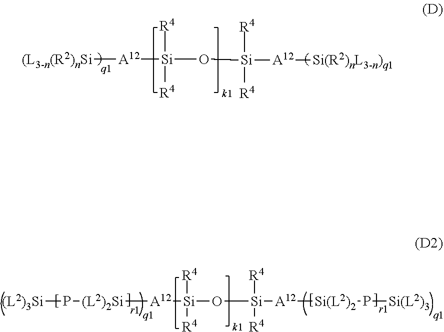

In formula (D),
each R⁴ independently represents a hydrocarbon group or T¹¹-Bᵣ—(SiR³₂—O)ₖ₁—,
each T¹¹ independently represents a monovalent group;
each B independently represents —O— or —C(═O)—;
each r independently represents 0 or 1,
each R³ independently represents a hydrocarbon group;
each k1 independently represents a number of 1 or larger;
each A¹² independently represents a (q1+1)-valent linking group;
each q1 independently represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

In formula (D2),
each L² independently represents a hydrolyzable group, a group having a hydrolyzable group, a hydroxy group, or a hydrocarbon group;
each of at least four pieces of L² among all L² represents a hydrolyzable group, a group having a hydrolyzable group, or a hydroxy group;
each P independently represents an oxygen atom, or an organic group having one carbon atom bonded to both neighboring Si; and
each r1 independently represents an integer from 1 to 3.

Definitions of R⁴, k1, A¹², and q1 are same as definitions thereof in formula (D).

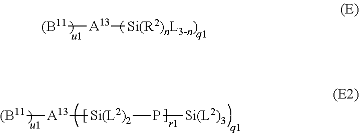

In formula (E),
B¹¹ represents a monovalent group having at least one selected from the group consisting of Si, Ge, and Sn to which a hydroxy group or a hydrolyzable group is not directly bonded; or a monovalent group having a branched alkyl group;
u1 represents an integer of 1 or larger;
A¹³ represents a (q1+u1)-valent linking group;
q1 represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

In formula (E2),
each L² independently represents a hydrolyzable group, a group having a hydrolyzable group, a hydroxy group, or a hydrocarbon group;
each of at least four L²s among all L²s represents a hydrolyzable group, a group having a hydrolyzable group, or a hydroxy group;
each P independently represents an oxygen atom, or an organic group having one carbon atom bonded to both neighboring Si; and
each r1 independently represents an integer from 1 to 3.

Definitions of B¹¹, u1, A¹³, and q1 are the same as definitions thereof in formula (E).

<6>

The article according to <5>, wherein k1 in formulae (C) and (C2) represents a number from 3 to 500; and
k1 in formulae (D) and (D2) represents a number from 3 to 500.
   <7>

The article according to claim <5> or <6>, wherein q1 in formulae (C), (C2), (E), and (E2) represents an integer from 1 to 4; and
each q1 in formulae (D) and (D2) independently represents an integer from 1 to 4.
   <8>

The article according to any one of <1> to <7>, wherein the substrate is glass.

<9>

The article according to any one of <1> to <8>, which is an optical component.

<10>

The article according to any one of <1> to <9>, which is a display or a touch panel.

<11>

A method of producing an article, the method includes: subjecting a substrate to surface treatment with use of a surface treatment agent, to produce an article having the substrate and a surface treatment layer formed thereon,
wherein the surface treatment layer has a surface roughness Sdr of 30% or larger within any measurement area of from 5 to 50 μm squares, and
the surface treatment agent contains a compound having a chain group and a reactive silyl group.
   <12>

The method of producing an article according to <11>, wherein the compound having a chain group and a reactive silyl group is a compound having a linear organo(poly)siloxane residue and a reactive silyl group.

<13>

The method of producing an article according to <11> or <12>, wherein the substrate has a surface roughness Sdr of 30% or larger within a measurement area of any of 5 to 50 μm squares.

<14>

The method of producing an article according to any one of <11> to <13>, wherein the reactive silyl group is represented by the following formula (S1) or (S3):

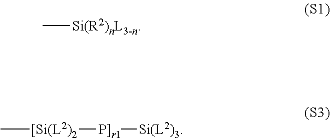

In formula (S1),
each R² independently represents a hydrocarbon group;
each L independently represents a hydrolyzable group, a group having a hydrolyzable group, or a hydroxy group; and
n represents an integer from 0 to 2.

In formula (S3),
each L² independently represents a hydrolyzable group, a group having a hydrolyzable group, hydroxy group, or hydrocarbon group;
each of at least four L²s among all L²s represents a hydrolyzable group, a group having a hydrolyzable group, or a hydroxy group; and
each P independently represents an oxygen atom, or an organic group having one carbon atom bonded to both neighboring Si; and
r1 represents an integer from 1 to 3.
   <15>

The method of producing an article according to <12>, wherein the linear organo(poly)siloxane residue is represented by the following formula (B1):

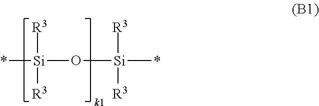

In formula (B1),
each R³ independently represents a hydrocarbon group;
k1 represents a number of 1 or larger; and
* indicates a bonding site with a neighboring atom.
   <16>

The method of producing an article according to any one of <11> to <15>, wherein the compound having a chain group and a reactive silyl group is represented by the following formula (C), (C2), (D), (D2), (E), or (E2).

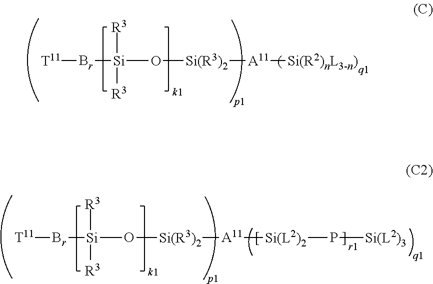

In formula (C),
T¹¹ represents a monovalent group that does not contain a reactive silyl group;
each B independently represents —O— or —C(═O)—;
each r independently represents 0 or 1;
each R³ independently represents a hydrocarbon group;
each k1 independently represents a number of 1 or larger;
p1 represents an integer of 1 or larger,
A¹¹ represents a (p1+q1)-valent linking group;
q1 represents an integer of 1 or larger,
each R² independently represents a hydrocarbon group;
each L independently represents a hydrolyzable group, a group having a hydrolyzable group, or a hydroxy group; and
each n independently represents an integer from 0 to 2.

In formula (C2),
each L² independently represents a hydrolyzable group, a group having a hydrolyzable group, a hydroxy group, or a hydrocarbon group;
each of at least four L²s among all L²s represents a hydrolyzable group, a group having a hydrolyzable group, or a hydroxy group;
each P independently represents an oxygen atom, or an organic group having one carbon atom bonded to both neighboring Si; and
r1 represents an integer from 1 to 3.

Definitions of T¹¹, B, r, R³, k1, p1, A¹¹, and q1 are same as definitions thereof in formula (C).

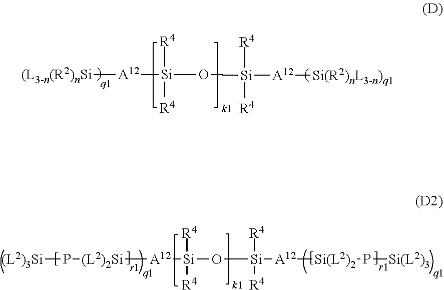

in formula (D),
each R⁴ independently represents a hydrocarbon group or T¹¹-Bᵣ—(SiR³₂—O)ₖ₁—;
each T¹¹ independently represents a monovalent group;
each B independently represents —O— or —C(═O)—,
each r independently represents 0 or 1;
each R³ independently represents a hydrocarbon group;
each k1 independently represents a number of 1 or larger;
each A¹² independently represents a (q1+1)-valent linking group;
each q1 independently represents an integer of 1 or larger;
each R² independently represents a hydrocarbon group;
each L independently represents a hydrolyzable group, a group having a hydrolyzable group, or a hydroxy group, and
each n independently represents an integer from 0 to 2;

In formula (D2),
each L² independently represents a hydrolyzable group, a group having a hydrolyzable group, a hydroxy group, or a hydrocarbon group;
each of at least four L²s among all L²s represents a hydrolyzable group, a group having a hydrolyzable group, or a hydroxy group;
each P independently represents an oxygen atom, or an organic group having one carbon atom bonded to both neighboring Si; and
each r1 independently represents an integer from 1 to 3.

Definitions of R⁴, k1, A¹², and q1 are same as definitions thereof in formula (D).

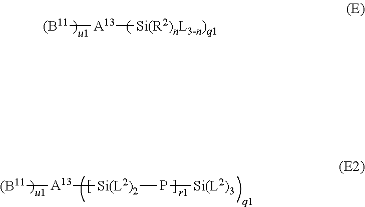

In formula (E),
B¹¹ represents a monovalent group having at least one selected from the group consisting of Si, Ge, and Sn to which a hydroxy group or a hydrolyzable group is not directly bonded; or a monovalent group having a branched alkyl group;
u1 represents an integer of 1 or larger;
A¹³ represents a (q1+u1)-valent linking group;
q1 represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

In formula (E2),
each L² independently represents a hydrolyzable group, a group having a hydrolyzable group, a hydroxy group, or a hydrocarbon group;
each of at least four L²s among all L²s represents a hydrolyzable group, a group having a hydrolyzable group, or a hydroxy group;
each P independently represents an oxygen atom, or an organic group having one carbon atom bonded to both neighboring Si; and
each r1 independently represents an integer from 1 to 3.

Definitions of B¹¹, u1, A¹³, and q1 are same as definitions thereof in formula (E).

### Advantageous Effects of Invention

According to an embodiment of the present invention, there is provided an article having a surface treatment layer that excels in liquid repellency, and a method of producing the article.

### DESCRIPTION OF EMBODIMENTS

In the present disclosure, each numerical range indicated with use of “to” includes numerical values described before and after “to”, as a minimum value and a maximum value, respectively.

With respect to the numerical ranges described stepwise in the present disclosure, the upper limit value or the lower limit value described in one numerical range may be replaced with the upper limit value or the lower limit value of another numerical range described stepwise. With respect to the numerical ranges described in the present specification, the upper limit value or the lower limit value of such numerical ranges may be replaced with values described in Examples.

In the present disclosure, the “surface treatment layer” means a layer formed by surface treatment, on a surface of the substrate.

In the present disclosure, any compound or group, when represented by a specific formula (X), may be referred to as a compound (X) or a compound X, or, a group (X) or a group X, respectively.

In the present disclosure, the organo(poly)siloxane residue means organosiloxane residue, or organopolysiloxane residue.

In the present disclosure, “Me” occasionally means a methyl group.

### [Article]

The article of the present disclosure has a substrate, and a surface treatment layer arranged on the substrate and having a surface treated with a surface treatment agent, wherein the surface treatment layer has a surface roughness Sdr of 30% or larger within any measurement area of from 5 to 50 μm squares, and the surface treatment agent contains a compound having a chain group and a reactive silyl group.

In one aspect, the article of the present disclosure preferably has a substrate, and a surface treatment layer arranged on the substrate and having a surface treated with a surface treatment agent, wherein the surface treatment layer preferably has a surface roughness Sdr of 30% or larger within a measurement area of any of 5 to 50 μm squares, and the surface treatment agent preferably contains a compound having a linear organo(poly)siloxane residue and a reactive silyl group.

Hereinafter, the compound having a chain group and a reactive silyl group is also referred to as “specific silane compound”, and among which, the compound having a linear organo(poly)siloxane residue and a reactive silyl group is also referred to as “specific silane compound A” (note, each of “first compound” and “second compound” described later apply to one aspect thereof). In the present disclosure, the description regarding the specific silane compound also applies to a case where the “specific silane compound” is replaced with the “specific silane compound A”, as long as no contradiction arises.

The article of the present disclosure has the surface treatment layer that excels in liquid repellency.

The reason why such effect is obtainable is presumably, but not definitely, as follows.

In general, it is difficult to enhance liquid repellency for silicone-based material. The surface treatment layer, whose surface was treated with a surface treatment agent that contains a compound having a linear organo(poly)siloxane residue and a reactive silyl group, will however have an improved liquid repellency supposedly for its surface irregularity, if the surface roughness Sdr of the surface treatment layer is adjusted to 30% or larger within any measurement area of from 5 to 50 μm squares.

On the other hand, Patent Document 1 does not describe the surface roughness of the surface treatment layer.

Hereinafter, the individual structures of the article of the present disclosure will be described in detail.

The article of the present disclosure includes a substrate, and a surface treatment layer arranged on the substrate and having a surface treated with a surface treatment agent.

### <Substrate>

Type of the substrate is not particularly limited, for which a substrate required to have water repellency is exemplified. Examples of the substrate include, substrate possibly used in contact with other article (stylus, for example) or human finger; substrate possibly operated while being held by human fingers; and substrate possibly placed on other article (stage, for example).

Examples of material for the substrate include metal, resin, glass, sapphire, ceramic, semiconductor, stone, fiber, nonwoven fabric, paper, wood, fur, natural leather, artificial leather, chinaware, and composite materials thereof. The glass may be chemically strengthened.

Examples of the substrate include building material, decorative building material, interior goods, transportation equipment (for example, automobile), signboard, bulletin board, drinkware, tableware, water tanks, ornamental goods (for example, frame, box), laboratory instruments, furniture, textile product, and packaging container; glass or resin used for art, sporting goods, game machine, and the like; and glass or resin used for an exterior portion (excluding a display unit) of devices such as mobile phone (for example, smartphone), personal digital assistant, game machine, or remote controller. Shape of the substrate may be plate or film.

For use as an optical component, the substrate is more preferably glass.

The substrate is preferably any of those for touch panel, display, and spectacle lens, wherein touch panel substrate is particularly preferred. Material of the touch panel substrate is preferably glass or transparent resin.

The substrate may have one surface or both surfaces subjected to surface treatment such as corona discharge treatment, plasma treatment, or plasma graft polymerization treatment. The substrate subjected to the surface treatment will have improved adhesion with the surface treatment layer, whereby the surface treatment layer will have improved abrasion resistance. The substrate is therefore preferably subjected to the surface treatment, on the surface thereof on the side in contact with the surface treatment layer. In a case where an underlayer described later is provided, the substrate thus subjected to the surface treatment will have improved adhesion with the underlayer, whereby the surface treatment layer will have improved abrasion resistance. Hence in a case where the underlayer is provided, the substrate is preferably subjected to the surface treatment, on the surface thereof on the side in contact with the underlayer.

### <Surface Treatment Layer>

The surface treatment layer may be formed on a part of the surface of the substrate, or over the entire surface of the substrate. The surface treatment layer may spread like a film over the surface of the substrate, or may be scattered like dots.

In the surface treatment layer, the compound having a chain group and a reactive silyl group (in one aspect, a compound having a linear organo(poly)siloxane residue and a reactive silyl group) is contained, with the reactive silyl group partially or entirely hydrolysed, and with a silanol group dehydrolysed and condensed.

The thickness of the surface treatment layer is preferably 1 to 100 nm, and more preferably 1 to 50 nm. With the thickness of the surface treatment layer set to 1 nm or larger, a sufficient effect of the surface treatment will be obtainable. With the thickness of the surface treatment layer set to 100 nm or smaller, the utilization efficiency will be high. The thickness of the surface treatment layer can be calculated from an oscillation period of an interference pattern of the reflected X-ray, obtainable by X-ray reflectometry with use of an X-ray diffractometer for thin film analysis (Model “ATX-G”, from Rigaku Corporation).

The surface treatment layer may be provided directly on the surface of the substrate. An underlayer may be provided between the substrate and the surface treatment layer. From the viewpoint of further improving the liquid repellency of the surface treatment layer, the article of the present disclosure preferably includes the substrate, the underlayer arranged on the substrate, and the surface treatment layer arranged on the underlayer, and surface-treated with the surface treatment agent of the present disclosure.

The underlayer is preferably a layer that contains an oxide containing silicon, and at least one specific element selected from the group consisting of Group 1 element, Group 2 element, Group 4 element, Group 5 element, Group 13 element, and Group 15 element in the periodic table.

The Group 1 element in the periodic table (also referred to as “Group 1 element”, hereinafter) means lithium, sodium, potassium, rubidium, and cesium. From the viewpoint that the surface treatment layer can be formed on the underlayer more uniformly without defects, or compositional variation of the underlayer among samples can be further suppressed, the Group 1 element is preferably lithium, sodium, or potassium, and is more preferably sodium or potassium. The underlayer may contain two or more kinds of Group 1 element.

The Group 2 element in the periodic table (also referred to as “Group 2 element”, hereinafter) means beryllium, magnesium, calcium, strontium, and barium. From the viewpoint that the surface treatment layer can be formed on the underlayer more uniformly without defects, or compositional variation of the underlayer among samples can be further suppressed, the Group 2 element is preferably magnesium, calcium or barium, and is more preferably magnesium or calcium. The underlayer may contain two or more kinds of Group 2 element.

The Group 4 element in the periodic table (also referred to as “Group 4 element”, hereinafter) means titanium, zirconium, and hafnium. From the viewpoint that the surface treatment layer can be formed on the underlayer more uniformly without defects, or compositional variation of the underlayer among samples can be further suppressed, the Group 4 element is preferably titanium or zirconium, and is more preferably titanium. The underlayer may contain two or more kinds of Group 4 element.

The Group 5 element in the periodic table (also referred to as “Group 5 element”, hereinafter) means vanadium, niobium, and tantalum. From the viewpoint of more excellent abrasion resistance of the surface treatment layer, vanadium is particularly preferred as the Group 5 element. The underlayer may contain two or more kinds of Group 5 element.

The Group 13 element in the periodic table (also referred to as “Group 13 element”, hereinafter) means boron, aluminum, gallium, and indium. From the viewpoint that the surface treatment layer can be formed on the underlayer more uniformly without defects, or compositional variation of the underlayer among samples can be further suppressed, the Group 13 element is preferably boron, aluminum or gallium, and is more preferably boron or aluminum. The underlayer may contain two or more kinds of Group 13 element.

The Group 15 element in the periodic table (also referred to as “Group 15 element”, hereinafter) means nitrogen, phosphorus, arsenic, antimony, and bismuth. From the viewpoint that the surface treatment layer can be formed on the underlayer more uniformly without defects, or compositional variation of the underlayer among samples can be further suppressed, the Group 15 element is preferably phosphorus, antimony or bismuth, and is more preferably phosphorus or bismuth. The underlayer may contain two or more kinds of Group 15 element.

The specific element contained in the underlayer is preferably Group 1 element, Group 2 element, and Group 13 element, considering further excellence in the abrasion resistance of the surface treatment layer, more preferably Group 1 element or Group 2 element, and still more preferably Group 1 element.

As the specific element, only one kind of element, or two or more kinds of element may be contained.

The oxide contained in the underlayer may be a mixture of single oxides (mixture of silicon oxide, with oxide of specific element, for example) of the aforementioned elements (silicon and specific element), or may be a composite oxide that contains two or more kinds of the aforementioned elements, or a mixture of single oxide and composite oxide of the aforementioned elements.

The ratio of the total molar concentration of the specific elements in the underlayer, to the molar concentration of silicon in the underlayer (specific element/silicon) is preferably 0.02 to 2.90, more preferably 0.10 to 2.00, and still more preferably 0.20 to 1.80, from the viewpoint of more excellent abrasion resistance of the surface treatment layer.

The molar concentration (mol %) of the individual elements in the underlayer can be measured by, for example, depth profiling based on X-ray photoelectron spectroscopy (XPS), with the aid of ion sputtering.

The underlayer may be a single layer or a multilayer. The underlayer may have irregularity on the surface.

The thickness of the underlayer is preferably 1 to 100 nm, more preferably 1 to 50 nm, and still more preferably 2 to 20 nm. With the thickness of the underlayer adjusted to the aforementioned lower limit value or above, the adhesion of the underlayer to the surface treatment layer will further improve, whereby the surface treatment layer will have more excellent abrasion resistance. With the thickness of the underlayer adjusted to the aforementioned upper limit value or below, the underlayer per se will have excellent abrasion resistance.

The thickness of the underlayer is measured by observing a cross-section of the underlayer under a transmission electron microscope (TEM).

The underlayer can be formed by, for example, vapor deposition method with use of vapor deposition material, or wet coating.

The vapor deposition material used for vapor deposition preferably contains oxide that contains silicon and the specific element.

Specific examples of the form of the vapor deposition material include powder, molten matter, sintered matter, granule, and crushed matter. From the viewpoint of handleability, molten matter, sintered matter, and granule are preferred.

The molten matter herein means a solid matter obtained by melting powder of the vapor deposition material at high temperatures, followed by solidification by cooling. The sintered matter means a solid matter obtained by firing powder of the vapor deposition material. A mold formed of press-formed powder may alternatively be used as necessary, in place of the powder of the vapor deposition material. The granule is a solid matter obtained by kneading powder of a vapor deposition material and a liquid medium (for example, water, organic solvent), followed by drying of the obtained particle.

The vapor deposition material can be produced, for example, by the method below:
a method by which a powder of silicon oxide and powder of oxide of specific element are mixed to obtain powder of a vapor deposition material;
a method by which powder of the vapor deposition material and water are kneaded to obtain particle, and the particle is then dried to obtain granule of the vapor deposition material;
a method by which silicon-containing powder (for example, powder composed of silicon oxide, silica sand, or silica gel), powder containing a specific element (for example, powder of oxide of specific element, carbonate, sulfate, nitrate, oxalate, or hydroxide), and water are mixed, the mixture is dried, and the dried mixture or a press-molded matter thereof is then fired to obtain a sintered matter; and
a method by which silicon-containing powder (for example, powder composed of silicon oxide, silica sand, or silica gel), and powder containing a specific element (for example, powder of oxide of specific element, carbonate, sulfate, nitrate, oxalate, or hydroxide) are melted at high temperatures, and the melt is then cooled to solidify, to obtain a molten matter.

Specific examples of the vapor deposition method with use of the vapor deposition material include vacuum vapor deposition method. The vacuum vapor deposition method is a method of evaporating the vapor deposition material in a vacuum chamber, to cause deposition on the surface of the substrate.

The temperature of vapor deposition (the temperature of a boat on which the vapor deposition material is placed, in an exemplary case of using a vacuum vapor deposition apparatus) is preferably 100 to 3,000° C., and more preferably 500 to 3,000° C.

The pressure of vapor deposition (the pressure in the chamber in which the vapor deposition material is placed, in an exemplary case of using a vacuum vapor deposition apparatus) is preferably 1 Pa or lower, and more preferably 0.1 Pa or lower.

In a case where the underlayer is formed with use of the vapor deposition material, one kind of the vapor deposition material may be used, or two or more kinds of vapor deposition materials containing different elements may be used.

Specific examples of the evaporation method of the vapor deposition material include resistance heating by which the vapor deposition material is melted on a resistance heating boat made of refractory metal, and allowed to evaporate; and an electron gun method by which the surface of the vapor deposition material is directly heated and melted under irradiation with electron beam, and allowed to evaporate. The method of evaporating the vapor deposition material is preferably the electron gun method, from the viewpoint that such local heating can also evaporate high-melting-point substances, and that area of the container not irradiated by the electron beam can remain at low temperatures, and is unlikely to cause reaction with the container or contamination with impurity.

The evaporation method of the vapor deposition material may use a plurality of boats, or a single boat on which all the vapor deposition materials are placed. The vapor deposition method may employ co-deposition, alternate deposition, or the like. More specifically, examples include a case of using silica and specific source in a mixed manner in the same boat; a case of causing co-deposition of silica and specific element source placed in separate boats; and a case of causing alternate deposition similarly from the separate boats. Conditions, order or the like of vapor deposition are appropriately selectable depending on the structure of the underlayer.

In wet coating, it is preferred to form the underlayer on the substrate, by wet coating of a coating liquid that contains a silicon-containing compound, a specific element-containing compound, and a liquid medium.

Specific examples of the silicon compound include silicon oxide, silicic acid, partial condensates of silicic acid, alkoxysilane, and partial hydrolysis condensates of alkoxysilane.

Specific examples of the specific element-containing compound include oxide of the specific element, alkoxide of the specific element, carbonate of the specific element, sulfate of the specific element, nitrate of the specific element, oxalate of the specific element, and hydroxide of the specific element.

Examples of the liquid medium include those equivalent to the liquid medium that may be contained in the surface treatment agent described later.

The content of the liquid medium, with respect to the total amount of the coating liquid used for forming the underlayer, is preferably 80 to 99.99 mass %, and more preferably 90 to 99.9 mass %.

Specific examples of the wet coating for forming the underlayer include spin coating, wipe coating, spray coating, squeegee coating, dip coating, die coating, inkjet method, flow coating, roll coating, casting, the Langmuir-Blodgett method, and gravure coating.

The wet coating of the coating liquid is preferably followed by drying of a coated film. Drying temperature of the coated film is preferably 20 to 200° C., and more preferably 80 to 160° C.

### (Surface Roughness Sdr)

The surface treatment layer has a surface roughness Sdr of 30% or larger within any measurement area of from 5 to 50 μm squares.

The surface roughness Sdr is defined in ISO 25178-2:2012, which means an index that indicates how much the developed area (surface area) of the definition area is increased with respect to the area of the definition area. Sdr of the flat surface equals 0 (zero).

In the present disclosure, the surface roughness Sdr is measured under an atomic force microscope. The measurement is made on the surface treatment layer in three square areas having a side of 5 to 50 μm, and an average value is employed.

The surface roughness Sdr is preferably 20% or larger, and more preferably 30% or larger, from the viewpoint of improving liquid repellency. On the other hand, the surface roughness Sdr is preferably 100% or smaller, and more preferably 50% or smaller, from the viewpoint of transparency and design.

Examples of the method of adjusting the surface roughness Sdr of the surface treatment layer to 30% or larger, within any measurement area of from 5 to 50 μm squares, include the methods below.
Method 1: use of a substrate having a surface roughness Sdr of 30% or larger.
Method 2: provision of an underlayer on a substrate, with the surface roughness of the underlayer adjusted to 30% or larger.

The method 1, with use of the substrate having a surface roughness Sdr of 30% or larger, can make the surface roughness Sdr of the surface treatment layer, arranged on the substrate, reach 30% or larger.

In this case, the surface treatment layer is directly arranged on the substrate without interposing the underlayer. The underlayer, if interposed, preferably has a thickness of 1 μm or smaller.

The thickness of the surface treatment layer is preferably 1 μm or smaller. With the thickness of the surface treatment layer adjusted to 1 μm or smaller, the irregularity on the surface of the substrate is more likely to be reflected directly to the irregularity on the surface of the surface treatment layer.

Any generally available substrate with an underlayer will be regarded simply as the “substrate”. Also a substrate, with an underlayer having a surface roughness Sdr of 30% or larger is adoptable.

Examples of the method for adjusting the surface roughness Sdr of the substrate to 30% or larger include sandblasting and etching. Etching is preferred.

The etching may be dry etching or wet etching.

The etching process may also be chemical etching, physical etching, or combination of chemical etching and physical etching.

In order to adjust the surface roughness Sdr to 30% or larger, the substrate is preferably cleaned in advance of the etching.

The cleaning process preferably includes a step of ultrasonic cleaning with use of aqueous alkaline solution, a step of ultrasonic cleaning with use of ultrapure water, and a step of ozone cleaning.

The ultrasonic cleaning with use of aqueous alkaline solution can remove inorganic substances having been adhered to the surface of the substrate. The time for the ultrasonic cleaning with use of aqueous alkaline solution is, for example, 1 to 30 minutes.

The ultrasonic cleaning with use of ultrapure water can remove the aqueous alkaline solution, and can improve cleaning efficiency in the next step. The time for the ultrasonic cleaning with use of ultrapure water is, for example, 1 to 30 minutes.

The ozone cleaning can remove organic matters having been adhered to the surface of the substrate.

Examples of gas (process gas) used for the etching include hydrogen fluoride gas and fluorine gas. The process gas may contain carrier gas and dilution gas. Examples of the carrier gas and the dilution gas include nitrogen and argon. The process gas may contain water.

The concentration of hydrogen fluoride gas, if contained in the process gas, is preferably 0.01 to 20 vol %, and more preferably 0.1 to 5 vol %.

The flow rate of the process gas is preferably 1 to 200 standard liters per minute (SLM), and more preferably 30 to 80 SLM.

The temperature of the etching is preferably 400 to 800° C., and more preferably 500 to 700° C.

The etching time is preferably 1 to 600 seconds, more preferably 10 to 500 seconds, still more preferably 200 to 500 seconds, and particularly preferably 300 to 500 seconds.

In a case where the process gas contains hydrogen fluoride gas, the substrate is preferably cleaned with use of acidic solution (hydrochloric acid, for example) after the etching, in order to remove fluoride formed on the surface of the substrate.

The method 2 can adjust the surface roughness Sdr of the surface treatment layer, arranged on the underlayer, to 30% or larger, by providing the underlayer on the substrate, and by adjusting the surface roughness of the underlayer to 30% or larger.

The thickness of the surface treatment layer in this case is preferably 1 μm or smaller. With the thickness of the surface treatment layer adjusted to 1 μm or smaller, the irregularity on the surface of the underlayer is more likely to be reflected directly to the irregularity on the surface of the surface treatment layer.

Examples of the method of adjusting the surface roughness Sdr of the underlayer to 30% or larger include sandblasting and etching. Etching is preferred. Preferred aspects of the etching are as described above.

### (Surface Treatment Agent)

The surface treatment layer is surface-treated with the surface treatment agent.

The surface treatment agent contains a compound (specific silane compound A) having a chain group (in one aspect, linear organo(poly)siloxane residue) and a reactive silyl group.

Hereinafter, the individual components contained in the surface treatment agent will be described in detail.

### <Specific Silane Compound>

The specific silane compound has a chain group and a reactive silyl group. The specific silane compound A has a linear organo(poly)siloxane residue and a reactive silyl group. The surface treatment agent of the present disclosure may contain only one kind of specific silane compound, or two or more kinds thereof.

### (Chain Group)

The specific silane compound contains a chain group. The chain group may be linear without branching, or may contain branching. The specific silane compound may have, but not necessarily, any other structure such as a cyclic structure, as long as the chain group is contained.

The chain group is not particularly limited as long as it has a chain structure in which two or more atoms are linked, and examples thereof include chain hydrocarbon group; linear organo(poly)siloxane residue; group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group; and combinations thereof. R^{d} represents a hydrogen atom or an alkyl group (preferably having 1 to 10 carbon atoms).

Examples of the chain hydrocarbon group include linear or branched chain hydrocarbon group having 2 to 100, preferably 5 to 90, and more preferably 10 to 80 carbon atoms. The chain hydrocarbon group is preferably alkylene group, and more preferably alkylene group having the aforementioned number of carbon atoms. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

In one aspect, the chain group is preferably a linear organo(poly)siloxane residue. Hereinafter, the linear organo(poly)siloxane residue will be described in detail.

### (Linear Organo(Poly)Siloxane Residue)

The specific silane compound may contain one, or two or more linear organo(poly)siloxane residues. In a case where the specific silane compound contains two or more linear organo(poly)siloxane residues, such two or more linear organo(poly)siloxane residues may be the same or different.

Examples of the linear organo(poly)siloxane residue include a linear organo(poly)siloxane residue represented by formula (B1) or (B2) below:

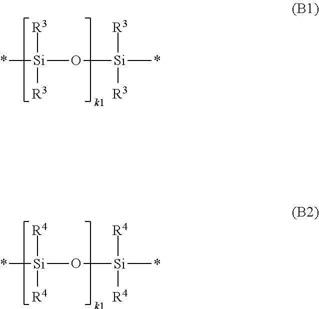

In formula (B1), each R³ independently represents a hydrocarbon group;
k1 represents a number of 1 or larger; and
* indicates a bonding site with a neighboring atom.

In formula (B2),
each R⁴ independently represents a hydrocarbon group or T¹¹-Bᵣ—(SiR³₂—O)ₖ₁—;
each T¹¹ independently represents a monovalent group;
each B independently represents —O— or —C(═O)—;
each r independently represents 0 or 1,
each R³ independently represents a hydrocarbon group;
each k1 independently represents a number of 1 or larger; and
* indicates a bonding site with a neighboring atom.

In formulae (B1) and (B2), examples of the hydrocarbon group represented by R³ include aliphatic hydrocarbon group and aromatic hydrocarbon group. In particular, the hydrocarbon group is preferably aliphatic hydrocarbon group, and more preferably alkyl group. The alkyl group may be any of linear alkyl group, branched alkyl group, or cycloalkyl group. Linear alkyl group is preferred; methyl group, ethyl group, n-propyl group, or n-butyl group is more preferred; and methyl group is still more preferred. The aromatic hydrocarbon group is preferably phenyl group.

In formulae (B1) and (B2), k1 represents a number of 1 or larger, which is preferably 1 to 600, more preferably 1 to 500, still more preferably 3 to 500, particularly preferably 9 to 50, very preferably 11 to 30, and most preferably 11 to 25.

In formula (B2), each R⁴ independently represents a hydrocarbon group or T¹¹-Bᵣ—(SiR³₂—O)ₖ₁—, wherein a hydrocarbon group is preferred. Details of the hydrocarbon group are the same as those of the hydrocarbon group represented by R³.

Each T¹¹ independently represents a monovalent group, wherein specific aspects thereof are the same as those for T¹¹ in formula (C) described later.

Specific aspects of B and r are the same as those for B and r in formula (C) described later.

### (Reactive Silyl Group)

The number of the reactive silyl groups contained in the specific silane compound is 1 or larger. From the viewpoint of further improving the abrasion resistance of the surface treatment layer, the number is preferably 1 to 18, more preferably 1 to 12, still more preferably 1 to 8, particularly preferably 1 to 6, and very preferably 1 to 4. In one aspect, the number of reactive silyl groups contained in the specific silane compound is preferably 2 to 18, more preferably 2 to 12, still more preferably 2 to 8, and particularly preferably 2 to 6. The number of reactive silyl groups may even be one.

The reactive silyl group means a group having a reactive group bound to Si atom. The reactive group is preferably hydrolyzable group, group having hydrolyzable group, or hydroxy group.

The hydrolyzable group is a group converted by a hydrolysis reaction into hydroxy group. That is, the hydrolyzable silyl group represented by Si-L¹ (L¹ represents a hydrolyzable group) is converted by the hydrolysis reaction into silanol group represented by Si—OH. The silanol groups further react among themselves to form a Si—O—Si bond. The silanol group can also cause dehydration condensation reaction with a silanol group derived from an oxide present on the surface of the substrate, to form the Si—O—Si bond.

Examples of the hydrolyzable group include alkoxy group, aryloxy group, halogen atom, acyl group, acyloxy group, amino group, —O—N═CR₂, and isocyanato group (—NCO). The alkoxy group preferably has 1 to 4 carbon atoms. The aryloxy group preferably has 3 to 10 carbon atoms. Where, the aryl group of the aryloxy group includes heteroaryl group. The halogen atom is preferably a chlorine atom. The acyl group preferably has 1 to 6 carbon atoms. The acyloxy group preferably has 1 to 6 carbon atoms. Each R independently represents an alkyl group having 1 to 10 carbon atoms.

Examples of the group having a hydrolyzable group include groups having hydrolyzable groups exemplified above. The group having a hydrolyzable group is preferably —O-L^{A}-L^{B}. L^{A} represents an alkylene group, and L^{B} represents a hydrolyzable group. The number of carbon atoms in the alkylene group is preferably 1 to 10. The hydrolyzable group represented by L^{B} is the same as the aforementioned hydrolyzable group. The same applies to the preferred aspects.

The reactive silyl group is preferably a group represented by formula (S1) below:

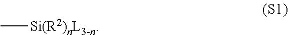

In formula (S1),
each R² independently represents a monovalent hydrocarbon group;
each L independently represents a hydrolyzable group, a group having a hydrolyzable group, or a hydroxy group; and
n represents an integer from 0 to 2.

In a case where there is a plurality of reactive silyl groups in one molecule, such plurality of reactive silyl groups may be the same, or different from each other. Such plurality of reactive silyl groups is preferably the same, from the viewpoint of availability of raw materials, and ease of production of the compound.

Each R² independently represents a monovalent hydrocarbon group, and is preferably a monovalent saturated hydrocarbon group. The number of carbon atoms in R² is preferably 1 to 6, more preferably 1 to 3, and still more preferably 1 to 2.

Each L independently represents a hydrolyzable group, a group having a hydrolyzable group, or a hydroxy group. Details of the hydrolyzable group and the group having a hydrolyzable group are as described above.

In particular, L preferably represents an alkoxy group having 1 to 4 carbon atoms, or a halogen atom, from the viewpoint of ease of production of the compound. From the viewpoint of low outgassing during coating, and excellence of shelf stability of the compound, L preferably represents an alkoxy group having 1 to 4 carbon atoms, and more preferably an ethoxy group or a methoxy group.

n represents an integer from 0 to 2, preferably 0 or 1, and more preferably 0. Presence of a plurality of L makes the surface treatment layer more tightly adherable to the substrate.

If n represents 1 or smaller, the plurality of L present in one molecule may be the same, or different from each other. From the viewpoint of availability of raw materials, and ease of production of the compound, the plurality of L is preferably the same. If n represents 2, the plurality of R² present in one molecule may be the same, or different from each other. From the viewpoint of availability of raw materials, and ease of production of the compound, the plurality of R² is preferably the same.

From the viewpoint of excellence in the uniformity and durability of the surface treatment layer, the reactive silyl group is preferably an alkoxysilyl group or a trichlorosilyl group. From the viewpoint of handleability of byproduct generated in the reaction with the substrate, the reactive silyl group is more preferably an alkoxysilyl group. The alkoxysilyl group is preferably a dialkoxysilyl group or a trialkoxysilyl group, and more preferably trialkoxysilyl group.

The reactive silyl group may also be a group represented by formula (S2) below:

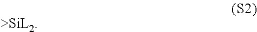

L is the same as L in formula (S1).

The reactive silyl group is also preferably a group represented by formula (S3) below:

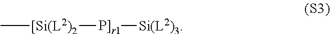

In formula (S3)
each L² independently represents a hydrolyzable group, a group having a hydrolyzable group, hydroxy group, or hydrocarbon group;
each of at least four L²s among all L²s represents a hydrolyzable group, a group having a hydrolyzable group, or a hydroxy group; and
each P independently represents an oxygen atom, or an organic group having one carbon atom bonded to both neighboring Si; and
r1 represents an integer from 1 to 3.

In a case where there is a plurality of groups (S3) in one molecule, such plurality of groups (S3) may be the same, or different from each other. Such plurality of groups (S3) is preferably the same, from the viewpoint of availability of raw materials, and ease of production of the compound.

Each L² independently represents a hydrolyzable group, a group having a hydrolyzable group, hydroxy group, or hydrocarbon group.

Details of the hydrolyzable group and the group having a hydrolyzable group are as described above.

In particular, the hydrolyzable group or the group having a hydrolyzable group in L² is preferably an alkoxy group having 1 to 4 carbon atoms, alkylene oxide-modified alkoxy group, or halogen atom, from the viewpoint of ease of production of the compound. From the viewpoint of low outgassing during coating, and further excellence in shelf stability of the compound, L² preferably represents an alkoxy group having 1 to 4 carbon atoms, and more preferably an ethoxy group or a methoxy group.

Examples of the hydrocarbon group represented by L² include alkyl group, cycloalkyl group, alkenyl group, and allyl group. From the viewpoint of ease of synthesis and the like, saturated hydrocarbon group is preferred, and alkyl group is more preferred. The number of carbon atoms in the hydrocarbon group is preferably 1 to 6, more preferably 1 to 3, and still more preferably 1 to 2.

r1 represents an integer from 1 to 3. From the viewpoint of ease of synthesis, r1 preferably represents 1 or 2, and more preferably 1.

Among the plurality of L² present in one group (S3), each of at least four of them represents a hydrolyzable group, a group having a hydrolyzable group, or a hydroxy group. Accordingly, the group (S3) and the substrate will be more tightly bonded, whereby the surface treatment layer that excels in durability will be obtainable. From this point of view, the number of the hydrolyzable groups, groups having hydrolyzable groups, and hydroxy groups in the group (S3) is preferably 4 to 9, more preferably 4 to 7, and still more preferably 4 or 5.

Note that the plurality of L² present in one molecule may be the same, or different from each other. For example, the plurality of L² may be the same hydrolyzable group.

Each P independently represents an oxygen atom, or an organic group having one carbon atom bonded to both neighboring Si. The “organic group having one carbon atom bonded to both neighboring Si” means that Si atoms are connected, while placing one carbon atom in between. Examples of P include hydrocarbon group, which may be —CH₂—, —C(CH₃)₂—, or the like, for example. From the viewpoint of durability of the surface treatment layer, P preferably represents an oxygen atom, —CH₂—, or —C(CH₃)₂—, which is more preferably oxygen atom or —CH₂—, and still more preferably oxygen atom.

From the viewpoint of excellence in durability of the surface treatment layer, the group (S3) is preferably —[Si(OR¹²)₂—O]ᵣ₁—Si(OR¹²)₃. In particular, —Si(OR¹²)₂—O—Si(OR¹²)₃ that applies to r1=1 is preferred. Each R¹² herein independently represents a hydrocarbon group. Examples of the hydrocarbon group include alkyl group, cycloalkyl group, alkenyl group, and allyl group. From the viewpoint of ease of synthesis, saturated hydrocarbon group is preferred, and alkyl group is more preferred. The number of carbon atoms in R¹² is preferably 1 to 6, more preferably 1 to 3, and still more preferably 1 or 2.

Specific examples of the group (S3) include —Si(OCH₃)₂—O—Si(OCH₃)₃, —Si(OCH₃)₂—CH₂—Si(OCH₃)₃, —Si(OCH₃)₂—C(CH₃)₂—Si(OCH₃)₃, —Si(OCH₂CH₃)₂—O—Si(OCH₃)₃, —Si(OCH₃)₂—O—Si(OCH₂CH₃)₃, —Si(OCH₂CH₃)₂—O—Si(OCH₂CH₃)₃, —Si(OCH₂CH₃)₂—CH₂—Si(OCH₃)₃, —Si(OCH₃)₂—CH₂—Si(OCH₂CH₃)₃, —Si(OCH₂CH₃)₂—CH₂—Si(OCH₂CH₃)₃, —Si(OCH₂CH₃)₂—C(CH₃)₂—Si(OCH₃)₃, —Si(OCH₃)₂—C(CH₃)₂—Si(OCH₂CH₃)₃, —Si(OCH₂CH₃)₂—C(CH₃)₂—Si(OCH₂CH₃)₃, —Si(OH)₂—O—Si(OH)₃, —Si(OH)₂—O—Si(OCH₃)₃, —Si(OCH₃)₂—O—Si(OH)₃, —Si(OH)₂—CH₂—Si(OH)₃, —Si(OH)₂—CH₂—Si(OCH₃)₃, —Si(OCH₃)₂—CH₂—Si(OH)₃, —Si(OH)₂—C(CH₃)₂—Si(OH)₃, —Si(OH)₂—C(CH₃)₂—Si(OCH₃)₃, and —Si(OCH₃)₂—C(CH₃)₂—Si(OH)₃.

The number average molecular weight (Mn) of the specific silane compound is preferably 500 to 20,000, more preferably 600 to 18,000, and still more preferably 700 to 15,000.

With Mn set to 500 or larger, the surface treatment layer will further excel in abrasion resistance. With Mn set to 20,000 or smaller, the viscosity will be easily adjustable within an appropriate range, and the solubility will be improved, whereby handleability during film formation will be excellent.

The surface treatment agent may contain impurity such as byproduct produced in the production process of the specific silane compound.

The content of the specific silane compound, with respect to the total amount of the surface treatment agent, is preferably 0.001 to 50 mass %, more preferably 0.01 to 20 mass %, and still more preferably 0.1 to 10 mass %. For the surface treatment agent intended for use in wet coating, the content of the specific silane compound, with respect to the total amount of the surface treatment agent, may be 0.01 to 10 mass %, which may be 0.02 to 5 mass %, may be 0.03 to 3 mass %, or may be 0.05 to 2 mass %.

Examples of the specific silane compound include a compound (also referred to as a “first compound”, hereinafter), having a linear organo(poly)siloxane residue, and a reactive silyl group bound to only one terminal of the linear organo(poly)siloxane residue; and a compound (also referred to as a “second compound”, hereinafter), having a linear organo(poly)siloxane residue, and a reactive silyl group bound to both terminals of the linear organo(poly)siloxane residue.

For the specific silane compound, the first compound may be used singly, the second compound may be used singly, or the first compound and the second compound may be used in combination. In all cases, one kind of, or two or more kinds of the first compound may be used singly or in combination, and one kind of, or two or more kinds of the second compound may be used singly or in combination.

### [First Compound]

The first compound has a linear organo(poly)siloxane residue, and a reactive silyl group bound to only one terminal of the linear organo(poly)siloxane residue. In the present disclosure, the “reactive silyl group bound to only one terminal of the linear organo(poly)siloxane residue” means a reactive silyl group that is bound to only one terminal of a linear organo(poly)siloxane residue directly, or indirectly while placing other chemical structure in between.

### (Linear Organo(Poly)Siloxane Residue)

The first compound contains the linear organo(poly)siloxane residue. The first compound may have one, or two or more linear organo(poly)siloxane residues. In a case where the first compound contains two or more linear organo(poly)siloxane residues, such two or more linear organo(poly)siloxane residues may be the same or different. In a case where the first compound contains two or more linear organo(poly)siloxane residues, it suffices that there is no linear organo(poly)siloxane residue having a reactive silyl group bound to both terminals, but at least one linear organo(poly)siloxane residue has a reactive silyl group bound to one terminal thereof.

Details of the linear organo(poly)siloxane residue are as described above in the section regarding the linear organo(poly)siloxane residue contained in the specific silane compound. In particular, the linear organo(poly)siloxane residue is preferably represented by formula (B1) or (B2), and more preferably represented by formula (B1).

### (Reactive Silyl Group)

Details of the reactive silyl group are as described above in the section regarding the reactive silyl group contained in the specific silane compound.

The number of the reactive silyl groups contained in the first compound is 1 or larger, per one terminal of the linear organo(poly)siloxane residue. From the viewpoint of further improving the abrasion resistance of the surface treatment layer, the number, per one terminal of the linear organo(poly)siloxane residue, is preferably 1 to 18, more preferably 1 to 12, still more preferably 1 to 8, particularly preferably 1 to 6, and very preferably 1 to 4. In one aspect, the number of reactive silyl groups contained in the first compound, per one terminal of the linear organo(poly)siloxane residue, is preferably 2 to 18, more preferably 2 to 12, still more preferably 2 to 8, and particularly preferably 2 to 6. The number of reactive silyl groups, per one terminal of the linear organo(poly)siloxane residue, may be one.

### (Compound (C))

In one aspect, the first compound is preferably represented by formula (C) below:

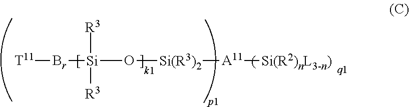

In formula (C),
T¹¹ represents a monovalent group that does not contain a reactive silyl group;
each B independently represents —O— or —C(═O)—;
each r independently represents 0 or 1;
each R³ independently represents a hydrocarbon group;
each k1 independently represents a number of 1 or larger;
p1 represents an integer of 1 or larger,
A¹¹ represents a (p1+q1)-valent linking group;
q1 represents an integer of 1 or larger,
each R² independently represents a hydrocarbon group;
each L independently represents a hydrolyzable group, a group having a hydrolyzable group, or a hydroxy group; and
each n independently represents an integer from 0 to 2.

In formula (C), R³ and k1 are the same as R³ and k1 in formula (B1).

R², L, and n are the same as R², L, and n in formula (S1).

In formula (C), T¹¹ represents a monovalent group.

Examples of T¹¹ include alkyl group, T¹₃M¹- (where, M¹ represents Si, Sn, or Ge, and each T¹ independently represents a hydrocarbon group or a trialkylsilyloxy group; T¹₃M¹-R¹— (where M¹ represents Si, Sn or Ge, each T¹ independently represents a hydrocarbon group or a trialkylsilyloxy group, and R¹ represents an alkylene group); monovalent cyclic polysiloxane residue or monovalent cage-like polysiloxane residue; and combination of the monovalent cyclic polysiloxane residue or the monovalent cage-like polysiloxane residue, with a divalent hydrocarbon group.

The alkyl group represented by T¹¹ may be any of linear alkyl group, branched alkyl group, and cycloalkyl group. Linear alkyl group or branched alkyl group is preferred. The number of carbon atoms in the alkyl group may be 1, or 2 or larger. In a case where the alkyl group has two or more carbon atoms, the number of carbon atoms is preferably 2 to 30, more preferably 3 to 28, and still more preferably 4 to 22.

M¹ in T¹₃M¹- and T¹₃M¹-R¹— preferably represents Si.

T¹ in T¹₃M¹- and T¹₃M¹-R¹— preferably represents an alkyl group or a trialkylsilyloxy group, and more preferably a methyl group, butyldimethylsilyloxy group, trimethylsilyloxy group, or triethylsilyloxy group.

R¹ preferably represents an alkylene group having 1 to 20 carbon atoms, more preferably an alkylene group having 1 to 10 carbon atoms, and still more preferably an alkylene group having 1 to 5 carbon atoms. Ethylene group is particularly preferred.

In one aspect, T¹¹ preferably represents an alkyl group or a trialkylsilyl group, and more preferably represents a methyl group or a trimethylsilyl group.

The monovalent cyclic polysiloxane residue is preferably a group represented by formula (T1) below.

In formula (T1),
each R^{T} independently represents a hydrocarbon group or a hydrocarbon group having substituent, and
s represents an integer from 1 to 4.

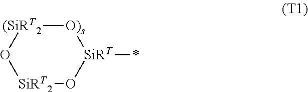

Examples of the hydrocarbon group represented by R^{T} include aliphatic hydrocarbon group and aromatic hydrocarbon group. In particular, the hydrocarbon group is preferably aliphatic hydrocarbon group, and more preferably alkyl group.

The alkyl group, from among the hydrocarbon group represented by R^{T}, may be any of linear alkyl group, branched alkyl group, and cycloalkyl group. Linear alkyl group is preferred. The number of carbon atoms in the alkyl group is preferably 1 to 10, more preferably 1 to 8, and still more preferably 1 to 4. More specifically, the alkyl group is preferably methyl group, ethyl group, n-propyl group, or n-butyl group, wherein methyl group is more preferred.

Examples of the hydrocarbon group, contained in the substituted hydrocarbon group represented by R^{T}, include aliphatic hydrocarbon group and aromatic hydrocarbon group. In paRTicular, the hydrocarbon group is preferably aliphatic hydrocarbon group, and more preferably alkyl group. The alkyl group may be any of linear alkyl group, branched alkyl group, and cycloalkyl group. Linear alkyl group is preferred. The number of carbon atoms in the alkyl group contained in the substituted alkyl group is preferably 1 to 10, more preferably 1 to 8, and still more preferably 2 to 4.

Examples of the substituent, in the substituted hydrocarbon group represented by R^{T}, include halogen atom, hydroxy group, alkoxy group, trialkylsilyl ether group, trialkylsilyl group, amino group, nitro group, cyano group, sulfonyl group, and trifluoromethyl group.

The plurality of R^{T} may be the same or different from each other, and is preferably the same, from the viewpoint of ease of production.

Examples of the monovalent cyclic polysiloxane residue include the groups below:

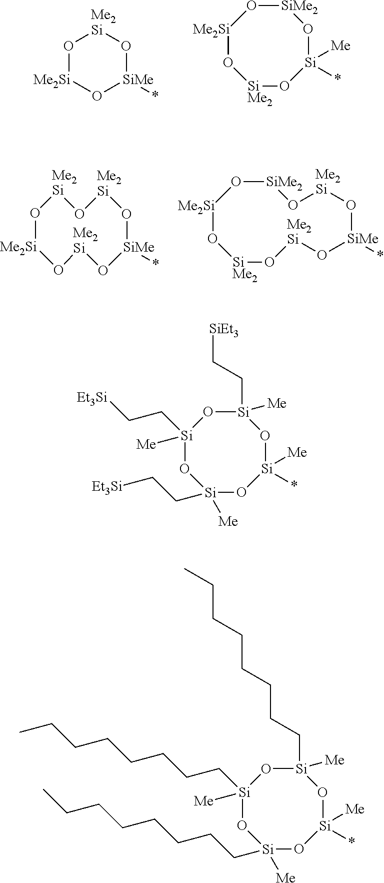

The monovalent cage-like polysiloxane residue is preferably a group represented by formula (T2) below.

In formula (T2),
each R⁵ independently represents a hydrocarbon group or a trialkylsilyloxy group.

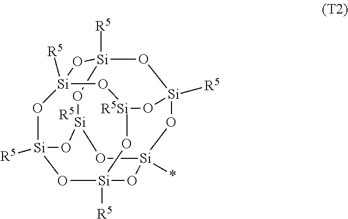

Examples of the hydrocarbon group represented by R⁵ include aliphatic hydrocarbon group and aromatic hydrocarbon group. In particular, the hydrocarbon group is preferably aliphatic hydrocarbon group, and more preferably alkyl group. The alkyl group may be any of linear alkyl group, branched alkyl group, or cycloalkyl group. Linear alkyl group or branched alkyl group is preferred; methyl group, ethyl group, n-propyl group, n-butyl group, or isobutyl group is more preferred; and isobutyl group is still more preferred.

The alkyl group contained in the trialkylsilyloxy group represented by R⁵ may be any of linear alkyl group, branched alkyl group, or cycloalkyl group. Linear alkyl group is preferred; methyl group, ethyl group, n-propyl group, or n-butyl group is more preferred; and methyl group is still more preferred. In a case where R⁵ represents a trialkylsilyloxy group, the three alkylsilyloxy groups may be the same or different from each other, and are preferably the same, from the viewpoint of ease of production.

Examples of the monovalent cage-like polysiloxane residue include the groups below:

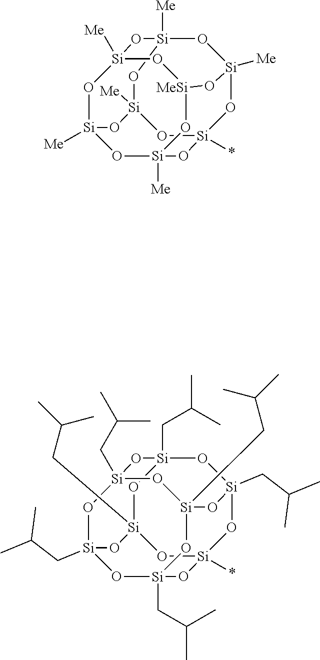

Examples of the divalent hydrocarbon group, in the combination of the monovalent cyclic polysiloxane residue or the monovalent cage-like polysiloxane residue, with the divalent hydrocarbon group, include alkylene group. The number of carbon atoms in the alkylene group is preferably 1 to 20, more preferably 1 to 10, and still more preferably 1 to 5.

In formula (C), each B independently represents —O— or —C(═O)—, wherein —O— is preferred.

In formula (C), p1 represents an integer of 1 or larger, preferably an integer of 1 to 3, more preferably 1 or 2, and still more preferably 1.

If p1 represents 2 or larger, the plurality of T¹¹-Bᵣ—[Si(R³)₂—O]ₖ₁—Si(R³)₂— may be the same or different from each other.

In formula (C), A¹¹ represents a (p1+q1)-valent linking group. Examples of A¹¹ include alkylene group, organo(poly)siloxane residue, polyalkylene oxide group, and combinations thereof, as well as combinations of any of these groups with (p1+1)-valent group and/or a (q1+1)-valent group.

Examples of the alkylene group include alkylene group having 1 to 30 carbon atoms, and preferably alkylene group having 1 to 20 carbon atoms, having but not necessarily at least one species selected from the group consisting of etheric oxygen atom, sulfur atom, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group.

Examples of the organo(poly)siloxane residue include group represented by the aforementioned formula (B1).

Examples of the polyalkylene oxide group include group represented by formula (XO)ₘ. Each X herein independently represents an alkylene group having 1 to 5 carbon atoms, and m represents an integer of 1 or larger. The number of carbon atoms in X is preferably 1 to 4, and more preferably 2 or 3. m preferably represents 1 to 200, more preferably 1 to 20, and still more preferably 1 to 10.

Examples of A¹¹ include A in formula A(Si(R²)ₙL₃₋ₙ)_{q1} described later.

In formula (C), q1 represents an integer of 1 or larger, which is preferably 1 to 18, more preferably 1 to 12, still more preferably 1 to 8, particularly preferably 1 to 6, and very preferably 1 to 4. In one aspect, q1 preferably represents 2 to 18, more preferably 2 to 12, still more preferably 2 to 8, particularly preferably 2 to 6, and very preferably 2 to 4. q1 may also represent 1.

If q1 represents an integer of 2 or larger, the plurality of [Si(R²)ₙL₃₋ₙ] may be the same or different from each other.

In one aspect, T¹¹ in formula (C) preferably represents a trialkylsilyl group or an alkyl group, and more preferably represents a trimethylsilyl group or a methyl group.

B preferably represents O, and r represents 0 or 1.

R³ preferably represents a methyl group.

k1 preferably represents 1 to 100.

p1 preferably represents 1.

A¹¹ preferably represents an alkylene group having 1 to 30 carbon atoms, or a group that remains after removal of Si(R²)ₙL₃₋ₙ from a group (3-1A) described later, and more preferably represents an alkylene group having 1 to 30 carbon atoms, or a group that remains after removal of Si(R²)ₙL₃₋ₙ from a group (3-1A-4) described later.

q1 preferably represents an integer from 1 to 4.

### (Compound (C2))

In further aspect, the first compound is preferably represented by formula (C2) below:

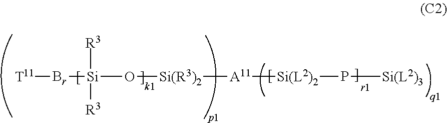

In formula (C2),
each L² independently represents a hydrolyzable group, a group having a hydrolyzable group, a hydroxy group, or a hydrocarbon group;
each of at least four L²s among all L²s represents a hydrolyzable group, a group having a hydrolyzable group, or a hydroxy group;
each P independently represents an oxygen atom, or an organic group having one carbon atom bonded to both neighboring Si; and
r1 represents an integer from 1 to 3.

Definitions of T¹¹, B, r, R³, k1, p1, A¹¹, and q1 are same as those in formula (C).

Specific aspects of T¹¹, B, r, R³, k1, p1, A¹¹, and q1 in formula (C2) are the same as the specific aspects in formula (C).

Specific aspects of L², P, and r1 in formula (C2) are the same as the specific aspects of L², P, and r1 in formula (S3).

The number average molecular weight (Mn) of the first compound is preferably 500 to 20,000, more preferably 600 to 18,000, and still more preferably 700 to 15,000. In one aspect, Mn of the first compound may also be 500 to 5,000, and may be 500 to 3,000.

With Mn set to 500 or larger, the surface treatment layer will more excel in abrasion resistance. With Mn set to 20,000 or smaller, the viscosity will be easily adjustable within an appropriate range, and the solubility will be improved, whereby handleability during film formation will be excellent.

The surface treatment agent may contain only one kind of the first compound, or two or more kinds thereof.

The surface treatment agent may contain impurity such as byproduct produced in the production process of the first compound.

The content of the first compound, with respect to the total amount of the surface treatment agent, is preferably 0.001 to 50 mass %, more preferably 0.01 to 20 mass %, and still more preferably 0.1 to 10 mass %. For the surface treatment agent intended for use in wet coating, the content of the first compound, with respect to the total amount of the surface treatment agent, may be 0.01 to 10 mass %, may be 0.02 to 5 mass %, may be 0.03 to 3 mass %, or may be 0.05 to 2 mass %.

The content of the first compound, with respect to the total solid content of the surface treatment agent, is preferably 5 mass % or more and less than 65 mass %, more preferably 10 to 64 mass %, may also be 20 to 60 mass %, and may be 30 to 50 mass %.

### [Second Compound]

The second compound has a linear organo(poly)siloxane residue, and reactive silyl groups individually bound to both terminals of the linear organo(poly)siloxane residue. In the present disclosure, the “reactive silyl groups individually bound to both terminals of the linear organo(poly)siloxane residue” means each reactive silyl group is bound to each of both terminals of the linear organo(poly)siloxane residue directly, or indirectly while placing other chemical structure in between.

### (Linear Organo(Poly)Siloxane Residue)

The second compound contains the linear organo(poly)siloxane residue. The second compound may have one, or two or more linear organo(poly)siloxane residues. In a case where the second compound contains two or more linear organo(poly)siloxane residues, such two or more linear organo(poly)siloxane residues may be the same or different. In a case where the second compound contains two or more linear organo(poly)siloxane residues, it suffices that at least one linear organo(poly)siloxane residue has the reactive silyl groups bound to both terminals thereof.

Details of the linear organo(poly)siloxane residue are as described above in the section regarding the linear organo(poly)siloxane residue contained in the specific silane compound. In particular, the linear organo(poly)siloxane residue is preferably represented by formula (B1) or (B2), and more preferably represented by formula (B1).

### (Reactive Silyl Group)

Details of the reactive silyl group are as described above in the section regarding the reactive silyl group contained in the specific silane compound.

The number of the reactive silyl groups contained in the second compound is 1 or larger, per one terminal of the linear organo(poly)siloxane residue. From the viewpoint of further improving the abrasion resistance of the surface treatment layer, the number, per one terminal of the linear organo(poly)siloxane residue, is preferably 1 to 18, more preferably 1 to 12, still more preferably 1 to 8, particularly preferably 1 to 6, and very preferably 1 to 4. In one aspect, the number of reactive silyl groups contained in the second compound, per one terminal of the linear organo(poly)siloxane residue, is preferably 2 to 18, more preferably 2 to 12, still more preferably 2 to 8, and particularly preferably 2 to 6. The number of reactive silyl groups, per one terminal of the linear organo(poly)siloxane residue, may be one.

### (Compound (D))

In one aspect, the second compound is preferably represented by formula (D) below:

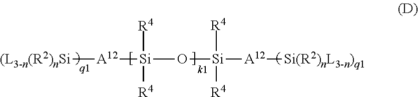

In formula (D),
each R⁴ independently represents a hydrocarbon group or T¹¹-Bᵣ—(SiR³₂—O)ₖ₁—,
each T¹¹ independently represents a monovalent group;
each B independently represents —O— or —C(═O)—;
each r independently represents 0 or 1,
each R³ independently represents a hydrocarbon group;
each k1 independently represents a number of 1 or larger;
each A¹² independently represents a (q1+1)-valent linking group;
each q1 independently represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

In formula (D), R⁴ and k1 are the same as R⁴ and k1 in formula (B2).

R², L, and n are the same as R², L, and n in formula (S1).

Examples of A¹² include alkylene group, organo(poly)siloxane residue, polyalkylene oxide group, and combinations thereof, as well as combinations of any of these groups with (q1+1)-valent group.

Examples of the alkylene group include alkylene group having 1 to 30 carbon atoms, and preferably alkylene group having 1 to 20 carbon atoms, having but not necessarily at least one species selected from the group consisting of etheric oxygen atom, sulfur atom, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group.

Examples of the organo(poly)siloxane residue include group represented by the aforementioned formula (B1) or (B2).

Examples of the polyalkylene oxide group include group represented by formula (XO)ₘ. Each X herein independently represents an alkylene group having 1 to 5 carbon atoms, and m represents an integer of 1 or larger. The number of carbon atoms in X is preferably 1 to 4, and more preferably 2 or 3. m preferably represents 1 to 100, more preferably 1 to 10, and still more preferably 1 to 5.

Examples of A¹² include (q1+1)-valent group, from among A in formula A(Si(R²)ₙL₃₋ₙ)_{q1} described later.

Each q1 independently represents an integer of 1 or larger, and independently, preferably 1 to 18, more preferably 1 to 12, still more preferably 1 to 8, particularly preferably 1 to 6, and very preferably 1 to 4. In one aspect, q1 preferably represents 2 to 18, more preferably 2 to 12, still more preferably 2 to 8, particularly preferably 2 to 6, and very preferably 2 to 4. q1 may also represent 1.

If q1 represents an integer of 2 or larger, the plurality of [Si(R²)ₙL₃₋ₙ] may be the same or different from each other.

In one aspect, R⁴ preferably represents a methyl group.

k1 preferably represents a number from 1 to 100.

A¹² preferably represents an alkylene group having 1 to 30 carbon atoms, or a group that remains after removal of Si(R²)ₙL₃₋ₙ from a group (3-1A) described later, and more preferably represents an alkylene group having 1 to 30 carbon atoms, or a group that remains after removal of Si(R²)ₙL₃₋ₙ from a group (3-1A-4) described later.

q1 preferably represents an integer from 1 to 4.

### (Compound (D2))

In further aspect, the second compound is preferably represented by formula (D2) below:

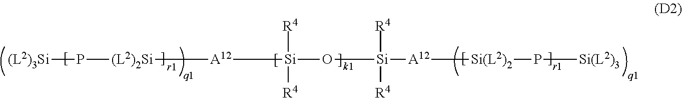

In formula (D2),
each L² independently represents a hydrolyzable group, a group having a hydrolyzable group, a hydroxy group, or a hydrocarbon group;
each of at least four L²s among all L²s represents a hydrolyzable group, a group having a hydrolyzable group, or a hydroxy group;
each P independently represents an oxygen atom, or an organic group having one carbon atom bonded to both neighboring Si; and
each r1 independently represents an integer from 1 to 3.

Definitions of R⁴, k1, A¹², and q1 are same as those in formula (D).

Specific aspects of R⁴, k1, A¹², and q1 in formula (D2) are the same as the specific aspects in formula (D).

Specific aspects of L², P, and r1 in formula (D2) are the same as the specific aspects of L², P, and r1 in formula (S3).

The number average molecular weight (Mn) of the second compound is preferably 500 to 20,000, more preferably 600 to 18,000, and still more preferably 700 to 15,000. In one aspect, Mn of the second compound may also be 500 to 5,000, and may be 500 to 3,000 or smaller.

With Mn set to 500 or larger, the surface treatment layer will further excel in abrasion resistance. With Mn set to 20,000 or smaller, the viscosity will be easily adjustable within an appropriate range, and the solubility will be improved, whereby handleability during film formation will be excellent.

The surface treatment agent may contain only one kind of second compound, or two or more kinds of second compounds.

The surface treatment agent may contain impurity such as byproduct produced in the production process of the second compound.

The content of the second compound, with respect to the total amount of the surface treatment agent, is preferably 0.001 to 50 mass %, more preferably 0.01 to 20 mass %, and still more preferably 0.1 to 10 mass %. For the surface treatment agent intended for use in wet coating, the content of the second compound, with respect to the total amount of the surface treatment agent, may be 0.01 to 10 mass %, may be 0.02 to 5 mass %, may be 0.03 to 3 mass %, and may be 0.05 to 2 mass %.

The content of the second compound, with respect to the total solid content of the surface treatment agent, is preferably more than 35 mass % and 95 mass % or less, more preferably 36 to 90 mass %, may also be 40 to 80 mass %, and may be 50 to 70 mass %. The content of the second compound may be 35 to 95 mass %.

### [Compound (E) or (E2)]

In one aspect, the specific silane compound may also be a compound represented by formula (E).

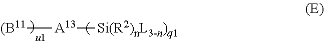

In formula (E),
B¹¹ represents a monovalent group having at least one selected from the group consisting of Si, Ge, and Sn to which a hydroxy group or a hydrolyzable group is not directly bonded; or a monovalent group having a branched alkyl group;
u1 represents an integer of 1 or larger;
A¹³ represents a (q1+u1)-valent linking group;
q1 represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

In formula (E), R², L, and n are the same as R², L, and n in formula (S1).
q1 is the same as q1 in formula (C).

B¹¹ represents a monovalent group having at least one selected from the group consisting of Si, Ge, and Sn to which a hydroxy group or a hydrolyzable group is not directly bonded; or a monovalent group having a branched alkyl group. The monovalent group having at least one selected from the group consisting of Si, Ge, and Sn to which a hydroxy group or a hydrolyzable group is not directly bonded may contain, but not necessarily, Si, Ge, or Sn to which a hydroxy group or a hydrolyzable group is directly bonded.

In one aspect, B¹¹ may represent a group having a group (a) or a group (b).

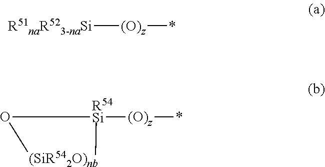

In formula (a),
R⁵¹ is a group represented by —(R⁶¹—SiR⁵³₂)ₘₐ—R³, where each R⁶¹ independently represents an oxygen atom or an alkylene group having 1 to 6 carbon atoms, each R³ independently represents a hydrocarbon group or R^{51′}, wherein R^{51′} has the same meaning as R⁵¹; ma represents an integer from 1 to 5; wherein the number of R^{51′} in R⁵¹ is 20 or smaller;
R⁵² represents a hydrocarbon group;
na represents an integer from 1 to 3,
z represents 0 or 1; and
* indicates a bonding site with a neighboring atom.

In formula (b),
each R⁵⁴ independently represents a hydrocarbon group;
nb represents an integer from 1 to 5;
z represents 0 or 1; and
* indicates a bonding site with a neighboring atom.

The alkylene group having 1 to 6 carbon atoms in R⁶¹ may be linear or branched. The alkylene group having 1 to 6 carbon atoms is preferably alkylene group having 1 to 4 carbon atoms, and more preferably alkylene group having 2 to 4 carbon atoms.

The hydrocarbon group represented by R⁵³ is preferably an alkyl group or an aryl group. The alkyl group may be linear or branched. The alkyl group is preferably an alkyl group having 1 to 6 carbon atoms, more preferably an alkyl group having 1 to 4 carbon atoms, and still more preferably methyl group, ethyl group, n-propyl group, isopropyl group, or tert-butyl group.

The hydrocarbon group represented by R⁵² is preferably an alkyl group or an aryl group. The alkyl group may be linear or branched. The alkyl group is preferably an alkyl group having 1 to 6 carbon atoms, more preferably an alkyl group having 1 to 4 carbon atoms, and still more preferably methyl group, ethyl group, n-propyl group, isopropyl group, or tert-butyl group.

Examples of the group having the group (a) or the group (b) include the group (a) or the group (b) alone, and a group composed of the group (a) or the group (b) to which a chain group is bound.

Examples of the chain group include chain hydrocarbon group; linear organo(poly)siloxane residue; group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal, or between the carbon-carbon atoms in the chain hydrocarbon group; and combinations thereof. R^{d} represents a hydrogen atom or an alkyl group (preferably having 1 to 10 carbon atoms).

Examples of the chain hydrocarbon group include linear or branched chain hydrocarbon group having 2 to 100, preferably 5 to 90, and more preferably 10 to 80 carbon atoms. The chain hydrocarbon group is preferably alkylene group. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

Examples of the linear organo(poly)siloxane residue include the examples described above as the linear organo(poly)siloxane residue in the specific silane compound.

In one aspect, B¹¹ may represent a group having a group (c):

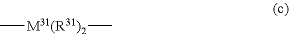

In formula (c),
M³¹ represents Sn or Ge, and
each R³¹ independently represents a hydrocarbon group or a trialkylsilyloxy group.

M³¹ represents Sn or Ge. Ge has an atomic size larger than that of Sn, and can form the surface treatment layer having more lowered surface free energy and more excellent removability of fingerprint. M³¹ therefore preferably represents Ge.

R³¹ represents a hydrocarbon group or a trialkylsilyloxy group.

Examples of the hydrocarbon group include alkyl group, cycloalkyl group, alkenyl group, and allyl group. From the viewpoint of ease of synthesis or the like, saturated hydrocarbon group is preferred, and alkyl group is more preferred. The number of carbon atoms in R³¹ is preferably 1 to 6, and more preferably 1 to 3. In particular, —CH₃ or —CH₂CH₃ is preferred.

The trialkylsilyloxy group is preferably a group represented by —O—SiR⁴⁰₃. Where, each R⁴⁰ herein independently represents a hydrocarbon group. The hydrocarbon group in R⁴⁰ is preferably an alkyl group or an aryl group, and more preferably an alkyl group. The number of carbon atoms in R⁴⁰ is preferably 1 to 6, more preferably 1 to 4, and still more preferably 1 to 2. Specific examples of the hydrocarbon group in R⁴⁰ include —CH₃, —CH₂CH₃, and —C(CH₃)₃.

Examples of the group having the group (c) include the group (c) alone, and group composed of the group (c) having an organic group bound to one side or both sides of M³¹ Examples of the organic group include monovalent organic group, divalent organic group, and combination thereof. Where, the monovalent organic group is not bound to both terminals.

Examples of the monovalent organic group include hydrocarbon group, trialkylsilyloxy group, or organopolysiloxane group. The group (c) may be M³¹(R³¹)₃—.

Examples of the divalent organic group include chain hydrocarbon group; linear organo(poly)siloxane residue; group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal, or between the carbon-carbon atoms in the chain hydrocarbon group; and combinations thereof. R^{d} represents a hydrogen atom or an alkyl group (preferably having 1 to 10 carbon atoms).

Examples of the chain hydrocarbon group include linear or branched chain hydrocarbon group having 2 to 100, preferably 5 to 90, and more preferably 10 to 80 carbon atoms. Examples of the chain hydrocarbon group include alkyl group and alkylene group. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

Examples of the linear organo(poly)siloxane residue include the examples described above as the linear organo(poly)siloxane residue in the specific silane compound.

In one aspect, B¹¹ may represent a monovalent group having a branched alkyl group. The branched alkyl group is preferably unsubstituted. The branched alkyl group is preferably a tert-butyl group, or contains a tert-butyl group. The branched alkyl group may contain one branching, or a plurality of branchings. The number of branching in the branched alkyl group may be 1 to 30, may be 1 to 20, may be 1 to 10, or may be 1 to 5.

Examples of the branched alkyl group include a group represented by a formula below:

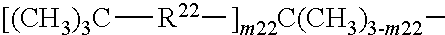

In the formula,
each R²² independently represents an alkylene group having 1 to 6 carbon atoms, and
m22 represents an integer from 0 to 3.

Examples of the monovalent group having a branched alkyl group include group having a chain group bound to a carbon atom at the branching point of the branched alkyl group.

Examples of the chain group include chain hydrocarbon group; linear organo(poly)siloxane residue; group having at least one species selected from the group consisting of —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and phenylene group, at a terminal, or between the carbon-carbon atoms in the chain hydrocarbon group; and combinations thereof.

Examples of the chain hydrocarbon group include linear or branched chain hydrocarbon group having 2 to 100, preferably 5 to 90, and more preferably 10 to 80 carbon atoms. The chain hydrocarbon group is preferably alkylene group. From the viewpoint of forming the surface treatment layer that excels in acid resistance, hot water resistance, abrasion resistance, and the like, the chain hydrocarbon group is preferably alkylene group having 13 or more carbon atoms.

The same will apply to the number of carbon atoms of the group having at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, at a terminal or between the carbon-carbon atoms in the chain hydrocarbon group. R^{d} represents a hydrogen atom or an alkyl group (preferably having 1 to 10 carbon atoms).

Examples of the linear organo(poly)siloxane residue include the examples described above as the linear organo(poly)siloxane residue in the specific silane compound.

In formula (E), u1 represents an integer of 1 or larger. From the viewpoint of ease of production and the like, u1 preferably represents 1 to 6, and more preferably 1 to 4.

In formula (E), A¹³ represents a (q1+u1)-valent linking group. Examples of A¹³ include the same specific examples as A¹¹ in formula (C).

The compound (E) may be a compound in which B¹¹ represents the group (a) or M³¹(R³¹)₃—; u1 represents 1; A¹³ represents an alkylene group having 1 to 30 carbon atoms, and having but not necessarily at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, between the carbon-carbon atoms; and q1 represents 1.

The compound (E) may also be a compound in which B¹¹ represents the group (a) or M³¹(R³¹)₃—; u1 represents 1; A¹³ represents a chain hydrocarbon group having 1 to 30 carbon atoms, and having but not necessarily at least one species selected from the group consisting of —O—, —S—, —C(═O)NH—, —NHC(═O)—, —N(R^{d})—, —C(═O)O—, —OC(═O)—, —C(═O)S—, —SC(═O)—, —S(═O)₂NH—, —NHS(═O)₂—, —S(═O)₂—, —S(═O)₂O—, —OS(═O)₂—, and phenylene group, between the carbon-carbon atoms; and q1 represents 2 or 3.

R^{d} represents a hydrogen atom or an alkyl group (preferably having 1 to 10 carbon atoms).

Specific examples of the compound (E) include the compounds below. In the formulae below, sa preferably represents 1 to 30, more preferably 4 to 20, and still more preferably 5 to 15.

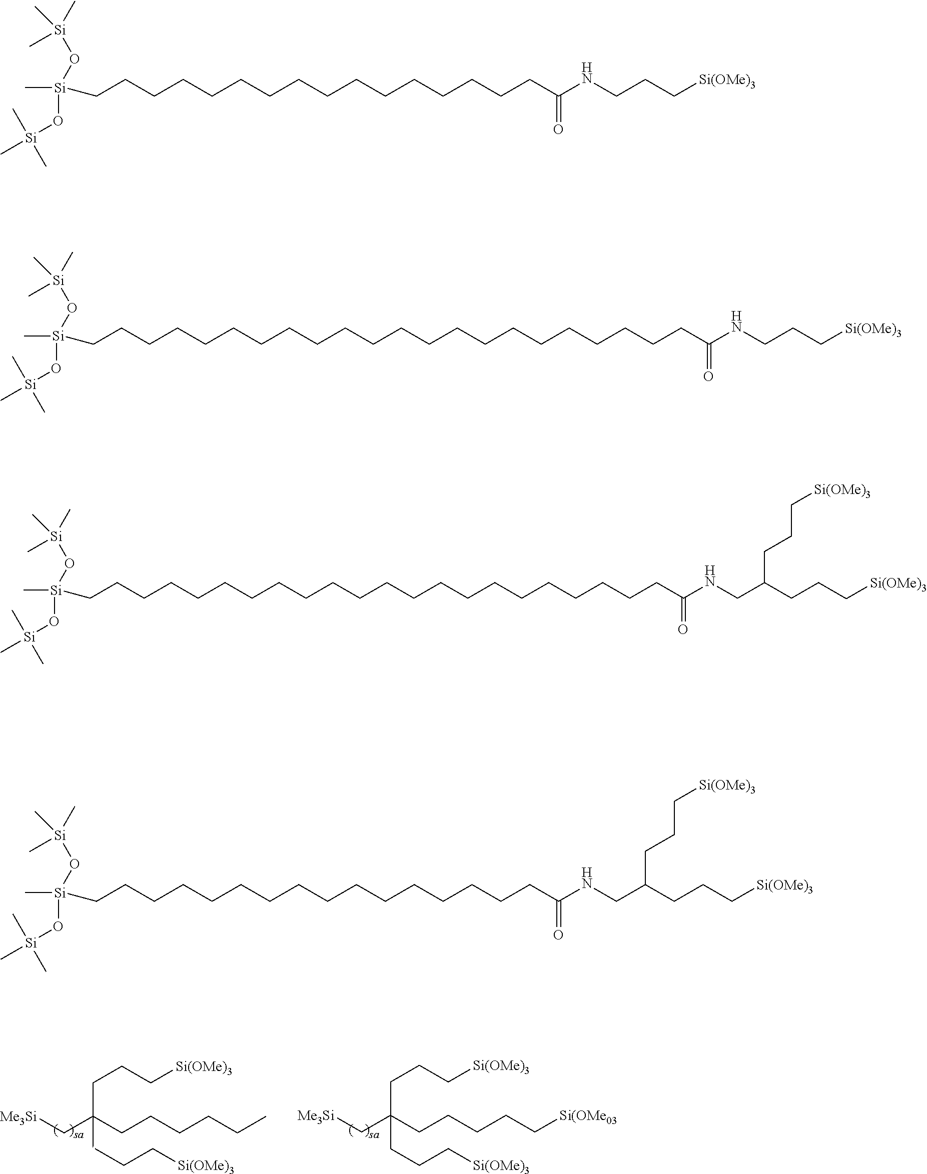

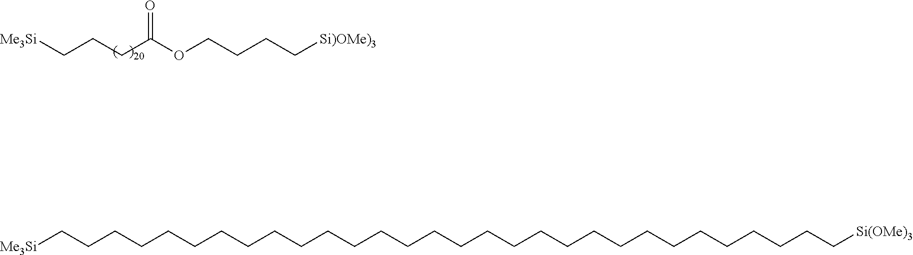

In one aspect, the specific silane compound may also be a compound represented by formula (E2)

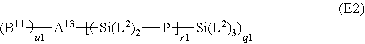

In formula (E2),
each L² independently represents a hydrolyzable group, a group having a hydrolyzable group, a hydroxy group, or a hydrocarbon group;
each of at least four L²s among all L²s represents a hydrolyzable group, a group having a hydrolyzable group, or a hydroxy group;
each P independently represents an oxygen atom, or an organic group having one carbon atom bonded to both neighboring Si; and
each r1 independently represents an integer from 1 to 3.

Definitions of B¹¹, u1, A¹³, and q1 are same as those in formula (E).

Specific aspects of B¹¹, u1, A¹³, and q1 are the same as the specific aspects in formula (E).

Specific aspects of L², P, and r1 are the same as the specific aspects in formula (S3).

### [Partial Structures of First Compound, Second Compound, and Compound (E)]

Hereinafter, preferred aspects of A¹¹(Si(R²)ₙL₃₋ₙ)_{q1} in formula (C), A¹²(Si(R²)ₙL₃₋ₙ)_{q1} in formula (D), and A¹³(Si(R²)ₙL₃₋ₙ)_{q1} in formula (E) will be described in detail. Hereinafter, A¹¹ (Si(R²)ₙL₃₋ₙ)_{q1} in formula (C), A¹²(Si(R²)ₙL₃₋ₙ)_{q1} in formula (D), and A¹³(Si(R²)ₙL₃₋ₙ)_{q1} in formula (E) will collectively be denoted as A(Si(R²)ₙL₃₋ₙ)_{q1}.

Where, A represents a (p1+q1)-valent group for formula (C), A represents a (q1+1)-valent group for formula (D), and A represents a (q1+u1)-valent group for formula (E).

The group represented by A(Si(R²)ₙL₃₋ₙ)_{q1} is preferably the group (3-1A) or group (3-1B). The group (3-1A) is more preferred.

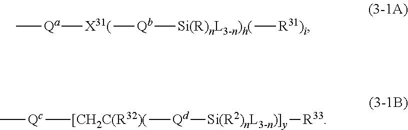

Note definitions of R², L, and n in formulae (3-1A) and (3-1B) are as described above.

In formula (3-1A), Q^{a} represents a single bond or a divalent linking group.

Examples of the divalent linking group include divalent hydrocarbon group, divalent heterocyclic group, —O—, —S—, —SO₂—, —N(R^{d})—, —C(O)—, —Si(R^{a})₂—, and group combining two or more of these groups.

The divalent hydrocarbon group may be divalent saturated hydrocarbon group, divalent aromatic hydrocarbon group, alkenylene group, or alkynylene group. The divalent saturated hydrocarbon group may be linear, branched, or cyclic, and is exemplified by alkylene group. The number of carbon atoms in the alkylene group is preferably 1 to 30, more preferably 1 to 20, still more preferably 4 to 20, and particularly preferably 5 to 15. The divalent aromatic hydrocarbon group preferably has 5 to 20 carbon atoms, and is exemplified by phenylene group. Other examples include alkenylene group having 2 to 20 carbon atoms, and alkynylene group having 2 to 20 carbon atoms.

The aforementioned R^{a} represents an alkyl group (preferably having 1 to 10 carbon atoms), or a phenyl group. The aforementioned R^{d} represents a hydrogen atom or an alkyl group (preferably having 1 to 10 carbon atoms).

Examples of the group obtained by combining two or more of them include —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, alkylene group having-C(O)N(R^{d})—, alkylene group having —N(R^{d})C(O)—, alkylene group having —OC(O)N(R^{d})—, alkylene group having an etheric oxygen atom, alkylene group having —S—, alkylene group having —OC(O)—, alkylene group having —C(O)O—, alkylene group having —C(O)S—, alkylene group having —N(R^{d})—, alkylene group having —N(R^{d})C(O)N(R^{d})—, alkylene group having —SO₂N(R^{d})—, and alkylene group-Si(R^{a})₂-phenylene group-Si(R^{a})₂.

In formula (3-1A), X³¹ represents a single bond, alkylene group, carbon atom, nitrogen atom, silicon atom, 2- to 8-valent organo(poly)siloxane residues, or group having a (h+i+1)-valent ring.

The alkylene group may have —O—, silphenylene skeleton group, divalent organo(poly)siloxane residue, or dialkylsilylene group. The alkylene group may also have a plurality of groups selected from the group consisting of —O—, silphenylene skeleton group, divalent organo(poly)siloxane residue, and dialkylsilylene group.

The number of carbon atoms in the alkylene group represented by X³¹ is preferably 1 to 20, and more preferably 1 to 10.

Examples of the 2- to 8-valent organo(poly)siloxane residues include divalent organo(poly)siloxane residue, and (w2+1)-valent organo(poly)siloxane residue described later.

In a case where X³¹ in formula (3-1A) represents a group having a (h+i+1)-valent ring, Q^{a}, (-Q^{b}-Si(R²)ₙL₃₋ₙ), and R³¹ are directly bonded to an atoms that constitute the ring. Where, the ring is other than an organopolysiloxane ring.

The ring in X³¹ may be any of monocyclic ring, fused polycyclic ring, bridged ring, spiro ring, and assembled polycyclic ring. Regarding atoms that compose the ring, the ring may also be carbon ring composed only of carbon atoms, or heterocyclic ring composed of hetero atom having a valence of 2 or larger and carbon atoms. The bond between atoms that constitute the ring may be a single bond or a multiple bond. Further, the ring may be an aromatic ring or a non-aromatic ring.

The monocyclic ring is preferably any of 4-membered ring to 8-membered rings, and more preferably 5-membered ring or 6-membered ring. The fused polycyclic ring is preferably the one having fused therein two or more 4-membered to 8-membered rings, and more preferably the one having fused therein two or three rings selected from 5-membered and 6-membered rings, or the one having one or two rings selected from 5-membered and 6-membered rings, fused with one 4-membered ring. The bridged ring is preferably the one having a 5-membered ring or a 6-membered ring as the largest ring, meanwhile the spiro ring is preferably the one composed of two of 4-membered to 6-membered rings. The assembled polycyclic ring is preferably the one having two or three rings selected from 5-membered and 6-membered rings, which are bound via a single bond, 1 to 3 carbon atoms, or one heteroatom having a valence of 2 or 3. In the assembled polycyclic ring, each ring preferably has any of Q^{a} (-Q^{b}-Si(R²)ₙL₃₋ₙ) or R³¹ (where i=1 or larger) bound thereto.

The hetero atom that constitutes the ring is preferably nitrogen atom, oxygen atom, and sulfur atom, and more preferably nitrogen atom and oxygen atom. The number of heteroatoms that constitute the ring is preferably 3 or smaller. In a case where the number of heteroatoms that constitute the ring is two or larger, these heteroatoms may be different.

The ring for X³¹ is preferably one species selected from the group consisting of a 3- to 8-membered aliphatic rings, benzene ring, 3- to 8-membered heterocyclic rings, fused ring having two or three of these rings fused therein, bridged ring having a 5-membered or a 6-membered ring as the largest ring, and assembled polycyclic ring having two or more of these rings, and having one species of linking group selected from single bond, alkylene group having 3 or less carbon atoms, oxygen atom, and sulfur atom, from the viewpoint of ease of production of the compound, and more excellent abrasion resistance of the surface treatment layer.

Preferred rings include benzene ring, 5-membered or 6-membered aliphatic ring, 5-membered or 6-membered heterocycle having nitrogen atom or oxygen atom, and fused ring having 5-membered or 6-membered carbon ring fused with any of 4- to 6-membered heterocycles.

Specific examples of the ring include the rings listed below, 1,3-cyclohexadiene ring, 1,4-cyclohexadiene ring, anthracene ring, cyclopropane ring, decahydronaphthalene ring, norbornene ring, norbornadiene ring, furan ring, pyrrole ring, thiophene ring, pyrazine ring, morpholine ring, aziridine ring, isoquinoline ring, oxazole ring, isoxazole ring, thiazole ring, imidazole ring, pyrazole ring, pyran ring, pyridazine ring, pyrimidine ring, and indene ring. Also rings having an oxo group (═O) are listed below.

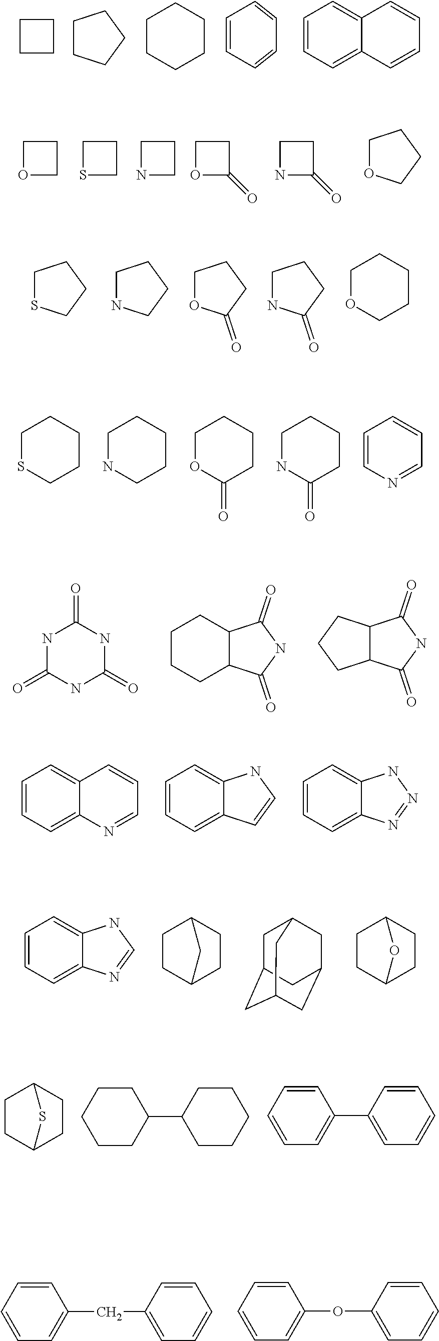

Bond of ring-constituting atom, which does not constitute the ring, in X³¹ is a bond bound to Q^{a}, (-Q^{b}-Si(R²)ₙL₃₋ₙ), or R³¹. Any residual bond, if present, is bound to a hydrogen atom or a substituent. Examples of the substituent include halogen atom, alkyl group (etheric oxygen atom may be contained between the carbon-carbon atoms), cycloalkyl group, alkenyl group, allyl group, alkoxy group, and oxo group (═O).

In a case where one of the carbon atoms that constitute the ring has two bonds bound to Q^{a}, (-Q^{b}-Si(R²)ₙL₃₋ₙ), or R³¹, such Q^{a} and (-Q^{b}-Si(R²)ₙL₃₋ₙ) may be bound to the one carbon atom, or two pieces of (-Q^{b}-Si(R²)ₙL₃₋ₙ) may be bound thereto. Q^{a} is preferably bound to a ring member atom different from that having (-Q^{b}-Si(R²)ₙL₃₋ₙ) or R³¹ bound thereto. Each of h pieces of (-Q^{b}-Si(R²)ₙL₃₋ₙ) may be bound to different ring member atoms, wherein two pieces thereof may be bound to one carbon atom that constitutes the ring. Moreover, there may be two or more carbon atoms that constitute the ring, each having two pieces of (-Q^{b}-Si(R²)ₙL₃₋ₙ) bound thereto. Each of i pieces of R³¹ may be bound to different ring member atoms, wherein two pieces thereof may be bound to one carbon atom that constitutes the ring. Moreover, there may be two or more carbon atoms that constitute the ring, each having two pieces of R³¹ bound thereto.

In particular from the viewpoint of improving the abrasion resistance of the surface treatment layer, X³¹ preferably represents a carbon atom, nitrogen atom, silicon atom, 4- to 8-valent organo(poly)siloxane residue, or group having (h+i+1)-valent ring. Carbon atom is more preferred.

In formula (3-1A), Q^{b} represents a single bond or a divalent linking group.

The definition of the divalent linking group is the same as the aforementioned definition regarding Q^{a}.

In particular, Q^{b} preferably represents an alkylene group optionally having an etheric oxygen atom. The number of carbon atoms in the alkylene group is preferably 1 to 30, more preferably 1 to 20, still more preferably 2 to 20, may be 2 to 10, may be 2 to 6, and may be 2 to 5. For example, examples include 2, 3, 8, 9, or 11. The number of carbon atoms may alternatively be 1 to 10.

In formula (3-1A), R³¹ represents a hydrogen atom, a hydroxy group, or an alkyl group. The number of carbon atoms in the alkyl group is preferably 1 to 5, more preferably 1 to 3, and still more preferably 1.

If X³¹ represents a single bond or an alkylene group, h represents 1, and i represents 0;
if X³¹ represents a nitrogen atom, h represents an integer of 1 or 2, i represents an integer of 0 or 1, and h+i=2 holds;
if X³¹ represents a carbon atom or a silicon atom, h represents an integer from 1 to 3, i represents an integer from 0 to 2, and h+i=3 holds; and
if X³¹ represents a 2- to 8-valent organo(poly)siloxane residues, h represents an integer from 1 to 7, i represents an integer from 0 to 6, and h+i=1 to 7 holds.

In a case where X³¹ represents a group having a (h+i+1)-valent ring, h represents an integer from 1 to 7, i represents an integer from 0 to 6, and h+i=1 to 7 holds.

In a case where two or more pieces of (-Q^{b}-Si(R)ₙL₃₋ₙ) are present, the two or more pieces of (-Q^{b}-Si(R)ₙL₃₋ₙ) may be the same or different. In a case where two or more pieces of R³¹ are present, the two or more pieces of (—R³¹) may be the same or different.

In particular, i preferably represents 0, from the viewpoint of improving the abrasion resistance of the surface treatment layer.

In formula (3-1B), Q^{c} represents a single bond or a divalent linking group.

The definition of the divalent linking group is the same as the aforementioned definition regarding Q^{a}.

In formula (3-1B), R³² represents a hydrogen atom or an alkyl group having from 1 to 10 carbon atoms, and preferably represents a hydrogen atom, from the viewpoint of ease of production of the compound.

The alkyl group is preferably a methyl group.

In formula (3-1B), Q^{d} represents a single bond or an alkylene group. The number of carbon atoms in the alkylene group is preferably from 1 to 10, and more preferably from 1 to 6. From the viewpoint of ease of production of the compound, Q^{d} preferably represents a single bond or CH₂—.

In formula (3-1B), R³³ represents a hydrogen atom or a halogen atom, and preferably represents a hydrogen atom, from the viewpoint of ease of production of the compound.

y represents an integer from 1 to 10, and preferably represents an integer from 1 to 6. Two or more pieces of [CH₂C(R³²)(-Q^{d}-Si(R²)ₙL₃₋ₙ)] may be the same or different.

The group (3-1A) is preferably any of groups (3-1A-1) to (3-1A-7).

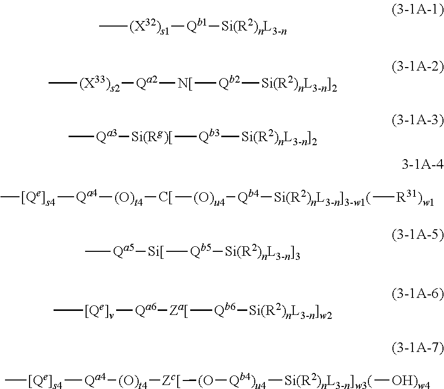

Note, definitions of R², L, and n in formulae (3-1A-1) to (3-1A-7) are as described above.

In particular, the group (3-1A) is preferably the group (3-1A-4).

In the group (3-1A-1), X³² represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d}); or combination of any of these groups with a divalent linking group (where, N in the formula is bound to Q^{b1}).

The definition of R^{d} is as described above.

s1 represents 0 or 1.

In a case where X³² is given by combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d}), with the divalent linking group, such divalent linking group is bound to Si(R³)₂ or Si(R⁴)₂ in formula (C) or (D), or, B¹¹ in formula (E).

Examples of the divalent linking group include alkylene group, organo(poly)siloxane residue, polyalkylene oxide group, and any combination thereof.

Q^{b1} represents a single bond or an alkylene group. The alkylene group may have —O—, silphenylene skeleton group, or dialkylsilylene group. The alkylene group may also have a plurality of groups selected from the group consisting of —O—, silphenylene skeleton group, divalent organo(poly)siloxane residue, and dialkylsilylene group.

The alkylene group, if having —O—, silphenylene skeleton group, divalent organo(poly)siloxane residue or dialkylsilylene group, preferably has any of these groups between the carbon-carbon atoms.

The number of carbon atoms in the alkylene group represented by Q^{b1} is preferably 1 to 30, more preferably 1 to 20, still more preferably 2 to 20, and particularly preferably 2 to 6. The number of carbon atoms may alternatively be 1 to 10.

In the group (3-1A-2), X³³ represents —O—, —S—, —N(R^{d})—, —C(O)—, —C(O)—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; or combination of any of these groups with a divalent linking group.

The definition of R^{d} is as described above.

s2 represents 0 or 1. s2 preferably represents 0, from the viewpoint of ease of production of the compound.

In a case where X³³ is given by combination of —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d}), with the divalent linking group, such divalent linking group is bound to Si(R³)₂ or Si(R⁴)₂ in formula (C) or (D), or, B¹¹ in formula (E).

Examples of the divalent linking group include alkylene group, organo(poly)siloxane residue, polyalkylene oxide group, and any combination thereof.

Q^{a2} represents a single bond, alkylene group, —C(O)—, or group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH—, between the carbon-carbon atoms of an alkylene group having two or more carbon atoms.

The number of carbon atoms in the alkylene group represented by Q^{a2} is preferably 1 to 20, more preferably 1 to 10, still more preferably 1 to 6, and particularly preferably 1 to 3.

The number of carbon atoms in the group, having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH—, between the carbon-carbon atoms of an alkylene group having two or more carbon atoms represented by Q^{a2}, is preferably 2 to 10, and more preferably 2 to 6.

Q^{a2} preferably represents a single bond, from the viewpoint of ease of production of the compound.

Q^{b2} represents an alkylene group, or a group having a divalent organo(poly)siloxane residue, an etheric oxygen atom, or —NH—, between the carbon-carbon atoms of an alkylene group having two or more carbon atoms.

The number of carbon atoms in the alkylene group represented by Q^{b2} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

The number of carbon atoms in the group, having a divalent organo(poly)siloxane residue, an etheric oxygen atom, or —NH—, between the carbon-carbon atoms of the alkylene group having two or more carbon atoms represented by Q^{b2}, is preferably 2 to 10, and more preferably 2 to 6.

Q^{b2} preferably represents —CH₂CH₂CH₂— or —CH₂CH₂OCH₂CH₂CH₂—, from the viewpoint of ease of production of the compound (where, the right side is bound to Si).

The two pieces of [-Q^{b2}-Si(R²)ₙL₃₋ₙ] may be the same or different.

In the group (3-1A-3), Q^{a3} represents a single bond, or an alkylene group optionally having an etheric oxygen atom. From the viewpoint of ease of production of the compound, Q^{a3} preferably represents a single bond.

The number of carbon atoms in the alkylene group optionally having an etheric oxygen atom is preferably 1 to 10, and particularly preferably 2 to 6.

R⁹ represents a hydrogen atom, hydroxy group, or alkyl group.

R⁹ preferably represents a hydrogen atom or an alkyl group, from the viewpoint of ease of production of the compound. The number of carbon atoms in the alkyl group is preferably 1 to 10, and more preferably 1 to 4. Methyl group is further preferred.

Q^{b3} represents an alkylene group, or a group having an etheric oxygen atom or a divalent organo(poly)siloxane residue between the carbon-carbon atoms of an alkylene group having two or more carbon atoms.

The number of carbon atoms in the alkylene group represented by Q^{b3} is preferably 1 to 30, more preferably 1 to 20, still more preferably 2 to 20, may be 2 to 10, and may be 2 to 6. The number is exemplified by 2, 3, 8, 9, or 11. The number of carbon atoms may alternatively be 1 to 10.

The number of carbon atoms in the group, having an etheric oxygen atom or a divalent organo(poly)siloxane residue, between the carbon-carbon atoms in the alkylene group having two or more carbon atoms represented by Q^{b3}, is preferably 2 to 20, more preferably 2 to 10, and still more preferably 2 to 6.

Q^{b3} preferably represents —CH₂CH₂—, —CH₂CH₂CH₂—, or —CH₂CH₂CH₂CH₂CH₂CH₂CH₂CH₂—, from the viewpoint of ease of production of the compound.

The two pieces of [-Q^{b3}-Si(R²)ₙL₃₋ₙ] may be the same or different.

In the group (3-1A-4), Q^{e} represents —C(O)O—, —SO₂N(R^{d})—, —N(R^{d})SO₂—, —N(R^{d})C(O)—, or —C(O)N(R^{d}); or combination of any of these groups with a divalent linking group.

In a case where Q^{c} is given by combination of —C(O)O—, —SO₂N(R^{d})—, —N(R^{d})SO₂—, —N(R^{d})C(O)—, or —C(O)N(R^{d})—, with the divalent linking group, such divalent linking group is bound to Si(R³)₂ or Si(R⁴)₂ in formula (C) or (D), or, B¹¹ in formula (E).

Examples of the divalent linking group include alkylene group, organo(poly)siloxane residue, polyalkylene oxide group, and any combination thereof.

The definition of R³¹ is as described above. In a case where w1 represents 1 or 2, R³¹ preferably represents a hydrogen atom.

s4 represents 0 or 1.

Q^{a4} represents a single bond, or an alkylene group optionally having an etheric oxygen atom.

The number of carbon atoms in the alkylene group optionally having an etheric oxygen atom is preferably 1 to 20, more preferably 1 to 10, still more preferably 1 to 6, and particularly preferably 1 to 3.

t4 represents 0 or 1 (and 0, if Q^{a4} represents a single bond).

From the viewpoint of ease of production of the compound, -Q^{a4}-(O)ₜ₄—, if s4 represents 0, preferably represents a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂—; and if s4 represents 1, preferably represents a single bond, —CH₂—, or —CH₂CH₂—.

Q^{b4} represents an alkylene group. The alkylene group may have —O—, —C(O)N(R^{d})— (the definition of R^{d} is as described above), silphenylene skeleton group, divalent organo(poly)siloxane residue, or dialkylsilylene group.

The alkylene group, if having —O— or silphenylene skeleton group, preferably has the —O— or the silphenylene skeleton between the carbon-carbon atoms. The alkylene group, if having —C(O)N(R^{d})—, dialkylsilylene group or divalent organo(poly)siloxane residue, preferably has any of these groups between the carbon-carbon atoms, or at the terminal on the side bound to (O)ᵤ₄.

The number of carbon atoms in the alkylene group represented by Q^{b4} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

u4 represents 0 or 1.

From the viewpoint of ease of production of the compound, —(O)ᵤ₄-Q^{b4}- preferably represents —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂₀Si(CH₃)₂CH₂CH₂CH₂—, or —CH₂CH₂CH₂Si(CH₃)₂PhSi(CH₃)₂CH₂CH₂— (where the right side is bound to Si).

w1 represents an integer from 0 to 2, preferably 0 or 1, and more preferably 0. In a case where two or more pieces of [—(O)ᵤ₄-Q^{b4}-Si(R²)ₙL₃₋ₙ] are present, the two or more pieces of [—(O)ᵤ₄-Q^{b4}-Si(R²)ₙL₃₋ₙ] may be the same or different.

In a case where two or more pieces of R³¹ are present, the two or more pieces of (—R³¹) may be the same or different.

In the group (3-1A-5), Q^{a5} represents an alkylene group optionally having an etheric oxygen atom.

The number of carbon atoms in the alkylene group optionally having an etheric oxygen atom is preferably 1 to 10, and particularly preferably 2 to 6.

From the viewpoint of ease of production of the compound, Q^{a}s preferably represents —OCH₂CH₂CH₂—, —OCH₂CH₂OCH₂CH₂CH₂—, —CH₂CH₂—, or —CH₂CH₂CH₂— (where, the right side is bound to Si).

Q^{b5} represents an alkylene group, or a group having an etheric oxygen atom or a divalent organo(poly)siloxane residue between the carbon-carbon atoms of an alkylene group having two or more carbon atoms.

The number of carbon atoms in the alkylene group represented by Q^{b5} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

The number of carbon atoms in the group, having an etheric oxygen atom or a divalent organo(poly)siloxane residue, between the carbon-carbon atoms in the alkylene group having two or more carbon atoms represented by Q^{b5}, is preferably 2 to 20, more preferably 2 to 10, and still more preferably 2 to 6.

From the viewpoint of ease of production of the compound, Q^{b5} preferably represents —CH₂CH₂CH₂— or —CH₂CH₂OCH₂CH₂CH₂— (where, the right side is bound to Si(R²)ₙL₃₋ₙ).

Three pieces of [-Q^{b5}-Si(R²)ₙL₃₋ₙ] may be the same or different.

The definition of Q^{c} in the group (3-1A-6) is as defined for the aforementioned group (3-1A-4).

v represents 0 or 1.

Q^{a6} represents an alkylene group optionally having an etheric oxygen atom.

The number of carbon atoms in the alkylene group optionally having an etheric oxygen atom is preferably 1 to 10, and particularly preferably 2 to 6.

From the viewpoint of ease of production of the compound, Q^{a6} preferably represents —CH₂OCH₂CH₂CH₂—, —CH₂OCH₂CH₂OCH₂CH₂CH₂—, —CH₂CH₂—, or —CH₂CH₂CH₂— (where the right side is bound to Z^{a}).

Z^{a} represents a (w2+1)-valent organo(poly)siloxane residue, or a group having a valence of (w2+1), and having an alkylene group between the organo(poly)siloxane residue and organo(poly)siloxane residue.

w2 represents an integer from 2 to 7.

The (w2+1)-valent organo(poly)siloxane residue, and the group having a valence of (w2+1), and having an alkylene group between the organo(poly)siloxane residue and organo(poly)siloxane residue, are exemplified by the groups below. Where, R^{a} in the following formulae is as described above. * Indicates a bonding site.

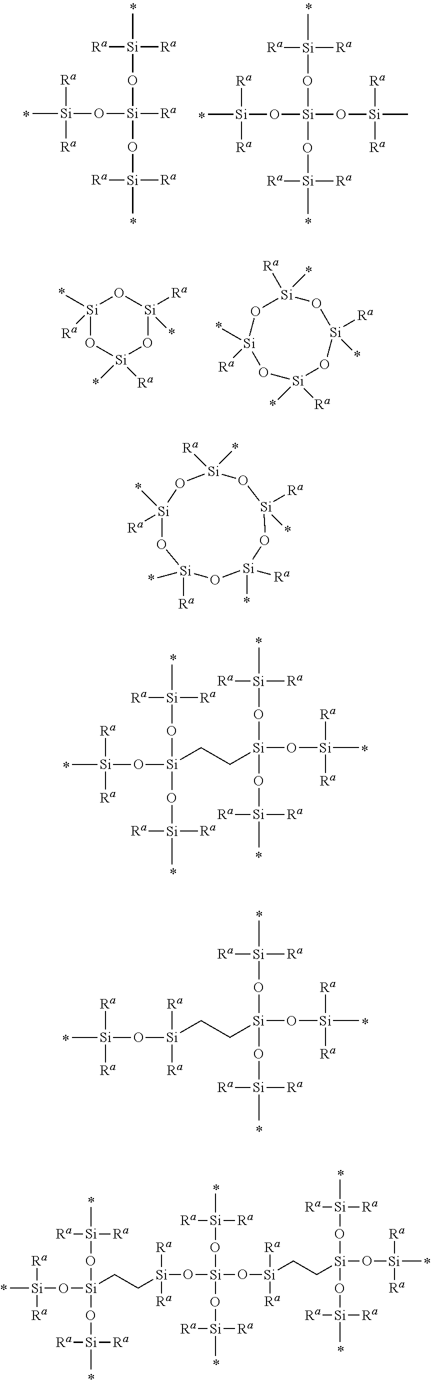

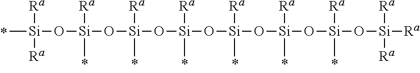

Q^{b6} represents an alkylene group, or a group having an etheric oxygen atom or a divalent organo(poly)siloxane residue between the carbon-carbon atoms of an alkylene group having two or more carbon atoms.

The number of carbon atoms in the alkylene group represented by Q^{b6} is preferably 1 to 30, more preferably 1 to 20, still more preferably 2 to 20, may be 2 to 10, and may be 2 to 6. For example, examples include 2, 3, 8, 9, or 11. The number of carbon atoms may alternatively be 1 to 10.

The number of carbon atoms in the group, having an etheric oxygen atom or a divalent organo(poly)siloxane residue, between the carbon-carbon atoms in the alkylene group having two or more carbon atoms represented by Q^{b6}, is preferably 2 to 20, more preferably 2 to 10, and still more preferably 2 to 6.

From the viewpoint of ease of production of the compound, Q^{b6} preferably represents —CH₂CH₂— or —CH₂CH₂CH₂—.

w2 pieces of [-Q^{b6}-Si(R²)ₙL₃₋ₙ] may be the same or different.

In the group (3-1A-7), Z^{c} represents a (w3+w4+1)-valent hydrocarbon group.

w3 represents an integer of 4 or larger.

w4 represents an integer of 0 or larger.

The definitions and preferred ranges of Q^{c}, s4, Q^{a4}, t4, Q^{b4}, and u4 are the same as the definitions of the respective reference signs in the group (3-1A-4).

Z^{c} may be composed of a hydrocarbon chain, may have an etheric oxygen atom between the carbon-carbon atoms of the hydrocarbon chain, and is preferably composed of a hydrocarbon chain.

The valence of Z^{c} is preferably 5 to 20, more preferably 5 to 10, still more preferably 5 to 8, and particularly preferably 5 to 6.

The number of carbon atoms in Z^{c} is preferably 3 to 50, more preferably 4 to 40, and still more preferably 5 to 30.

w3 preferably represents 4 to 20, more preferably 4 to 16, still more preferably 4 to 8, and particularly preferably 4 to 5.

w4 preferably represents 0 to 10, more preferably 0 to 8, still more preferably 0 to 6, particularly preferably 0 to 3, and most preferably 0 to 1.

In a case where two or more pieces of [—(O-Q^{b4})ᵤ₄-Si(R²)ₙL₃₋ₙ] are present, the two or more pieces of [—(O-Q^{b4})ᵤ₄-Si(R²)ₙL₃₋ₙ] may be the same or different.

A in formula A(Si(R²)ₙL₃₋ₙ)_{q1} may be groups (g2-1) to (g2-7).

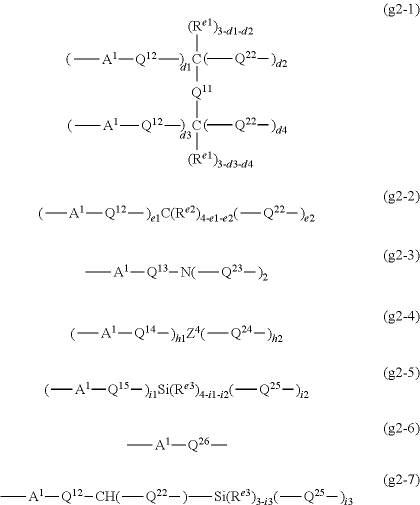

Where, in each of formulae (g2-1) to (g2-7), A¹ is given on the side bound to Si(R³)₂ or Si(R⁴)₂, meanwhile Q²², Q²³, Q²⁴, Q²⁵, or Q²⁶ is given on the side bound to [—Si(R²)ₙL₃₋ₙ].

A¹ represents a single bond, —C(O)NR⁶—, —C(O)—, —OC(O)O—, —NHC(O)O—, —NHC(O)NR⁶—, —O— or SO₂NR⁶—.

Q¹¹ represents a single bond, —O—, alkylene group, or a group having —C(O)NR⁶—, —C(O)—, —NR⁶—, or O— between the carbon-carbon atoms of an alkylene group having two or more carbon atoms.

Q¹² represents a single bond, an alkylene group, or a group having —C(O)NR⁶—, —C(O)—, —NR⁶—, or —O— between the carbon-carbon atoms of an alkylene group having two or more carbon atoms. In a case where A has two or more pieces of Q¹², such two or more pieces of Q¹² may be the same or different.

Q¹³ represents a single bond (where, A¹ represents —C(O)—), an alkylene group, a group having —C(O)NR⁶—, —C(O)—, —NR⁶—, or O— between the carbon-carbon atoms of an alkylene group having two or more carbon atoms, or a group having —C(O)— at the N-side terminal of an alkylene group.

Q¹⁴ equals to Q¹² if the atom in Z⁴ to which Q¹⁴ is bound is a carbon atom, and equals to Q¹³ if the atom in Z⁴ to which Q¹⁴ is bound is a nitrogen atom. In a case where A has two or more pieces of Q¹⁴, such two or more pieces of Q¹⁴ may be the same or different.

Q¹⁵ represents an alkylene group, or a group having —C(O)NR⁶—, —C(O)—, —NR⁶—, or —O-between the carbon-carbon atoms of an alkylene group having two or more carbon atoms. In a case where A has two or more pieces of Q¹⁵, such two or more pieces of Q¹⁵ may be the same or different.

Q²² represents an alkylene group; a group having —C(O)NR⁶—, —C(O)—, —NR⁶—, or O-between the carbon-carbon atoms of an alkylene group having two or more carbon atoms; a group having —C(O)NR⁶—, —C(O)—, —NR⁶—, or —O— at the terminal of the alkylene group on the side not bound to Si; or a group having —C(O)NR⁶—, —C(O)—, —NR⁶—, or —O— between the carbon-carbon atoms of an alkylene group having two or more carbon atoms, as well as having —C(O)NR⁶—, —C(O)—, —NR—, or O— at the terminal on the side not bound to Si. In a case where A has two or more pieces of Q²², such two or more pieces of Q²² may be the same or different.

Q²³ represents an alkylene group, or a group having —C(O)NR⁶—, —C(O)—, —NR⁶—, or —O-between the carbon-carbon atoms of an alkylene group having two or more carbon atoms, wherein two pieces of Q²³ may be the same or different.

Q²⁴ equals to Q²² if the atom in Z⁴ to which Q²⁴ is bound is a carbon atom, meanwhile equals to Q²³ if the atom in Z⁴ to which Q²⁴ is bound is a nitrogen atom. In a case where A has two or more pieces of Q²⁴, such two or more pieces of Q²⁴ may be the same or different.

Q²⁵ represents an alkylene group, or a group having —C(O)NR⁶—, —C(O)—, —NR⁶— or —O-between the carbon-carbon atoms of an alkylene group having two or more carbon atoms. In a case where A has two or more pieces of Q²⁵, such two or more pieces of Q²⁵ may be the same or different.

Q²⁶ represents an alkylene group, or a group having —C(O)NR⁶—, —C(O)—, —NR⁶—, or —O-between the carbon-carbon atoms of an alkylene group having two or more carbon atoms.

In a case where each of Q²², Q²³, Q²⁴, Q²⁵, and Q²⁶ represents an alkylene group, the number of carbon atoms is preferably 1 to 20, more preferably 1 to 10, and still more preferably 1 to 6.

Z⁴ represents a group having a (h1+h2)-valent ring structure which has a carbon atom or a nitrogen atom to which Q¹⁴ is directly bonded, and has a carbon atom or a nitrogen atom to which Q²⁴ is directly bonded.

R^{e1} represents a hydrogen atom or an alkyl group. In a case where A has two or more pieces of R^{e1}, such two or more pieces of R^{e1} may be the same or different.

R^{e2} represents a hydrogen atom, hydroxy group, alkyl group, or acyloxy group.

R^{e3} represents an alkyl group. R⁶ represents a hydrogen atom, alkyl group having 1 to 6 carbon atoms, or phenyl group.

d1 represents an integer from 0 to 3, which is preferably 1 or 2.

d2 represents an integer from 0 to 3, which is preferably 1 or 2.

d1+d2 represents an integer from 1 to 3.

d3 represents an integer from 0 to 3, which is preferably 0 or 1.

d4 represents an integer from 0 to 3, which is preferably 2 or 3.

d3+d4 represents an integer from 1 to 3.

d1+d3 represents an integer from 1 to 5, which is preferably 1 or 2.

d2+d4 represents an integer from 1 to 5, which is preferably 4 or 5.

e1+e2 represents 3 or 4.

e1 represents an integer from 1 to 3, which is preferably 1 or 2.

e2 represents an integer from 1 to 3, which is preferably 2 or 3.

h1 represents an integer of 1 or larger, which is preferably 1 or 2.

h2 represents an integer of 1 or larger, which is preferably 2 or 3.

i1+i2 represents 3 or 4.

i1 represents an integer from 1 to 3, which is preferably 1 or 2.

i2 represents an integer from 1 to 3, which is preferably 2 or 3.

i3 represents 2 or 3.

The number of carbon atoms in the alkylene groups represented by Q¹¹, Q¹², Q¹³, Q¹⁴, Q¹⁵, Q²², Q²³, Q²⁴, Q²⁵, and Q²⁶ is preferably 1 to 30, more preferably 1 to 20, still more preferably 2 to 20, may be 2 to 10, and may be 2 to 6, from the viewpoint of ease of production of the compound, and further excellence in the abrasion resistance of the surface treatment layer. For example, examples include 2, 3, 8, 9, or 11. The number of carbon atoms may alternatively be 1 to 10, may be 1 to 6, or may be 1 to 4. Where, in a case where the specific bond is present between the carbon-carbon atoms, the lower limit value of the number of carbon atoms in the alkylene group is 2.

Examples of the ring structure in Z⁴ include the ring structures described above. The same will apply to the preferred aspects. Q¹⁴ and Q²⁴ are directly bonded to the ring structure in Z⁴. In a case where an alkylene group is bound to the ring structure, therefore Q¹⁴ and Q²⁴ are not bound to the alkylene group.

The number of carbon atoms in the alkyl group represented by R^{e1}, R^{e2}, or R^{e3} is preferably 1 to 6, more preferably 1 to 3, and particularly preferably 1 or 2, from the viewpoint of ease of production of the compound.

The number of carbon atoms in an alkyl group moiety of acyloxy group represented by R^{e2} is preferably 1 to 6, more preferably 1 to 3, and particularly preferably 1 or 2, from the viewpoint of ease of production of the compound.

From the viewpoint of ease of production of the compound, and further excellence in the abrasion resistance of the surface treatment layer, h1 preferably represents 1 to 6, more preferably 1 to 4, still more preferably 1 or 2, and particularly preferably 1.

From the viewpoint of ease of production of the compound, and further excellence in the abrasion resistance of the surface treatment layer, h2 preferably represents 2 to 6, more preferably 2 to 4, and particularly preferably 2 or 3.

Examples of another aspect of A in formula A(Si(R²)ₙL₃₋ₙ)_{q1} include groups (g2-8) to (g2-14).

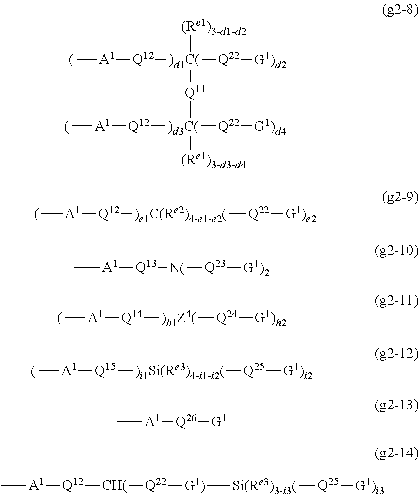

Where, in each of formulae (g2-8) to (g2-14), A¹ is given on the side bound to Si(R³)₂ or Si(R⁴)₂, meanwhile G¹ is given on the side bound to [—Si(R²)ₙL₃₋ₙ].

G¹ represents a group (g3) below. Two or more pieces of G¹ present in A may be the same or different. Reference signs other than G¹ are the same as the reference signs in formulae (g2-1) to (g2-7).

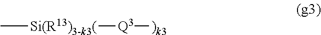

Where, in the group (g3), Si is given on the side bound to Q²², Q²³, Q²⁴, Q²⁵, or Q²⁶ meanwhile Q³ is given on the side bound to [—Si(R²)ₙL₃₋ₙ]. R¹³ represents an alkyl group. Q³ represents an alkylene group, a group having —C(O)NR⁶—, —C(O)—, —NR⁶— or O— between the carbon-carbon atoms of an alkylene group having two or more carbon atoms, or (OSi(R⁹)₂)ₚ—O—. Two or more pieces of Q³ may be the same or different. k3 represents 2 or 3. R⁶ represents a hydrogen atom, alkyl group having 1 to 6 carbon atoms, or phenyl group. R⁹ represents an alkyl group, phenyl group, or alkoxy group. Two pieces of R⁹ may be the same or different. p represents an integer from 0 to 5. If p represents 2 or larger, two or more pieces of (OSi(R⁹)₂) may be the same or different.

The number of carbon atoms in the alkylene group represented by Q³ is preferably 1 to 30, more preferably 1 to 20, still more preferably 2 to 20, may be 2 to 10, and may be 2 to 6, from the viewpoint of ease of production of the compound, and further excellence in the abrasion resistance of the surface treatment layer. For example, examples include 2, 3, 8, 9, or 11. The number of carbon atoms may alternatively be 1 to 10, may be 1 to 6, or may be 1 to 4. Where, in a case where the specific bond is present between the carbon-carbon atoms, the lower limit value of the number of carbon atoms in the alkylene group is 2.

The number of carbon atoms in the alkyl group represented by R¹³ is preferably 1 to 6, more preferably 1 to 3, and particularly preferably 1 to 2, from the viewpoint of ease of production of the compound.

The number of carbon atoms in the alkyl group represented by R⁹ is preferably 1 to 6, more preferably 1 to 3, and particularly preferably 1 to 2, from the viewpoint of ease of production of the compound.

The number of carbon atoms in the alkoxy group represented by R⁹ is preferably 1 to 6, more preferably 1 to 3, and particularly preferably 1 or 2, from the viewpoint of excellence in shelf stability of the compound.

p preferably represents 0 or 1.

### EXAMPLES OF FIRST COMPOUND AND SECOND COMPOUND

Hereinafter, specific examples of the first compound and the second compound will be described in detail.

Specific examples of the first compound include compounds (1) to (3), (4A), and (5) below.

Specific examples of the second compound include compound (4B) below.

### •Compound (1)

A compound that contains a group 1a below, a linear organo(poly)siloxane residue, a partial structure which is an alkylene chain having three or more carbon atoms or a polyalkylene oxide chain, and a group 1b below.

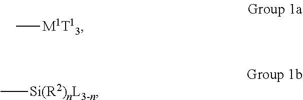

M¹ represents Si, Sn, or Ge;
each T¹ independently represents a hydrocarbon group or a trialkylsilyloxy group;
each R² independently represents a monovalent hydrocarbon group;
each L independently represents a hydrolyzable group, a group having a hydrolyzable group, or a hydroxy group; and
each n independently represents an integer from 0 to 2.
R², L, and n are the same as R², L, and n in formula (S1) above.

Details of the group 1a are the same as details of T¹₃M¹- in the description regarding T¹¹ in formula (C).

### •Compound (2)

A compound that contains an alkyl group having two or more carbon atoms, a linear organo(poly)siloxane residue, and a reactive silyl group.

### •Compound (3)

A compound that contains a group 3a below, a partial structure that contains a divalent linear organo(poly)siloxane residue, and a group 3b below, wherein the partial structure is a divalent linear organo(poly)siloxane residue, or a combination of a divalent linear organo(poly)siloxane residue with at least either an alkylene chain or a polyalkylene oxide chain.

Group 3a: monovalent cyclic polysiloxane residue, or monovalent cage-like polysiloxane residue

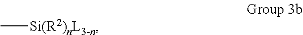

Each R² independently represents a monovalent hydrocarbon group;
each L independently represents a hydrolyzable group, a group having a hydrolyzable group, or a hydroxy group; and
each n independently represents an integer from 0 to 2.
R², L, and n are the same as R², L, and n in formula (S1) above.

### •Compounds (4A) and (4B)

Compounds represented by formula (4A) or (4B) below:

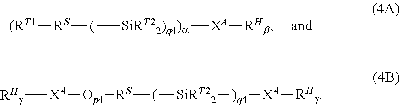

In formulae (4A) and (4B),
each R^{S} independently represents a divalent linear organosiloxane group;
each R^{T1} independently represents a hydrocarbon group;
each R^{T2} independently represents a hydrocarbon group;
p4 represents 0 or 1;
each q4 independently represents 0 or 1;
R^{H} is a group represented by any one of formulae (W1) to (W4) below;
the R^{H} has contained therein two or more Si atoms to which a hydroxy group or a hydrolyzable group is bound;
each X^{A} independently represents a single bond or a group represented by formula (W5) below;
α represents an integer from 1 to 9;
β represents an integer from 1 to 9; and
each γ independently represents an integer from 1 to 9.

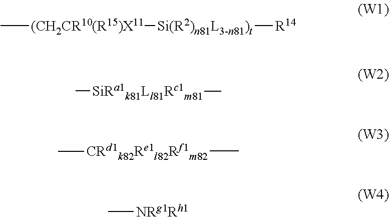

In formulae (W1) to (W4),
each L independently represents a hydrolyzable group, a group having a hydrolyzable group, or a hydroxy group;
each R² independently represents a monovalent hydrocarbon group;
each n81 independently represents an integer from 0 to 3 for each (SiR²ₙ₈₁L₃₋ₙ₈₁) unit;
each X¹¹ independently represents a single bond or a divalent organic group;
each R¹⁰ independently represents a hydrogen atom or a monovalent organic group;
each t independently represents an integer of 2 or larger;
each R¹⁴ independently represents a hydrogen atom, halogen atom, or —X¹—Si(R²)ₙ₈₁L₃₋ₙ₈₁;
each R¹⁵ independently represents a single bond, oxygen atom, alkylene group having 1 to 6 carbon atoms, or alkyleneoxy group having 1 to 6 carbon atoms;
each R^{a1} independently represents —Z⁸¹—SiR²¹ₚ₈₁L_{q81}R²³ᵣ₈₁;
each Z⁸¹ independently represents a divalent organic group;
each R²¹ independently represents —Z^{1′}—SiR^{21′}_{p1′}L_{q1′}R^{23′}_{r1′};
each R²³ independently represents a monovalent organic group;
each p81 independently represents an integer from 0 to 3;
each q81 independently represents an integer from 0 to 3;
each r81 independently represents an integer from 0 to 3;
p81+q81+r81 represents 3;
each Z^{1′} independently represents a divalent organic group;
each R^{21′} independently represents —Z^{1″}-SiL_{q1″}R^{23″}_{r1″};
each R^{23′} independently represents a monovalent organic group;
each p1′ independently represents an integer from 0 to 3;
each q1′ independently represents an integer from 0 to 3;
each r1′ independently represents an integer from 0 to 3;
p1′+q1′+r1′ represents 3;
each Z^{1″} independently represents a divalent organic group;
each R^{23″} independently represents a monovalent organic group;
each q1″ independently represents an integer from 0 to 3;
each r1″ independently represents an integer from 0 to 3;
q1″+r1″ represents 3;
each R^{c1} independently represents a monovalent organic group;
each k81 independently represents an integer from 0 to 3;
each l81 independently represents an integer from 0 to 3;
each m81 independently represents an integer from 0 to 3;
k81+l81+m81 represents 3;
each R^{d1} independently represents —Z⁸²—CR⁷¹ₚ₈₂R⁷²_{q}82R⁷³ᵣ₈₂;
each Z⁸² independently represents a single bond, oxygen atom, or divalent organic group;
each R⁷¹ independently represents —Z^{2′}—CR^{32′}_{q}2′R^{33′}_{r2′};
each R⁷² independently represents —Z⁸³—SiLₙ₈₂R³⁵₃₋ₙ₈₂;
each R⁷³ independently represents a hydrogen atom, hydroxy group, or monovalent organic group;
each p82 independently represents an integer from 0 to 3;
each q82 independently represents an integer from 0 to 3;
each r82 independently represents an integer from 0 to 3;
p82+q82+r82 represents 3;
each Z^{2′} independently represents a single bond, oxygen atom, or divalent organic group;
each R^{32′} independently represents —Z⁸³—SiLₙ₈₂R³⁵₃₋ₙ₈₂;
each R^{33′} independently represents a hydrogen atom, hydroxy group, or monovalent organic group;
each q2′ independently represents an integer from 0 to 3;
each r2′ independently represents an integer from 0 to 3;
q2′+r2′ represents 3;
each Z⁸³ independently represents a single bond, oxygen atom, or divalent organic group;
each R³⁵ independently represents a monovalent organic group;
each n82 independently represents an integer from 0 to 3;
each R^{e1} independently represents —Z⁸³—SiLₙ₈₂R³⁵₃₋ₙ₈₂;
each R^{f1} independently represents a hydrogen atom, hydroxy group, or monovalent organic group;
each k82 independently represents an integer from 0 to 3;
each l82 independently represents an integer from 0 to 3;
each m82 independently represents an integer from 0 to 3.
k82+l82+m82 represents 3;
each of R^{g1} and R^{h1} independently represents —Z⁸⁴—SiLₙ₈₁R²₃₋ₙ₈₁, —Z⁸⁴—SiR^{a1}ₖ₈₁Lₗ₈₁R^{c1}ₘ₈₁, or —Z⁸⁴—CR^{d1}ₖ₈₂R^{e1}ₗ₈₂R^{f1}ₘ₈₂; and
each Z⁸⁴ independently represents a single bond, oxygen atom, or divalent organic group;
where, in formulae (W1), (W2), (W3), and (W4), there are at least two Si atoms to which a hydrolyzable group, a group having a hydrolyzable group, or a hydroxy group is bound.
R² and L are the same as R² and L in formula (S1) above.

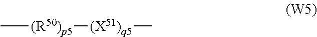

In formula (W5),
R⁵⁰ represents a single bond, —(CH₂)ₛ₅— or o-, m- or p-phenylene group,
s5 represents an integer from 1 to 20;
X⁵¹ represents —(X⁵²)ₗ₅—;
X⁵² for every occurrence independently represents a group selected from the group consisting of —O—, —S—, o-, m- or p-phenylene group, —CO—, —C(O)O—, —CONR⁵⁴—, —O—CONR⁵⁴—, —NR⁵⁴— and —(CH₂)ₙ₅—;
R⁵⁴ for every occurrence independently represents a hydrogen atom or a monovalent organic group,
n5 for every occurrence independently represents an integer from 1 to 20;
l5 represents an integer from 1 to 10;
p5 represents 0 or 1;
q5 represents 0 or 1;
at least either p5 or q5 represents 1; and the order of occurrence of (R⁵⁰)ₚ₅ and (X⁵¹)_{q5} is freely selectable.

It is preferred that each X^{A} independently represents a single bond, alkylene group having 1 to 20 carbon atoms, —(CH₂)ₛ₅—X⁵³—, —X⁵³—(CH₂)ₜ₅—, or —(CH₂)ₛ₅—X⁵³—(CH₂)ₜ₅—.

It is preferred that X⁵³ represents a single bond, —O—, —CO—, —CONR⁵⁴—, —O—CONR⁵⁴—, —O—(CH₂)ᵤ₅—CONR⁵⁴—, or —O—(CH₂)ᵤ₅—CO—;
R⁵⁴ for every occurrence independently represents a hydrogen atom, phenyl group, alkyl group having 1 to 6 carbon atoms, or oxyalkylene-containing group having 1 to 10 carbon atoms;
s5 represents an integer from 1 to 20;
t5 represents an integer from 1 to 20; and u5 represents an integer from 1 to 20.

### •Compound (5)

A compound represented by formula (5) below.

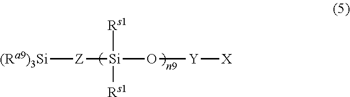

In formula (5),
Y represents a single bond or *—Si(R^{s2})₂-L^{s1}-. * Indicates a bond with an oxygen atom.
Z represents an oxygen atom, or a divalent hydrocarbon group having 1 to 10 carbon atoms.

Each R^{a9} independently represents a hydrocarbon group or a trialkylsilyloxy group. Where, in a case all of R^{a9} represent hydrocarbon groups, the hydrocarbon group represented by R^{a9} is an alkyl group.

Each of R^{s1} and R^{s2} independently represents an alkyl group having 1 to 10 carbon atoms.
L^{s1} represents a divalent hydrocarbon group having 1 to 10 carbon atoms.
X represents a group represented by any of formulae (X-1) to (X-3) below.
n9 represents a number 1 to 150.

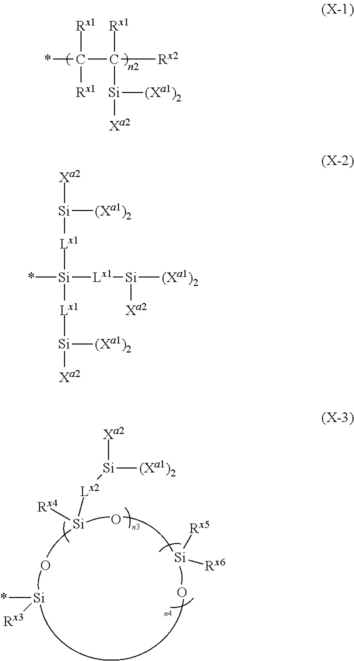

In formulae (X-1) to (X-3),
each of L^{x1} and L^{x2} independently represents a divalent hydrocarbon group having 1 to 20 carbon atoms, and a methylene group (—CH₂—) contained in the divalent hydrocarbon group may be replaced with —O— or —O—Si(R^{x7})₂—.

Each of R^{x1} to R^{x7} independently represents a hydrogen atom, or a hydrocarbon group having 1 to 10 carbon atoms.

Each X^{a1} independently represents a hydrolyzable group, a group having a hydrolyzable group, or a trialkoxysilyloxy group.

Each X^{a2} independently represents a trialkylsilyl-containing group, a hydrocarbon chain-containing group, a siloxane skeleton-containing group, a hydrolyzable group, a group having a hydrolyzable group, or a trialkoxysilyloxy group. In a case where X^{a2} represents a hydrolyzable group, X^{a2} and X^{a1} may be the same or different.
n2 represents an integer from 1 to 50.
n3 represents a number from 2 to 5.
n4 represents a number from 0 to 5.

In formula (X-3), the sequential order of units represented by (Si(R^{x4})(-L^{x2}-Si(X^{a2})(X^{a1})₂)—O—) and (Si(R^{x5})(R^{x6})—O—) is freely selectable.

Hereinafter, the compounds (1) to (5) will be described.

### (Compound (1))

The compound (1) is preferably represented by formula (1A) below:

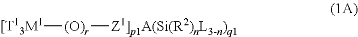

In formula (1A),
M¹ represents Si, Sn, or Ge;
each T¹ independently represents a hydrocarbon group or a trialkylsilyloxy group;
r represents 0 or 1;
each Z¹ independently represents an alkylene chain or a polyalkylene oxide chain, or, combination of an alkylene chain with a divalent linear organo(poly)siloxane residue; A represents a single bond or a (p1+q1)-valent linking group;
each R² independently represents a monovalent hydrocarbon group;
each L independently represents a hydrolyzable group, a group having a hydrolyzable group, or a hydroxy group;
each n independently represents an integer from 0 to 2; and
each of p1 and q1 independently represents an integer of 1 or larger.

Where, in a case where each Z¹ independently represents an alkylene chain or a polyalkylene oxide chain, A represents a (p1+q1)-valent linking group that contains a linear organo(poly)siloxane residue.

T¹ and M¹ are the same as T¹ and M¹ in the group 1a, and will not be described.

M¹ preferably represents Si.

T¹ preferably represents a trialkylsilyloxy group. Butyldimethylsilyloxy group, trimethylsilyloxy group, or triethylsilyloxy group is more preferred.

R², L, and n are the same as R², L, and n in formula (S1) above.

The combination of an alkylene chain and a divalent linear organo(poly)siloxane residue represented by Z¹ is preferably represented by formula (D3), (D4), or (D5) below:

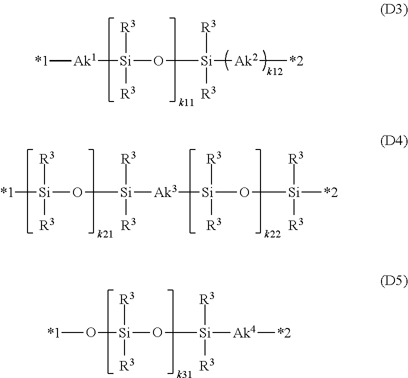

In formula (D3), each of Ak¹ and Ak² independently represents an alkylene chain. R³ is the same as R³ in formula (B1). k11 represents a number of 1 or larger. k12 represents 0 or 1.

In formula (D4), Ak³ represents an alkylene chain. R³ is the same as R³ in formula (B1). Each of k21 and k22 independently represents a number of 1 or larger.

In formula (D5), Ak⁴ represents an alkylene chain. R³ is the same as R³ in formula (B1). k31 represents a number of 1 or larger.

In formulae (D3), (D4), or (D5), *1 indicates the side bound to the group 1a, and *2 indicates the side bound to the group 1b.

A may only be a group unlikely to damage the effect of the present disclosure, and examples thereof include alkylene group optionally having an etheric oxygen atom or a divalent linear organo(poly)siloxane residue, carbon atom, nitrogen atom, silicon atom, 2- to 8-valent linear organo(poly)siloxane residues, and group that remains after removal of Si(R²)ₙL₃₋ₙ from the group (3-1A), group (3-1B), and groups (3-1A-1) to (3-1A-7).

A may have a triptycene structure. The triptycene structure refers to a partial structure that remains after removal of two or more hydrogen atoms from triptycene.

A may also be any of the groups (g2-1) to (g2-14).

p1 represents an integer of 1 or larger. From the viewpoint of more excellent water repellency of the surface treatment layer, p1 preferably represents 1 to 6, and more preferably 2 to 4. p1 may also represent 1.

In a case where p1 represents 2 or larger, the plurality of [T¹₃M¹-(O)ᵣ—Z¹] may be the same or different from each other.

q1 represents an integer of 1 or larger. From the viewpoint of more excellent abrasion resistance of the surface treatment layer, q1 preferably represents 1 to 15, which is more preferably 1 to 6, still more preferably 2 to 6, particularly preferably 2 to 4, and extremely preferably 2 or 3. q1 may also represent 1.

If q1 represents 2 or larger, the plurality of [Si(R²)ₙL₃₋ₙ] may be the same or different from each other.

Preferred aspect of the group A(Si(R²)ₙL₃₋ₙ)_{q1} in formula (1A) is the same as the preferred aspect of the group A(Si(R²)ₙL₃₋ₙ)_{q1} described previously in the section titled “Partial Structures of First Compound, Second Compound, and Compound (E)”. Where, A in the group A(Si(R²)ₙL₃₋ₙ)_{q1} is bound to [T¹₃M¹-(O)ᵣ—Z¹]ₚ₁ in formula (1A). In a case where the terminal of Z¹ on the side bound to A has an alkylene chain, the terminal of A on the side bound to Z¹ does not have an alkylene chain. In a case where the terminal of Z¹ on the side bound to A has a polyalkylene oxide chain, the terminal of A on the side bound to Z¹ does not have a polyalkylene oxide chain.

The compound (1) is preferably represented by a compound represented by formula (1B) below:

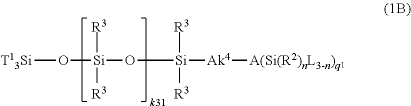

In formula (1), T¹ is the same as T¹ in the group 1a.

R³ is the same as R³ in formula (B1). k31 is the same as k31 in formula (D5).

A group represented by A(Si(R²)ₙL₃₋ₙ)_{q1} is the same as the group represented by A(Si(R²)ₙL₃₋ₙ)_{q1} in formula (1A).

Ak⁴ is the same as Ak⁴ in formula (D5).

The compound (1) is preferably represented by a compound represented by formula (1C), formula (1D), or formula (1E) below:

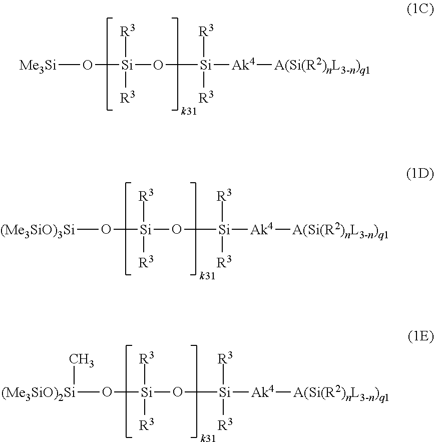

R³ in formula (1C), formula (1D) and formula (1E) is the same as R³ in formula (B1). k31 is the same as k31 in formula (D5).

A group represented by A(Si(R²)ₙL₃₋ₙ)_{q1} is the same as the group represented by A(Si(R²)ₙL₃₋ₙ)_{q1} in formula (1A).

Ak⁴ is the same as Ak⁴ in formula (D5).

Specific examples of the compound (1) include the compound below.

In formula below, n10 represents a number of 1 or larger, preferably a number from 1 to 60, may be a number from 3 to 50, may be a number from 5 to 30, and may be a number from 7 to 25.

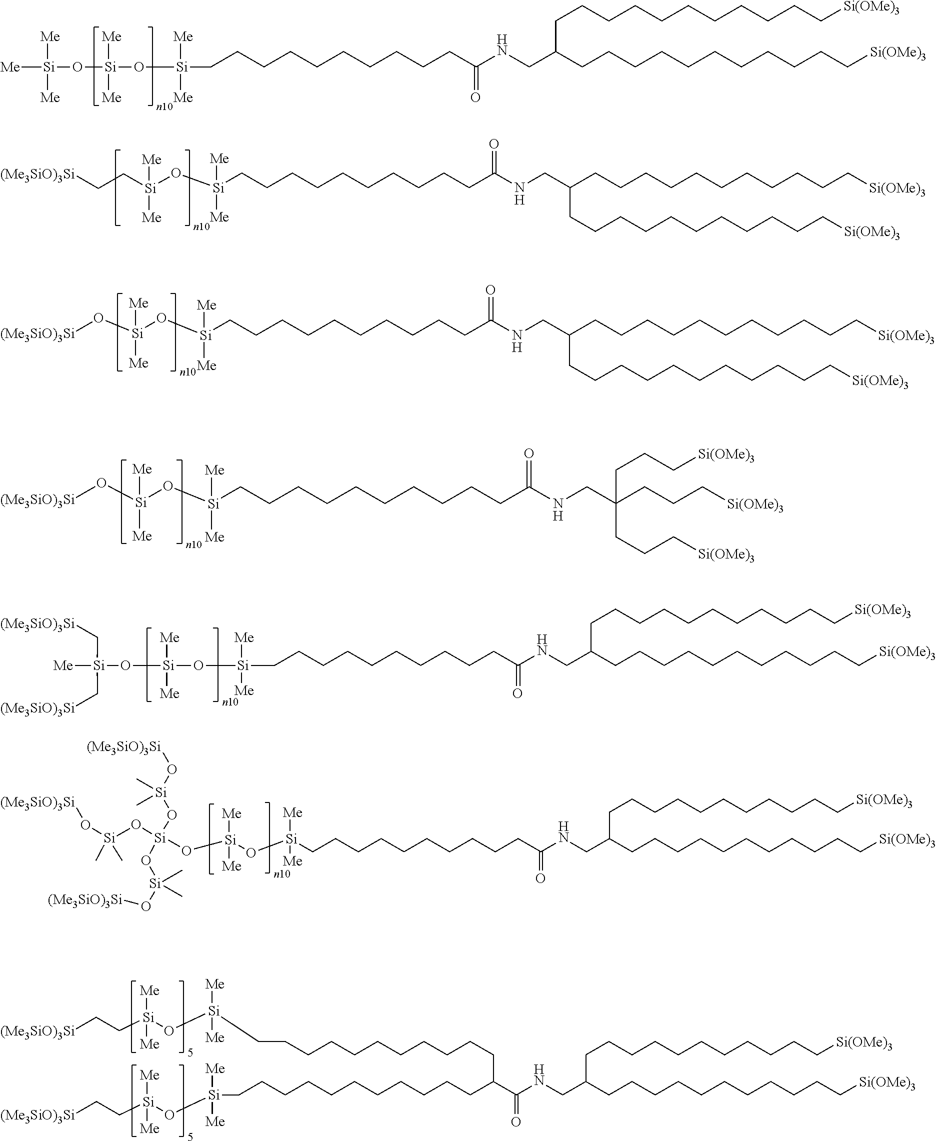

In the formula below, k preferably represents 1 to 80, more preferably 3 to 50, and still more preferably 3 to 30. m preferably represents 1 to 30, more preferably 3 to 20, and still more preferably 3 to 10. t preferably represents 1 to 30, more preferably 3 to 20, and still more preferably 3 to 10.

In formula below, n10 represents a number of 1 or larger, preferably a number from 1 to 60, may be a number from 3 to 50, may be a number from 5 to 30, and may be a number from 7 to 25.

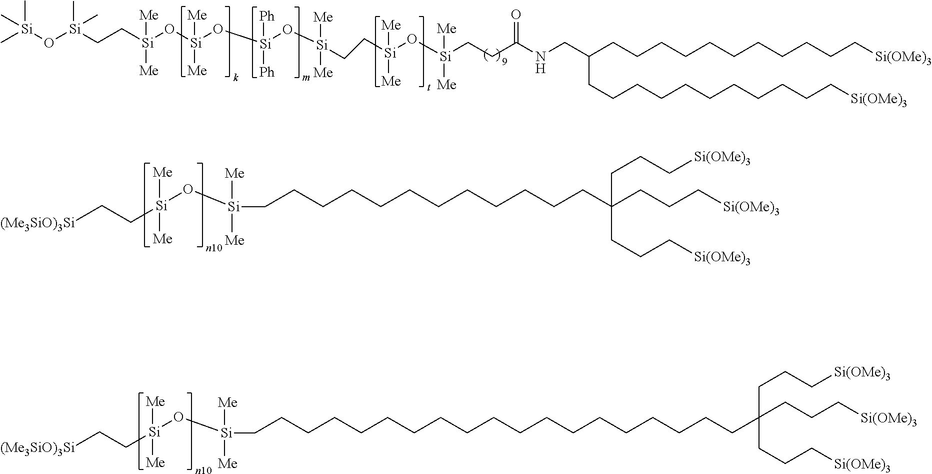

In formula below, n10 represents a number of 1 or larger, preferably a number from 1 to 60, may be a number from 3 to 50, may be a number from 5 to 30, and may be a number from 7 to 25.

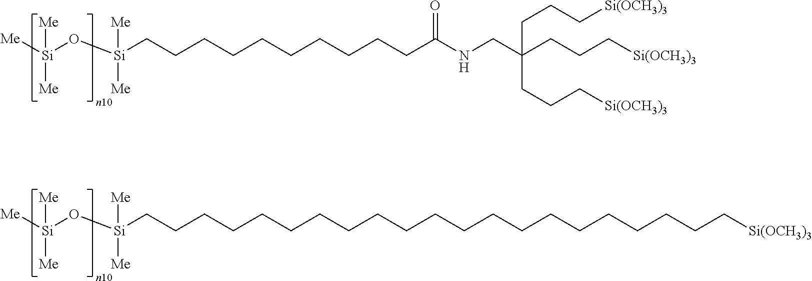

### (Compound (2))

In the compound (2), the alkyl group means an unsubstituted alkyl group. The alkyl group may be any of linear alkyl group, branched alkyl group, and cycloalkyl group. Linear alkyl group or branched alkyl group is preferred. The number of carbon atoms in the alkyl group is preferably 2 to 30, more preferably 3 to 28, and still more preferably 4 to 22.

In the compound, only one, or two or more alkyl groups may be contained.

The alkyl group, which is a monovalent group, is located at the terminal of the compound.

The compound (2) is preferably represented by formula (2A) below:

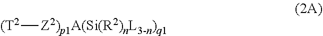

In formula (2A),
T² represents an alkyl group having two or more carbon atoms;
Z² represents a divalent linear organo(poly)siloxane residue;
A represents a single bond or a (p1+q1)-valent linking group;
each R² independently represents a monovalent hydrocarbon group;
each L independently represents a hydrolyzable group, a group having a hydrolyzable group, or a hydroxy group;
n represents an integer from 0 to 2; and
each of p1 and q1 independently represents an integer of 1 or larger.

Preferred aspects of the alkyl group having two or more carbon atoms represented by T2 are as described above.

The divalent linear organo(poly)siloxane residue represented by Z² is preferably the group represented by the aforementioned formula (B1).

R², L, and n are the same as R², L, and n in formula (S1) above.

The group represented by A(Si(R²)ₙL₃₋ₙ)_{q1} is the same as the group represented by A(Si(R²)ₙL₃₋ₙ)_{q1} in formula (1A), except for details given below.

p1 and q1 are the same as p1 and q1 in formula (1A) above.

The group represented by A(Si(R²)ₙL₃₋ₙ)_{q1} is preferably the group (3-1A) or group (3-1B). The group (3-1A) is more preferred.

In formula (3-1A), Q^{a} represents a single bond or a divalent linking group.

Where, the terminal of Q^{a} on the side bound to Z² does not have an oxysilyl group.

In formula (3-1A), X³¹ represents a single bond, alkylene group, carbon atom, nitrogen atom, silicon atom, 2- to 8-valent organo(poly)siloxane residues, or group having a (h+i+1)-valent ring.

Where, in a case where Q^{a} represents a single bond, the terminal of X³¹ on the side bound to Z² does not have an oxysilyl group. In cases other than the above, the terminal of X³¹ may have an oxysilyl group.

In formula (3-1A), Q^{b} represents a single bond or a divalent linking group.

Where, in a case where each of Q^{a} and X³¹ represents a single bond, the terminal of Q^{b} on the side bound to Z² does not have an oxysilyl group. In cases other than the above, the terminal of Q^{b} may have an oxysilyl group.

In a case where h represents 1, and Q^{b} represents an alkylene group, the Q^{b}-side terminal of Q^{a}-X³¹ does not have an alkylene group.

In formula (3-1B), Q^{c} represents a single bond or a divalent linking group.

Where, the terminal of Q^{c} on the side bound to Z² does not have an oxysilyl group.

The group (3-1A) is preferably any of groups (3-1A-1) to (3-1A-7).

Where, each of the terminals of the groups (3-1A-1) to (3-1A-7) on the side bound to Z² does not have an oxysilyl group.

In the group (3-1A-1), X³² preferably represents —O—, —S—, —N(R^{d})—, —C(O)—, —C(O)S—, —N(R^{d})C(O)N(R^{d})—, —OC(O)N(R^{d})—, or —C(O)N(R^{d})—, wherein —C(O)O— or —C(O)N(R^{d})— is more preferred.

s1 preferably represents 0, and Q^{b1} preferably represents an alkylene group having 2 to 6 carbon atoms.

In the group (3-1A-2), X³³ preferably represents —O—, —C(O)O—, or —C(O)N(R^{d})—.

A in formula (2A) may also be any of the groups (g2-1) to (g2-7).

Where, in each of formulae (g2-1) to (g2-7), A¹ is given on the side bound to Z², meanwhile Q²², Q²³, Q²⁴, Q²⁵, or Q²⁶ is given on the side bound to [—Si(R²)ₙL₃₋ₙ].

Examples of another aspect of A include groups (g2-8) to (g2-14).

Where, in each of formulae (g2-8) to (g2-14), A¹ is given on the side bound to Z², meanwhile G¹ is given on the side bound to [—Si(R²)ₙL₃₋ₙ].

The compound (2) is preferably a compound represented by formula (2B) below:

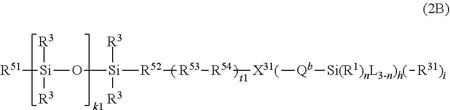

In formula (2B), R⁵¹ represents an alkyl group having two or more carbon atoms.

Each of R⁵² and R⁵⁴ independently represents an alkylene group.

R⁵³ represents —C(O)O—, —SO₂N(R^{d})—, —N(R^{d})SO₂—, —N(R^{d})C(O)—, or —C(O)N(R^{d})—.

R³ is the same as R³ in formula (B1). k1 is the same as k1 in formula (B1).

A group represented by X³¹(-Q^{b}-Si(R²)ₙL₃₋ₙ)ₕ(—R³¹)ᵢ is the same as the group represented by X³¹(-Q^{b}-Si(R²)ₙL₃₋ₙ)ₕ(—R³¹), in group (3-1A).

t1 represents 0 or 1.

Preferred aspects of the alkyl group represented by R⁵¹ are as described above in the section regarding the alkyl group.

The alkylene group represented by R⁵² may be linear, branched, or cyclic. The number of carbon atoms in the alkylene group is preferably 1 to 30, more preferably 1 to 20, still more preferably 4 to 20, and particularly preferably 5 to 15.

The alkylene group represented by R⁵⁴ may be linear, branched, or cyclic. The number of carbon atoms in the alkylene group is preferably 1 to 20, more preferably 1 to 10, still more preferably 1 to 6, and particularly preferably 1 to 3.

Specific examples of the compound (2) include the compounds below. In formula below, n10 represents a number of 1 or larger, preferably a number from 1 to 60, may be a number from 3 to 50, may be a number from 5 to 30, and may be a number from 7 to 25.

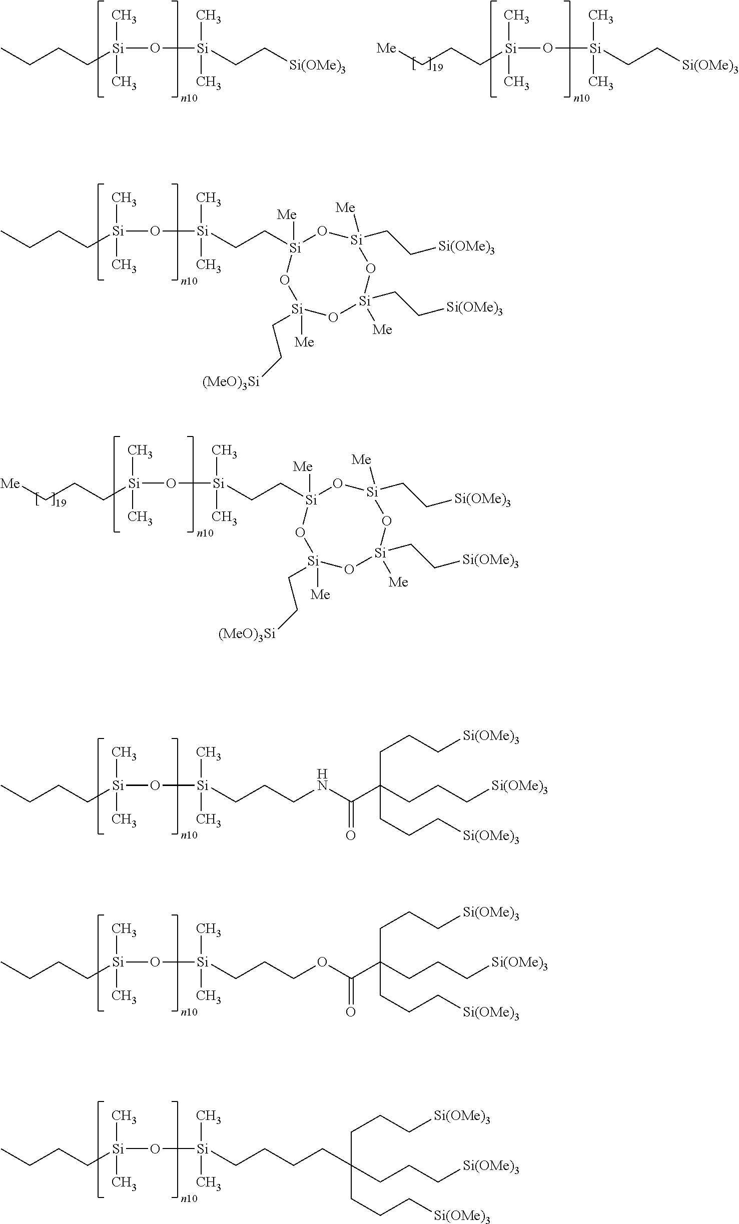

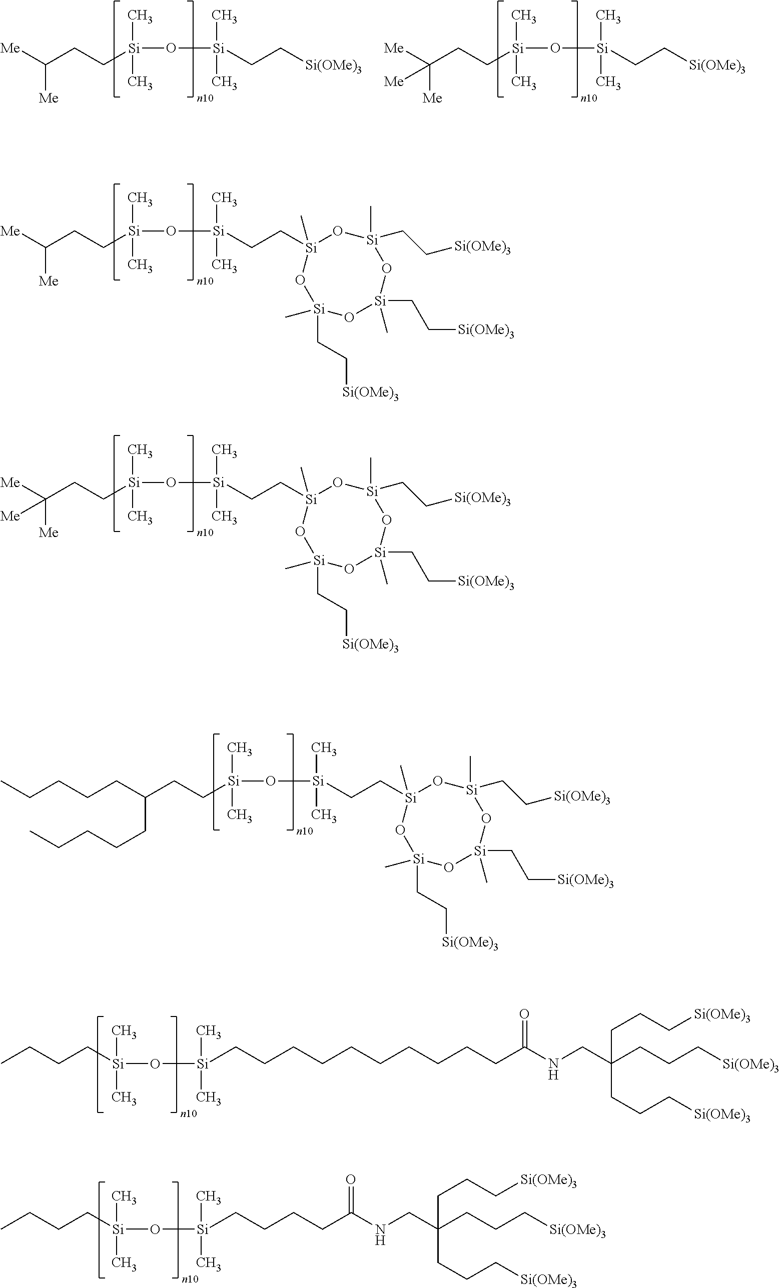

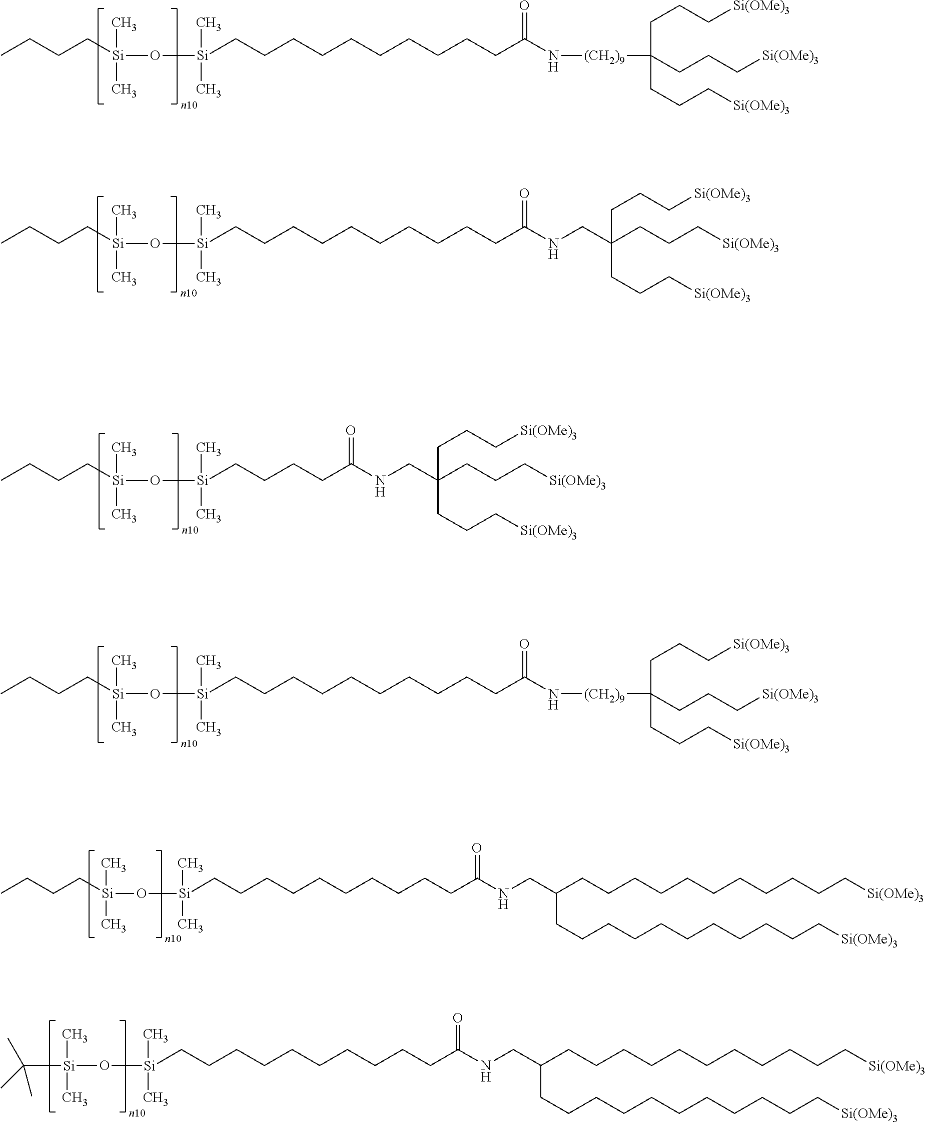

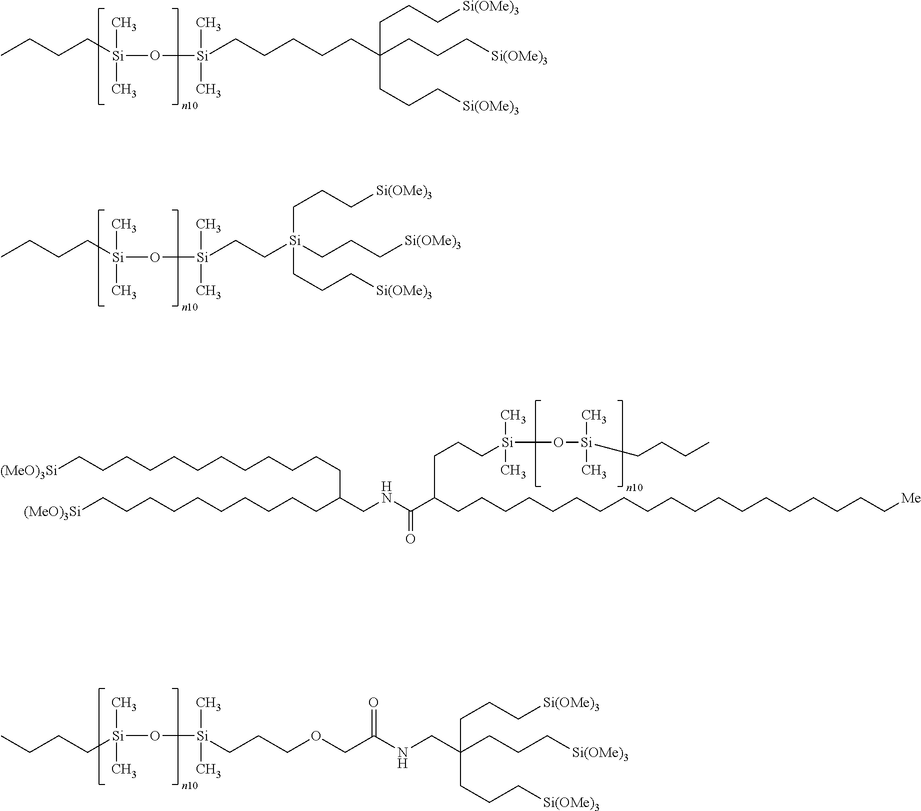

### (Compound (3))

The compound (3) is preferably represented by formula (3A) below.

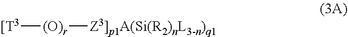

In formula (3A),
each T³ independently represents a monovalent cyclic polysiloxane residue or a monovalent cage-like polysiloxane residue;
r represents 0 or 1;
Z³ represents a divalent linear organo(poly)siloxane residue, or, combination of divalent linear organo(poly)siloxane residue, with at least either an alkylene chain or a polyalkylene oxide chain;
A represents a single bond or a (p1+q1)-valent linking group;
each R² independently represents a monovalent hydrocarbon group;
each L independently represents a hydrolyzable group, a group having a hydrolyzable group, or a hydroxy group;
each n independently represents an integer from 0 to 2; and
each of p1 and q1 independently represents an integer of 1 or larger.

R², L, and n are the same as R², L, and n in formula (S1) above.

The group represented by A(Si(R²)ₙL₃₋ₙ)_{q1} is the same as the group represented by A(Si(R²)ₙL₃₋ₙ)_{q1} in formula (1A), except for details given below.

p1 and q1 are the same as p1 and q1 in formula (1A) above.

Details of the monovalent cyclic polysiloxane residue or the monovalent cage-like polysiloxane residue are as described above in the description regarding T¹¹ in formula (C).

The group represented by A(Si(R²)ₙL₃₋ₙ)_{q1} is preferably the group (3-1A) or group (3-1B). The group (3-1A) is more preferred.

In formula (3-1A), Q^{a} represents a single bond or a divalent linking group.

Where, the terminal of Q^{a} on the side bound to Z³ has none of alkylene group, polyalkylene oxide chain, or divalent organo(poly)siloxane residue.

In a case where the A-side terminal of Z³ has an alkylene chain, Q^{a} preferably represents a divalent hydrocarbon group other than alkylene group, divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, alkylene group having —C(O)N(R^{d})—, alkylene group having —N(R^{d})C(O)—, alkylene group having —OC(O)N(R^{d})—, alkylene group having an etheric oxygen atom, alkylene group having —S—, alkylene group having —OC(O)—, alkylene group having —C(O)O—, alkylene group having —C(O)S—, alkylene group having —N(R^{d})—, alkylene group having —N(R^{d})C(O)N(R^{d})—, or alkylene group having —SO₂N(R^{d})—. Q³ more preferably represents —OC(O)—, alkylene group having —C(O)N(R^{d})—, alkylene group having —OC(O)N(R^{d})—, alkylene group having an etheric oxygen atom, alkylene group having —S—, alkylene group having —C(O)O—, alkylene group having —C(O)S—, alkylene group having —N(R^{d})—, or alkylene group having —N(R^{d})C(O)N(R^{d})—, and still more preferably represents alkylene group having —C(O)O—, or alkylene group having —C(O)N(R^{d})—.

In a case where the A-side terminal of Z³ has a polyalkylene oxide chain, Q^{a} preferably represents a divalent hydrocarbon group other than alkylene group, divalent heterocyclic group, —SO₂—, —C(O)—, —Si(R^{a})₂—, —C(O)O—, —C(O)S—, —C(O)N(R^{d})—, —SO₂N(R^{d})—, alkylene group having —C(O)N(R^{d})—, alkylene group having —C(O)O—, or alkylene group having —SO₂N(R^{d})—, wherein —C(O)— is more preferred.

In a case where the A-side terminal of Z³ has a divalent linear organo(poly)siloxane residue, Q^{a} preferably represents a divalent hydrocarbon group other than alkylene group, divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, alkylene group having-C(O)N(R^{d})—, alkylene group having —N(R^{d})C(O)—, alkylene group having OC(O)N(R^{d})—, alkylene group having an etheric oxygen atom, alkylene group having —S—, alkylene group having —OC(O)—, alkylene group having —C(O)O—, alkylene group having —C(O)S—, alkylene group having —N(R^{d})—, alkylene group having —N(R^{d})C(O)N(R^{d})—, or alkylene group having —SO₂N(R^{d})—.

In formula (3-1A), X³¹ represents a single bond, alkylene group, carbon atom, nitrogen atom, silicon atom, 2- to 8-valent organo(poly)siloxane residues, or group having a (h+i+1)-valent ring.

Where, in a case where Q^{a} represents a single bond, the terminal of X³¹ on the side bound to Z³ has none of alkylene group, polyalkylene oxide chain, or divalent organo(poly)siloxane residue. In cases other than the above, the terminal of X³¹ may have any of alkylene group, polyalkylene oxide chain, or divalent organo(poly)siloxane residue.

In formula (3-1A), Q^{b} represents a single bond or a divalent linking group.

Where, in a case where each of Q^{a} and X³¹ represents a single bond, the terminal of Q^{b} on the side bound to Z³ has none of alkylene group, polyalkylene oxide chain, or divalent organo(poly)siloxane residue. In cases other than the above, the terminal of Q^{b} may have any of alkylene group, polyalkylene oxide chain, or divalent organo(poly)siloxane residue.

In a case where each of Q^{a}, X³¹, and Q^{b} in formula (3-1A) represents a single bond, [Si(R²)ₙL₃₋ₙ] is directly bonded to Z³, where Z³ represents an alkylene chain.

In formula (3-1B), Q^{c} represents a single bond or a divalent linking group.

Where, the terminal of Q^{c} on the side bound to Z³ has none of alkylene group, polyalkylene oxide chain, or divalent organo(poly)siloxane residue.

The group (3-1A) is preferably any of groups (3-1A-1) to (3-1A-7).

Where, each of the terminals of the groups (3-1A-1) to (3-1A-7) on the side bound to Z³ has none of alkylene group, polyalkylene oxide chain, or divalent organo(poly)siloxane residue.

In a case where the A-side terminal of Z³ in the group (3-1A-1) has an alkylene group, X³² preferably represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; more preferably represents —O—, —S—, —N(R^{d})—, —C(O)O—, —C(O)S—, —N(R^{d})C(O)—, —N(R^{d})C(O)N(R^{d})—, —OC(O)N(R^{d})—, or —C(O)N(R^{d})—; and still more preferably represents —C(O)O— or —N(R^{d})C(O)—.

In a case where the A-side terminal of Z³ has a polyalkylene oxide chain, X³² preferably represents —C(O)—, —C(O)O—, —C(O)S—, —SO₂N(R^{d})—, or —C(O)N(R^{d})—, and more preferably represents —C(O)—.

In a case where the A-side terminal of Z³ has a divalent linear organo(poly)siloxane residue, X³² preferably represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, and more preferably represents —O—.

In a case where the A-side terminal of Z³ has an alkylene chain, it is preferred that s1 represents 0 and Q^{b1} represents a single bond, or, s1 represents 1 and Q^{b1} represents an alkylene group having 2 to 6 carbon atoms.

In a case where the A-side terminal of Z³ has a polyalkylene oxide chain, it is preferred that s1 represents 1, and Q^{b1} represents an alkylene group having 2 to 6 carbon atoms.

In a case where the A-side terminal of Z³ has a divalent linear organo(poly)siloxane residue, it is preferred that s1 represents 1, and Q^{b1} represents a single bond.

In a case where the A-side terminal of Z³ in the group (3-1A-2) has an alkylene chain or a divalent linear organo(poly)siloxane residue, X³³ preferably represents —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d}), —OC(O)N(R^{d})—, or —C(O)N(R^{d})—.

In a case where the A-side terminal of Z³ has a polyalkylene oxide chain, X³³ preferably represents —C(O)O—, —C(O)S—, —SO₂N(R^{d})—, or —C(O)N(R^{d})—.

A in formula (3A) may also be any of the groups (g2-1) to (g2-7).

Where, in each of formulae (g2-1) to (g2-7), A¹ is given on the side bound to Z³, meanwhile Q²², Q²³, Q²⁴, Q²⁵, or Q²⁶ is given on the side bound to [—Si(R²)ₙL₃₋ₙ].

Examples of another aspect of A include groups (g2-8) to (g2-14).

Where, in each of formulae (g2-8) to (g2-14), A¹ is given on the side bound to Z³, meanwhile G¹ is given on the side bound to [—Si(R²)ₙL₃₋ₙ].

Specific examples of the compound (3) include the compound below. In formula below, n10 represents a number of 1 or larger, preferably a number from 1 to 60, may be a number from 3 to 50, may be a number from 5 to 30, and may be a number from 7 to 25.

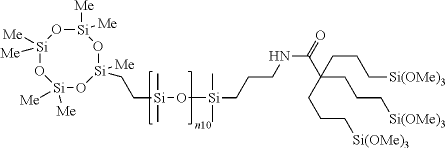

### (Compounds (4A) and (4B))

In the compounds (4A) and (4B), it is more preferred that
each X^{A} independently represents:

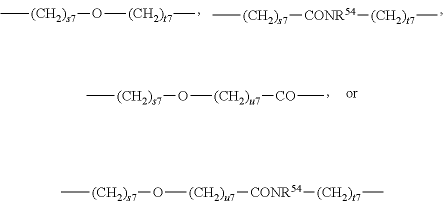

Each R⁵⁴ independently represents a hydrogen atom, phenyl group, alkyl group having 1 to 6 carbon atoms, or oxyalkylene-containing group having 1 to 10 carbon atoms;
s7 represents an integer from 1 to 20;
t7 represents an integer from 1 to 20; and
u7 represents an integer from 1 to 20.

Each X^{A} independently represents a group represented by formula (W6) below.

In formula (W6), each X^{a} independently represents a single bond, or a divalent organic group.

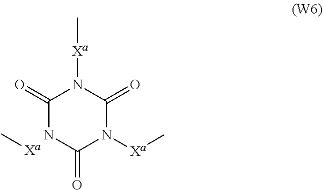

Specific examples of the compound (4A) include the compound below.

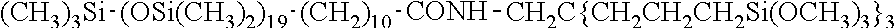

### (Compound (5))

The surface treatment agent of the present disclosure, if containing the compound (5), is preferred to further contain a metal compound.

The metal compound is preferably a compound represented by formula (M6a) or (M6b) below:

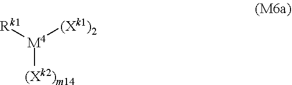

In formula (M6a),
R^{k1} represents a siloxane skeleton-containing group, a hydrocarbon chain-containing group, or a hydrolyzable group; and
each of a plurality of pieces of X^{k1} independently represent a hydrolyzable group.
X^{k2} represents a siloxane skeleton-containing group, a hydrocarbon chain-containing group, or a hydrolyzable group.

The number of elements of the siloxane skeleton-containing group in R^{k1} and X^{k1} is smaller than the number of elements of the trialkylsilyl group-containing molecular chain represented by (R^{a9})₃Si—Z—(Si(R^{s1})₂—O—)ₙ₉—Y— of the compound (5), and the number of carbon atoms of the longest straight chain of the hydrocarbon chain contained in the hydrocarbon chain-containing group in R^{k1} and X^{k1} is smaller than the number of elements of the trialkylsilyl group-containing molecular chain represented by (R^{a9})₃Si—Z—(Si(R^{s1})₂—O—)ₙ₉—Y— of the compound (5),

In a case where each of R^{k1} and X^{k2} represents a siloxane skeleton-containing group or a hydrocarbon chain-containing group, R^{k1} and X^{k2} may be the same or different.

In a case where X^{k2} represents a hydrolyzable group, X^{k2} and X^{k1} may be the same or different. Also R^{k1} and X^{k2} may be the same or different. M⁴ represents a trivalent or tetravalent metal atom capable of forming a metal alkoxide. m14 represents an integer of 0 or 1, depending on M⁴.

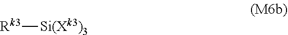

In formula (M6b),
R^{k3} represents a hydrolyzable silane oligomer residue; and
X^{k3} represents a hydrolyzable group, a fluorine-containing alkyl group having from 1 to 4 carbon atoms, or an alkyl group having from 1 to 4 carbon atoms.

Specific examples of the compound (5) include the compounds below. In formula below, n10 represents a number of 1 or larger, preferably a number from 1 to 60, may be a number from 3 to 50, may be a number from 5 to 30, and may be a number from 7 to 25.

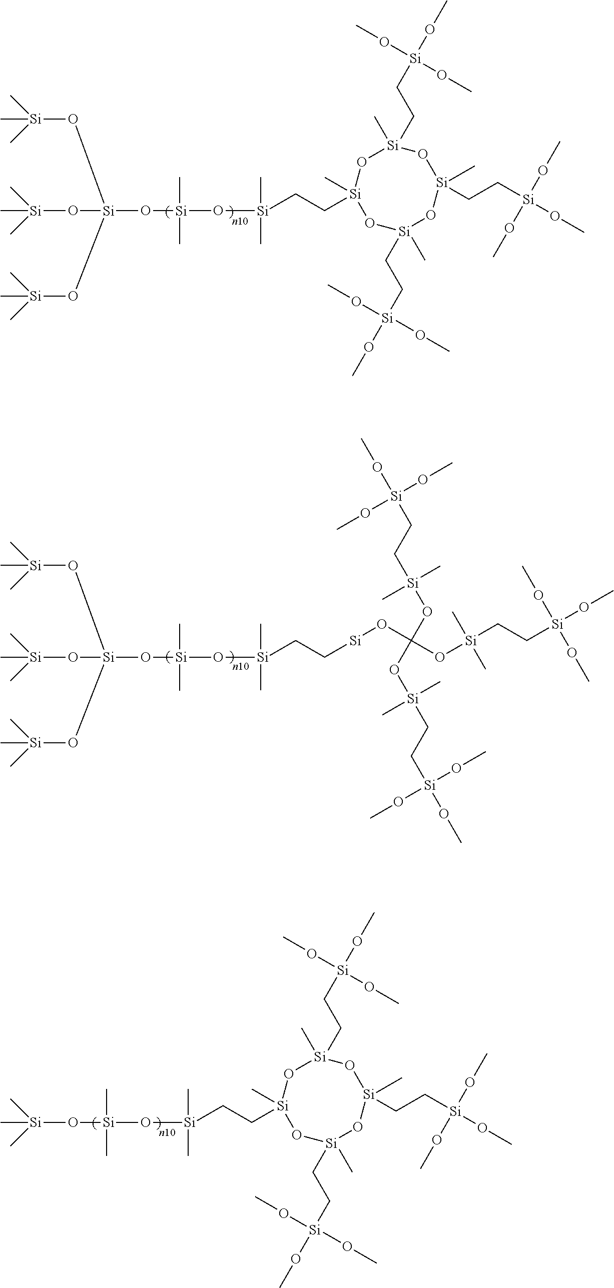

### <Liquid Medium>

The surface treatment agent may also contain a liquid medium.

The liquid medium may be used singly or in combination of two or more kinds thereof.

The liquid medium is preferably an organic solvent.

Examples of the organic solvent include compounds composed only of hydrogen atom and carbon atom, and compounds composed only of hydrogen atom, carbon atom, and oxygen atom. Specific examples thereof include hydrocarbon-based organic solvent, ketone-based organic solvent, ether-based organic solvent, ester-based organic solvent, glycol-based organic solvent, and alcohol-based organic solvent.

Specific examples of the hydrocarbon-based organic solvent include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of the ketone-based organic solvent include acetone, methyl ethyl ketone, methyl isobutyl ketone, diisobutyl ketone, cyclohexanone, 2-heptanone, 4-heptanone, 3,5,5-trimethyl-2-cyclohexene-1-one, and 3,3,5-trimethylcyclohexanone and isophorone.

Specific examples of the ether-based organic solvent include diethyl ether, cyclopentyl methyl ether, tetrahydrofuran, and 1,4-dioxane.

Specific examples of the ester-based organic solvent include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methyl butyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of the glycol-based organic solvent include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono-tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, pentane, triethylene glycol dimethyl ether, and polyethylene glycol dimethyl ether.

Specific examples of the alcohol-based organic solvent include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Examples of the organic solvent include halogen-containing organic solvent, nitrogen-containing compound, sulfur-containing compound, siloxane compound, and fluorine-containing organic solvent.

Specific examples of the halogen-containing organic solvent include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of the nitrogen-containing compound include nitrobenzene, acetonitrile, benzonitrile, N,N-dimethylformamide, N,N-dimethylacetamide, N-methylpyrrolidone, and 1,3-dimethyl-2-imidazolidinone.

Examples of the sulfur-containing compound include carbon disulfide and dimethyl sulfoxide.

Examples of the siloxane compound include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of the fluorine-containing organic solvent include polyfluoroaromatic hydrocarbons (for example, 1,3-bis(trifluoromethyl) benzene); polyfluoroaliphatic hydrocarbon (for example, C₆F₁₃CH₂CH₃ (for example, ASAHIKLIN (registered trademark) AC-6000 from AGC Inc.), 1,1,2,2,3,3,4-heptafluorocyclopentane (for example, ZEORORA (registered trademark) H from Zeon Corporation); hydrofluoroether (HFE) (for example, alkyl perfluoroalkyl ether (perfluoroalkyl group and alkyl group may be linear or branched), such as perfluoropropyl methyl ether (C₃F₇OCH₃) (for example, NOVEC (trademark) 7000 from Sumitomo 3M Limited.), perfluorobutyl methyl ether (C₄F₉OCH₃) (for example, NOVEC (trademark) 7100 from Sumitomo 3M Limited.), perfluorobutyl ethyl ether (C₄F₉OC₂H₅) (for example, NOVEC (trademark) 7200 from Sumitomo 3M Limited.), and perfluorohexyl methyl ether (C₂F₅CF(OCH₃)C₃F₇) (for example, NOVEC (trademark) 7300 from Sumitomo 3M Limited.), and CF₃CH₂OCF₂CHF₂ (for example, ASAHIKLIN (registered trademark) AE-3000 from AGC Inc.)); and hydrofluoroolefin (HFO) (for example, 1-chloro-2,3,3-trifluoro-1-propene (HCFO-1233yd) (for example, AMOLEA (registered trademark) AS-300 from AGC Inc.), OPTEON (registered trademark) SF01, SF05, SF10, SF30, SF33, SF70, SF79, and SF80 from The Chemours Company).

The content of the liquid medium, with respect to the total amount of the surface treatment agent, is preferably 50 to 99.999 mass %, more preferably 80 to 99.99 mass %, and still more preferably 90 to 99.9 mass %. For the surface treatment agent intended for use in wet coating, the content of the liquid medium, with respect to the total amount of the surface treatment agent, may be 90 to 99.99 mass %, may be 95 to 99.98 mass %, may be 97 to 99.97 mass %, and may be 98 to 99.95 mass %.

### <Other Components>

The surface treatment agent may contain other components besides the liquid medium, as long as the effects of the present disclosure are not degraded.

Examples of such other components include known additives such as acid catalyst and basic catalyst that promote hydrolysis and condensation reaction of the reactive silyl group.

The catalyst usable herein includes freely selectable appropriate acid or base, transition metal (for example, Ti, Ni, Sn, Zr, Al, B, and the like), sulfur-containing compound having lone pair in the molecular structure, and nitrogen-containing compound (such as sulfoxide compound, aliphatic amine compound, aromatic amine compound, phosphoric acid amide compound, amide compound, and urea compound).

Examples of the acid catalyst include acetic acid, formic acid, trifluoroacetic acid, hydrochloric acid, nitric acid, sulfuric acid, phosphoric acid, sulfonic acid, methanesulfonic acid, and p-toluenesulfonic acid.

Examples of the substrate catalyst include ammonia, sodium hydroxide, and potassium hydroxide; and organic amine such as triethylamine and diethylamine.

Examples of such other components also include metal compound having a hydrolyzable group (the metal compound having a hydrolyzable group is also referred to as “specific metal compound”, hereinafter). As a result of inclusion of the specific metal compound in the surface treatment agent, the surface treatment layer may be improved in the slippage and antifouling property. Examples of the specific metal compound include those represented by formulae (M1) to (M3) below:

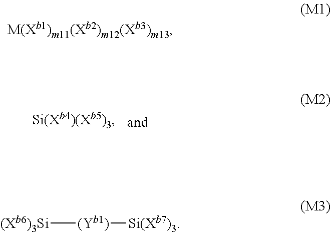

In formula (M1),

M represents a trivalent or tetravalent metal atom.

Each X^{b1} independently represents a hydrolyzable group.

Each X^{b2} independently represents a siloxane skeleton-containing group.

Each X^{b3} independently represents a hydrocarbon chain-containing group.
m11 represents an integer from 2 to 4;
each of m12 and m13 independently represents an integer from 0 to 2;
in a case where M represents a trivalent metal atom, m11+m12+m13 represents 3; and in a case where M represents a tetravalent metal atom, m11+m12+m13 represents 4.

In formula (M2),

X^{b4} represents a hydrolyzable silane oligomer residue.

Each X^{b5} independently represents a hydrolyzable group or an alkyl group having 1 to 4 carbon atoms.

In formula (M3),
each of X^{b6} and X^{b7} independently represents a hydrolyzable group or a hydroxy group.
Y^{b1} represents a divalent organic group.

The metal represented by M in formula (M1) also includes metalloid such as Si and Ge. M preferably represents a trivalent metal or a tetravalent metal, for which Al, Fe, In, Hf, Si, Ti, Sn, and Zr are more preferred; Al, Si, Ti, and Zr are still more preferred; and Si is particularly preferred.

The hydrolyzable group represented by X^{b1} in formula (M1) includes those same as the hydrolyzable group represented by L in [—Si(R²)ₙL₃₋ₙ] in the reactive silyl group.

The siloxane skeleton-containing group represented by X^{b2} has a siloxane unit (—Si—O—), and may be linear or branched. The siloxane unit is preferably dialkylsilyloxy group, and examples thereof include dimethylsilyloxy group and diethylsilyloxy group. The number of repetitions of the siloxane unit in the siloxane skeleton-containing group is 1 or larger, preferably 1 to 5, more preferably 1 to 4, and still more preferably 1 to 3.

The siloxane skeleton-containing group may contain a divalent hydrocarbon group in a part of the siloxane skeleton. More specifically, a part of oxygen atoms in the siloxane skeleton may be replaced by divalent hydrocarbon group. Examples of the divalent hydrocarbon group include alkylene groups such as methylene group, ethylene group, propylene group, and butylene group.

Silicon atom at the terminal of the siloxane skeleton-containing group may have, bound thereto, hydrolyzable group, hydrocarbon group (preferably alkyl group) or the like.

The number of elements in the siloxane-skeleton-containing group is preferably 100 or smaller, more preferably 50 or smaller, and still more preferably 30 or smaller. The number of elements is preferably 10 or larger.

The siloxane skeleton-containing group is preferably a group represented by *—(O—Si(CH₃)₂)ₙCH₃, where n represents an integer from 1 to 5, and * indicates a bonding site with a neighboring atom.

The hydrocarbon chain-containing group represented by X^{b3} may be composed only of a hydrocarbon chain, or may have an etheric oxygen atom between the carbon-carbon atoms of the hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms in the hydrocarbon chain-containing group is preferably 1 to 3, more preferably 1 to 2, and still more preferably 1. The hydrocarbon chain-containing group is preferably alkyl group, and more preferably methyl group, ethyl group, or propyl group.

m1 preferably represents 3 or 4.

The compound represented by formula (M1) is preferably any of compounds represented by formulae (M1-1) to (M1-5) having Si for M, and more preferably a compound represented by formula (M1-1). The compound represented by formula (M1-1) is preferably tetraethoxysilane, tetramethoxysilane, or triethoxymethylsilane.

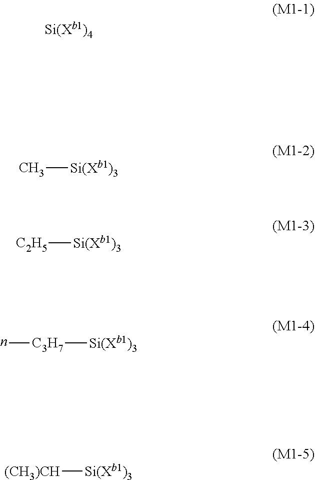

In formula (M2), the number of silicon atoms contained in the hydrolyzable silane oligomer residue represented by X^{b4} is preferably 3 or larger, more preferably 5 or larger, and still more preferably 7 or larger. The number of silicon atoms is preferably 15 or smaller, more preferably 13 or smaller, and still more preferably 10 or smaller.

The hydrolyzable silane oligomer residue may have an alkoxy group bound to silicon atom. Examples of the alkoxy group include methoxy group, ethoxy group, propoxy group, and butoxy group. Methoxy group and ethoxy group are preferred. The hydrolyzable silane oligomer residue may have one kind, or two or more kinds of these alkoxy groups, and preferably has one kind thereof.

Examples of the hydrolyzable silane oligomer residue include (C₂H₅O)₃Si—(OSi(OC₂H₅)₂)₄O—*. Where, * indicates a bonding site with a neighboring atom.

Examples of the hydrolyzable group represented by X^{b5} in formula (M2) include those same as the hydrolyzable group represented by L in [—Si(R²)ₙL₃₋ₙ] in the reactive silyl group, cyano group, hydrogen atom, and allyl group. Alkoxy group or isocyanato group is preferred. The alkoxy group preferably has 1 to 4 carbon atoms.

X^{b5} preferably represents a hydrolyzable group.

Examples of the compound represented by formula (M2) include (H₅C₂O)₃—Si—(OSi(OC₂H₅)₂)₄OC₂H₅.

The compound represented by formula (M3) is a compound having a reactive silyl group at each of both terminals of the divalent organic group, that is, bissilane.

Examples of the hydrolyzable group represented by X^{b6} and X^{b7} in formula (M3) include alkoxy group, acyloxy group, ketoxime group, alkenyloxy group, amino group, aminoxy group, amide group, isocyanato group, and halogen atom. Alkoxy group and isocyanato group are preferred. The alkoxy group is preferably alkoxy group having 1 to 4 carbon atoms. Methoxy group and ethoxy group are more preferred.

In formula (M3), X^{b6} and X^{b7} may be the same group or different groups. From the viewpoint of availability, X^{b6} and X^{b7} are preferably the same group.

In formula (M3), Y^{b1} represents a divalent organic group that binds the reactive silyl groups at both terminals. The number of carbon atoms in the divalent organic group Y^{b1} is preferably 1 to 8, and more preferably 1 to 3.

Examples of Y^{b1} include alkylene group, phenylene group, and alkylene group having etheric oxygen atom between the carbon atoms. Examples thereof include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content of any other component optionally contained in the surface treatment agent, with respect to the total amount of the surface treatment agent, is preferably 10 mass % or less, and more preferably 1 mass % or less. The content of the specific metal compound, if present in the surface treatment agent, is preferably 0.01 to 30 mass %, more preferably 0.01 to 10 mass %, and still more preferably 0.05 to 5 mass %, with respect to the total amount of the surface treatment agent.

The total content of the specific silane compound and other components (also referred to as “solid concentration”, hereinafter), with respect to the total amount of the surface treatment agent, is preferably 0.001 to 40 mass %, more preferably 0.01 to 20 mass %, and still more preferably 0.1 to 10 mass %. The solid concentration of the surface treatment agent is a value calculated from the mass before heating, and the mass after heating in a convection dryer at 120° C. for 4 hours.

Examples of the surface treatment with use of the surface treatment agent include dry coating and wet coating.

Examples of the dry coating include techniques such as vacuum deposition, CVD, PVD, and sputtering. The dry coating preferably relies upon vacuum deposition, from the viewpoint of suppressing decomposition of the compound, and convenience of the apparatus. The vacuum deposition may employ a pellet-like material having the compound of the present disclosure impregnated into a metal porous material made of iron, steel, or the like. The pellet-like material having impregnated therein the compound of the present disclosure usable herein is also obtainable by allowing a composition that contains the compound of the present disclosure and a liquid medium to impregnate into a metal porous material made of iron, steel or the like, and then drying off the liquid medium.

Examples of the wet coating include spin coating, wipe coating, spray coating, squeegee coating, dip coating, die coating, inkjet method, flow coating, roll coating, casting, the Langmuir-Blodgett method, and gravure coating.

For improved abrasion resistance of the surface treatment layer, there may be an optional operation for promoting a reaction between the compound having a linear organo(poly)siloxane residue and a reactive silyl group, with the underlayer. Examples of the operation include heating, humidification, and light irradiation.

For example, the substrate having formed thereon the surface treatment layer may be heated in a moist atmosphere, to promote reaction such as hydrolysis reaction of the hydrolyzable group, reaction between hydroxy group or the like on the surface of the underlayer and the silanol group, and generation of siloxane bond as a result of condensation reaction of the silanol group.

After the surface treatment, any compound that is present in the surface treatment layer and remains chemically unbound to other compound or to the underlayer, may be removed as necessary. Examples of method of removal include flooding of solvent over the surface treatment layer, and wiping with a cloth soaked with the solvent.

The article of the present disclosure may be an optical material having a surface treatment layer in the outermost layer.

Preferred examples of the optical material include those regarding display and the like, as well as a wide variety of optical materials.

Examples of the optical material include displays such as cathode ray tube (CRT; personal computer monitor, for example), liquid crystal display, plasma display, organic EL display, inorganic thin film EL dot matrix display, rear projection-type display, vacuum fluorescent display (VFD), and field emission display (FED); protective plate for these displays; and these displays and protective plate having an antireflection film formed on the surfaces thereof.

The article of the present disclosure is preferably an optical component. Examples of the optical component include car navigation, mobile phone, smartphone, digital camera, digital video camera, PDA, portable audio player, car audio, game machine, spectacle lens, camera lens, lens filter, sunglasses, medical instrument such as a stomach camera, copy machine, PC, display (liquid crystal display, organic EL display, plasma display, and touch panel display, for example), touch panel, protective film, and antireflection film.

Examples of the optical component also include front protective plate, antireflection plate, polarizing plate, and anti-glare plate for displays such as PDP, LCD and so forth; disc face of optical disk such as Blu-ray (registered trademark) disc, DVD disc, CD-R, or MO; optical fiber; and display face of clock.

In particular, the article of the present disclosure is preferably display or touch panel.

The article of the present disclosure may be a medical device or a medical material. The article of the present disclosure may also be automotive interior and exterior materials. Examples of the exterior material include a window, a light cover, and an external camera cover. Examples of the interior material include an instrument panel cover, a navigation system touch panel, and a decorative interior material.

In a case where the article of the present disclosure is an optical component, the material constituting the surface of the substrate is any of those for optical component, such as glass or transparent plastic. In a case where the article of the present disclosure is an optical component, the substrate may have a functional layer such as hard coat layer or antireflection layer formed on the surface (outermost layer) thereof. The antireflection layer may be either a single-layer antireflection layer or a multi-layer antireflection layer.

Examples of inorganic substance that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used singly or in combination of two or more kinds thereof (for example, as a mixture). In a case of forming a multi-layered antireflection layer, it is preferred to use SiO₂ and/or SiO for the outermost layer. The article of the present disclosure, intended for use as optical glass for touch panel, may have a transparent electrode, such as thin film formed of indium tin oxide (ITO), indium zinc oxide, or the like, provided on a part of the surface of the substrate (glass). The substrate may also have an insulating layer, adhesive layer, protective layer, decorative frame layer (I—CON), atomizing film layer, hard coating film layer, polarizing film, phase difference film, liquid crystal display module, and the like, depending on the specific specification and the like thereof.

### [Method of Producing Article]

The method of producing an article of the present disclosure includes: subjecting a substrate to surface treatment with use of a surface treatment agent, to produce an article having the substrate and a surface treatment layer formed thereon, wherein the surface treatment layer has a surface roughness Sdr of 30% or larger within any measurement area of from 5 to 50 μm squares, and the surface treatment agent contains a compound having a chain group and a reactive silyl group.

In one aspect, the method of producing an article of the present disclosure includes: subjecting a substrate to surface treatment with use of a surface treatment agent, to produce an article having the substrate and a surface treatment layer formed thereon, the surface treatment layer has a surface roughness Sdr of 30% or larger within any measurement area of from 5 to 50 μm squares, and the surface treatment agent preferably contains a compound having a linear organo(poly)siloxane residue and a reactive silyl group.

The method of adjusting the surface roughness Sdr of the surface treatment layer, within the range of any measurement area of 5 to 50 μm square to 30% or larger, is as described above.

From the viewpoint of adjusting the surface roughness Sdr of the surface treatment layer, within the range of any measurement area of 5 to 50 μm square to 30% or larger, the substrate preferably has a surface roughness Sdr of 30% or larger, within the range of any measurement area of 5 to 50 μm squares.

Details of the surface treatment agent are as described above.

Also the surface treatment method with use of the surface treatment agent is as described above.

### EXAMPLES

Hereinafter, the present invention will be described in more detail with reference to Examples, to which the present invention is however by no means limited.

### [Synthesis of Compound 11B]

Under a nitrogen atmosphere, carboxylic acid-terminated polydimethylsiloxane (with an average value of n of 16, alkylene group bound to carboxylic acid has 10 carbon atoms) was placed in a 100 mL flask. MCR-B12 (product number, from Gelest, Inc.) (5.0 g), methylene chloride (20 mL), and oxalyl chloride (1.3 g) were added, and the mixture was stirred at 25° C. for 2 hours. After the solvent and the volatiles were distilled off under reduced pressure, 2-(undec-10-en-1-yl)tridec-12-en-1-amine (2.3 g), methylene chloride (20 mL) and triethylamine (0.70 g) were added, and the mixture was stirred at 25° C. for 2 hours. After the solvent and the volatiles were distilled off under reduced pressure, the residue was subjected to flash column chromatography (eluent: hexane/ethyl acetate) with use of silica gel, to obtain 2.8 g of Compound 11A. Structure of Compound 11A was confirmed from NMR data below. In Compound 11A, n10 was found to have an average value of 16. In formula (11A), n-Bu represents a normal butyl group (CH₃CH₂CH₂—), and Me represents a methyl group (CH₃—). The same applies hereinafter.

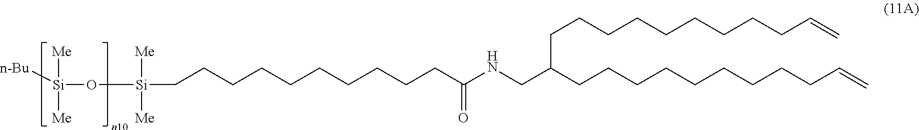

¹H-NMR (400 MHz, CDCl₃) δ 5.74 (ddt, J=16.9, 10.2, 6.7 Hz, 2H), 5.24 (t, J=5.7 Hz, 1H), 5.04-4.76 (m, 4H), 3.11 (t, J=6.0 Hz, 2H), 2.17-2.04 (m, 2H), 2.04-1.87 (m, 4H), 1.61-1.51 (m, 2H), 1.47-1.04 (m, 51H), 0.93-0.75 (m, 3H), 0.55-0.36 (m, 4H), 0.07 (s, 102H).

In a 20 mL flask, 1,3 bistrifluoromethylbenzene (2.0 mL) and Compound 11A (1.0 g) were placed, and the content was stirred at 25° C. Next, a toluene solution of platinum/1,3-divinyl-1,1,3,3-tetramethyldisiloxane complex (platinum content: 3 mass %, 15 μL), aniline (4.8 μL), and trimethoxysilane (0.31 g) were added, and the mixture was stirred at 40° C. for 2 hours. The solvent was distilled off under reduced pressure, to obtain 1.1 g of Compound 11B. Structure of Compound 11B was confirmed from NMR data below. In Compound 11B, n10 was found to have an average value of 16.

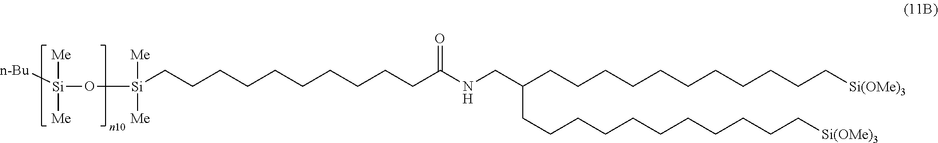

¹H-NMR (400 MHz, CDCl₃) δ 5.31-5.16 (m, 1H), 3.50 (s, 18H), 3.11 (t, J=6.0 Hz, 2H), 2.15-2.02 (m, 2H), 1.66-0.89 (m, 61H), 0.90-0.73 (m, 3H), 0.66-0.52 (m, 4H), 0.46 (ddd, J=12.6, 7.0, 3.2 Hz, 4H), 0.07 (s, 102H).

### [Synthesis of Compound 12F]

Compound 12A was obtained according to the method described in WO 2021/054413.

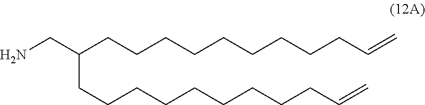 [SMILES: C=CCCCCCCCCCC(CN)CCCCCCCCCC=C]

Compound 12B was obtained according to the method described in JP 2017-119849 A.

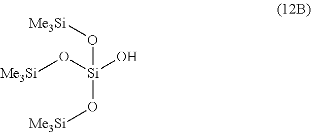 [SMILES: C[Si](C)(C)O[Si](O)(O[Si](C)(C)C)O[Si](C)(C)C]

Under a nitrogen atmosphere, 2,3,4,5,6-pentafluorophenol (6.8 g), tetrahydrofuran (THF, 42 mL), and triethylamine (5.1 g) were placed in a 100 mL flask, and the mixture was stirred at 25° C. Next, 10-undecenoyl chloride (5.0 g) was added dropwise, and the mixture was stirred at 25° C. for one hour. After the reaction liquid was filtered, and the solvent and the volatiles were distilled off under reduced pressure, the residue was subjected to flash column chromatography (eluent: hexane/ethyl acetate) with use of silica gel, to obtain 7.9 g of Compound 12C. Structure of Compound 12C was confirmed from NMR data below.

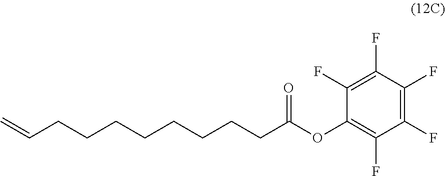 [SMILES: C=CCCCCCCCCC(=O)Oc1c(F)c(F)c(F)c(F)c1F]

¹H-NMR (400 MHz, CDCl₃) δ5.74 (ddt, J=16.9, 10.2, 6.6 Hz, 1H), 5.05-4.77 (m, 2H), 2.59 (t, J=7.4 Hz, 2H), 1.97 (q, J=7.1 Hz, 2H), 1.70 (p, J=7.4 Hz, 2H), 1.42-1.08 (m, 10H).

Under a nitrogen atmosphere, Compound 12C (5.6 g), THF (5.0 mL), and chlorodimethylsilane (2.3 g) were placed in a 200 mL flask, and the mixture was stirred at 25° C. Next, a xylene solution of platinum/1,3-divinyl-1,1,3,3-tetramethyldisiloxane complex (platinum content: 3 mass %, 0.10 mL) was added, and the mixture was stirred at 25° C. for 2 hours. The solvent and the volatiles were distilled off under reduced pressure, to obtain 7.2 g of Compound 12D. Structure of Compound 12D was confirmed from NMR data below.

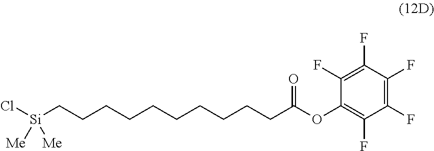 [SMILES: C[Si](C)(Cl)CCCCCCCCCCC(=O)Oc1c(F)c(F)c(F)c(F)c1F]

¹H-NMR (400 MHz, CDCl₃) δ 2.63 (t, J=7.4 Hz, 2H), 1.74 (p, J=7.4 Hz, 2H), 1.46-1.17 (m, 14H), 0.90-0.69 (m, 2H), 0.37 (s, 6H).

Under a nitrogen atmosphere, tris(trimethylsiloxy) silanol (1.3 g), and THF (20 mL) were placed in a 100 mL three-necked flask, and the mixture was stirred at 25° C. Next, the content was cooled to 0° C., to which a hexane solution of n-BuLi (1.6 M, 2.4 mL) was added dropwise. Next, a THF solution of hexamethylcyclotrisiloxane (1.1M, 4.0 mL) was added dropwise, a THF solution of hexamethylcyclotrisiloxane (1.1M, 22 mL) was further added dropwise, and the mixture was stirred for 7 hours. Compound 12D (3.6 g) was then added, the mixture was stirred at 25° C. for one hour, to which Compound 12A (3.2 g) was added, and the mixture was stirred for one hour. To the reaction liquid, hexane and ion-exchanged water were sequentially added, and the content was separated to obtain an organic layer. After the solvent and the volatiles were distilled off under reduced pressure, the residue was subjected to flash column chromatography (eluent: hexane/ethyl acetate) with use of silica gel, to obtain 0.98 g of Compound 12E. Structure of Compound 12E was confirmed from NMR data below. In Compound 12E, n10 was found to have an average value of 21.

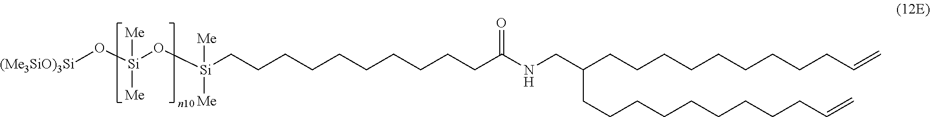

¹H-NMR (400 MHz, CDCl₃) δ 5.81 (ddt, J=16.9, 10.2, 6.7 Hz, 2H), 5.31 (d, J=4.8 Hz, 1H), 5.08-4.84 (m, 4H), 3.19 (t, J=6.0 Hz, 2H), 2.31-2.11 (m, 2H), 2.08-1.92 (m, 4H), 1.63 (t, J=7.3 Hz, 2H), 1.28 (d, J=9.6 Hz, 47H), 0.53 (t, J=7.7 Hz, 2H), 0.09 (s, 159H).

Dichloromethane (10 g), and Compound 12E (0.80 g) were placed in a 50 mL flask, and the mixture was stirred at 25° C. Next, a toluene solution of platinum/1,3-divinyl-1,1,3,3-tetramethyldisiloxane complex (platinum content: 3 mass %, 4.1 mg), aniline (2.6 mg), and trimethoxysilane (0.40 g) were added, and the mixture was stirred at 25° C. for 2 hours. The solvent was distilled off under reduced pressure, to obtain 0.69 g of a compound 12F. Structure of Compound 12F was confirmed from NMR data below. In Compound 12F, n10 was found to have an average value of 21.

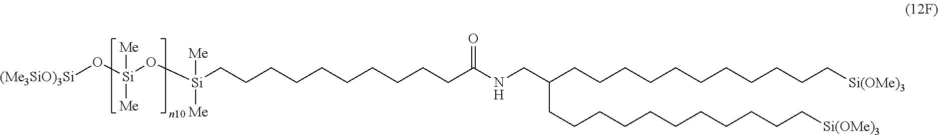

¹H-NMR (400 MHz, CDCl₃) δ 5.31 (d, J=4.8 Hz, 1H), 3.57 (s, 18H), 3.18 (t, J=6.0 Hz, 2H), 2.31-2.11 (m, 2H), 1.64-1.25 (m, 57H), 0.64 (m, 4H), 0.52 (t, J=7.7 Hz, 2H), 0.09 (s, 159H).

### [Synthesis of Compound 13D]

Under a nitrogen atmosphere, 2,3,4,5,6-pentafluorophenol (6.8 g), THF (42 mL) and triethylamine (5.1 g) were placed in a 100 mL flask, and the mixture was stirred at 25° C. Next, 10-undecenoyl chloride (5.0 g) was added dropwise, and the mixture was stirred at 25° C. for one hour. After the reaction liquid was filtered, and the solvent and the volatiles were distilled off under reduced pressure, the residue was subjected to flash column chromatography (eluent: hexane/ethyl acetate) with use of silica gel, to obtain 7.9 g of Compound 13A. Structure of Compound 13A was confirmed from NMR data below.

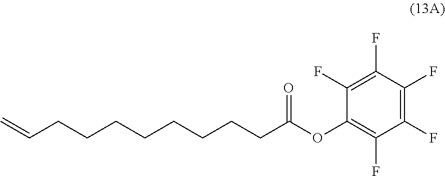 [SMILES: C=CCCCCCCCCC(=O)Oc1c(F)c(F)c(F)c(F)c1F]

¹H-NMR (400 MHz, CDCl₃) δ5.74 (ddt, J=16.9, 10.2, 6.6 Hz, 1H), 5.05-4.77 (m, 2H), 2.59 (t, J=7.4 Hz, 2H), 1.97 (q, J=7.1 Hz, 2H), 1.70 (p, J=7.4 Hz, 2H), 1.42-1.08 (m, 10H).

Under a nitrogen atmosphere, Compound 13A (5.6 g), THF (5.0 mL), and chlorodimethylsilane (2.3 g) were placed in a 200 mL flask, and the mixture was stirred at 25° C. Next, a xylene solution of platinum/1,3-divinyl-1,1,3,3-tetramethyldisiloxane complex (platinum content: 3 mass %, 0.10 mL) was added, and the mixture was stirred at 25° C. for 2 hours. The solvent and the volatiles were distilled off under reduced pressure, to obtain 7.2 g of Compound 13B. Structure of Compound 13B was confirmed from NMR data below.

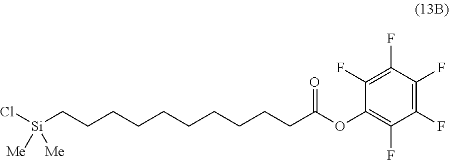 [SMILES: C[Si](C)(Cl)CCCCCCCCCCC(=O)Oc1c(F)c(F)c(F)c(F)c1F]

¹H-NMR (400 MHz, CDCl₃) δ 2.63 (t, J=7.4 Hz, 2H), 1.74 (p, J=7.4 Hz, 2H), 1.46-1.17 (m, 14H), 0.90-0.69 (m, 2H), 0.37 (s, 6H).

Under a nitrogen atmosphere, t-butyldimethylsilanol (2.5 g), and THF (92 mL) were placed in a 500 mL three-necked flask, and the mixture was stirred at 25° C. Next, the content was cooled to 0° C., to which a hexane solution of n-BuLi (1.6 M, 11 mL) was added dropwise. Next, a THF solution of hexamethylcyclotrisiloxane (1.1 M, 19 mL) was added dropwise, a THF solution of hexamethylcyclotrisiloxane (1.1 M, 100 mL) was further added dropwise, and the mixture was stirred at 0° C. for 7 hours. Compound 13B (15 g) was then added, the mixture was stirred at 0° C. for one hour, to which 2-(undec-10-en-1-yl)tridec-12-en-1-amine (15 g) was added, and the mixture was stirred at 0° C. for one hour. To the reaction liquid, hexane and ion-exchanged water were sequentially added, and the content was separated to obtain an organic layer. After the solvent and the volatiles were distilled off under reduced pressure, the residue was subjected to flash column chromatography (eluent: hexane/ethyl acetate) with use of silica gel, to obtain 4.5 g of Compound 13C. Structure of Compound 13C was confirmed from NMR data below. In Compound 13C, n10 was found to have an average value of 23.

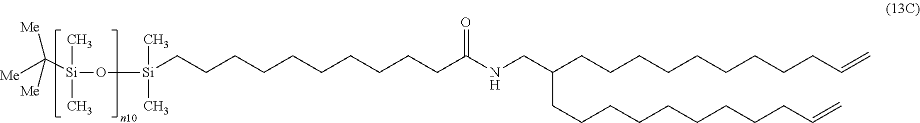

¹H-NMR (400 MHz, CDCl₃) δ 5.81 (ddt, J=16.9, 10.2, 6.7 Hz, 2H), 5.24 (t, J=5.7 Hz, 1H), 5.08-4.84 (m, 4H), 3.19 (t, J=6.0 Hz, 2H), 2.31-2.11 (m, 2H), 2.08-1.92 (m, 4H), 1.63 (t, J=7.3 Hz, 2H), 1.46-0.98 (m, 47H), 0.80 (s, 9H), 0.53 (t, J=7.7 Hz, 2H), 0.09 (s, 144H).

Dichloromethane (1.5 g), and Compound 13C (1.0 g) were placed in a 20 mL flask, and the mixture was stirred at 25° C. Next, a toluene solution of platinum/1,3-divinyl-1,1,3,3-tetramethyldisiloxane complex (platinum content: 3 mass %, 7.7 mg), aniline (1.2 mg), and trimethoxysilane (0.12 g) were added, and the mixture was stirred at 25° C. for 2 hours. The solvent was distilled off under reduced pressure, to obtain 0.69 g of a compound 13D. Structure of Compound 13D was confirmed from NMR data below. In Compound 13D, n10 was found to have an average value of 23.

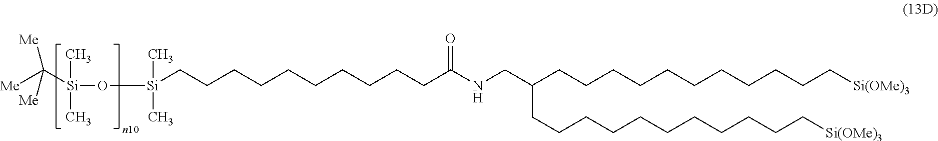

¹H-NMR (400 MHz, CDCl₃) δ 5.24 (t, J=5.7 Hz, 1H), 3.57 (s, 18H), 3.18 (t, J=6.0 Hz, 2H), 2.31-2.11 (m, 2H), 1.64-1.25 (m, 57H), 0.80 (s, 9H), 0.63-0.46 (m, 4H), 0.52 (t, J=7.7 Hz, 2H), 0.09 (s, 144H).

### [Compound 14]

Compound 14 was synthesized with reference to Example 1 of WO 2023/017830 A. In Compound 14, n10 was found to have an average value of 19.

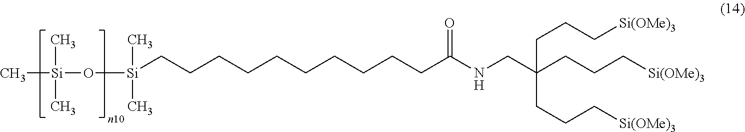

### [Preparation of Substrate]

DRAGONTRAIL Pro (from AGC Inc.) was prepared as a glass substrate.

The glass substrate was cleaned by the following procedure.

First, the glass substrate was ultrasonically cleaned for 15 minutes, with an aqueous solution that contains PK-LCG23 from Parker Corporation as an alkaline detergent.

Next, the glass substrate was ultrasonically washed for 15 minutes with use of ultrapure water.

Finally, the glass substrate was subjected to ozone cleaning for 15 minutes.

Next, a 50-mm-long and 50-mm-wide area of the surface (first surface) of the cleaned glass substrate was etched with a process gas. The process gas used herein was a mixed gas of nitrogen gas and hydrogen fluoride gas. The etching was conducted while setting concentration of the hydrogen fluoride gas in the process gas, flow rate of the process gas, and the process time as shown in Table 1. Etching temperature was set as shown in Table 1.

The etching was followed by 10-minute ultrasonic cleaning with use of a 10% hydrochloric acid solution.

The obtained substrate was subjected to measurement of surface roughness Sdr, within any measurement area of from 5 to 50 μm squares.

### —Method of Measuring Surface Roughness Sdr—

The glass substrate was measured under an atomic force microscope (Model “AFM-5500M”, from Hitachi High-Tech Corporation) to obtain a shape image. Sdr was calculated from data of the thus obtained shape image, with use of AFM analysis software (MOUNTAINS SPIP (registered trademark)).

Results of measurement are shown in Table 1.

### [Wet Coating]

On a copper hearth in a vacuum vapor deposition apparatus (VTR-350M, from ULVAC KIKO, Inc.), 30 g of silicon oxide was placed as a deposition source. The substrate was placed in the vacuum vapor deposition apparatus, and the inside of the vacuum vapor deposition apparatus was evacuated down to a pressure of 5×10⁻³ Pa or below. The hearth was heated up to approximately 2,000° C., and silicon oxide was vacuum-deposited on the surface of the substrate. A silicon oxide layer having a thickness of approximately 20 nm was thus formed on the substrate.

The substrate, having the silicon oxide layer thus formed thereon, was placed on a sample stage of a spray coater (API-90RS, from Apeiros Co., Ltd.), with the silicon oxide layer facing upward. Next, 13 g of a 0.2 mass % heptane solution of each Compound was injected into a syringe of the spray coater, and spray-coated at an atomization pressure of 130 kPa, a nozzle-sample face distance of 50 mm, and a scanning speed of 300 mm/sec. The substrate thus coated was then annealed at 140° C. for 30 minutes. An article, having the surface treatment layer formed on the surface of the silicon oxide layer, was thus obtained.

The surface treatment layer of the article thus obtained by the wet coating was subjected to measurement of surface roughness Sdr, within any measurement area of from 5 to 50 μm squares.

The obtained article was also evaluated for liquid repellency.

### <Liquid Repellency>

Oleic acid was added dropwise on the surface treatment layer of the article, and the oil contact angle was measured with use of a contact angle meter (Model “DM-500”, from Kyowa Interface Science Co., Ltd.). An average value was calculated from measurement values from five points on the surface treatment layer. The oil contact angle was calculated by the 20 method. The evaluation criteria are as follows. A and B correspond to practically acceptable levels.
A: Oil contact angle is 700 or larger.
B: Oil contact angle is 60° or larger, and smaller than 70°.
C: Oil contact angle is smaller than 60°.

Results of evaluation are shown in Table 1. Cases 1 to 4 correspond to Examples, and Cases 5 to 12 correspond to Comparative Examples.

TABLE 1

| | Substrate | | | | | | | | | Evaluation Etching | |
|---|---|---|---|---|---|---|---|---|---|---|---|
| | Etching | | | | | | Surface treatment layer | | | Oil | |
| | HF gas | Flow | | | Sdr | | | Sdr | | contact | |
| | conc. | rate | Time | Temp. | measurement | Sdr | | measurement | Sdr | angle | Liquid |
| | (vol %) | (SLM) | (sec) | (° C.) | area | (%) | Compound | area | (%) | (°) | Repellency |
| Case 1 | 0.2 | 70 | 200 | 650 | 5 × 5 μm sq. | 42 | 11B | 5 × 5 μm sq. | 40 | 69 | B |
| Case 2 | 5 | 70 | 8 | 650 | 5 × 5 μm sq. | 35 | 13D | 5 × 5 μm sq. | 31 | 60 | B |
| Case 3 | 0.1 | 80 | 400 | 500 | 50 × 50 μm sq. | 49 | 12F | 50 × 50 μm sq. | 47 | 72 | A |
| Case 4 | 0.1 | 50 | 300 | 500 | 50 × 50 μm sq. | 48 | 14 | 50 × 50 μm sq. | 47 | 72 | A |
| Case 5 | 5 | 70 | 4 | 500 | 5 × 5 μm sq. | 16 | 11B | 5 × 5 μm sq. | 14 | 51 | C |
| Case 6 | 0.1 | 70 | 200 | 650 | 5 × 5 μm sq. | 27 | 11B | 5 × 5 μm sq. | 24 | 57 | C |
| Case 7 | 0.1 | 70 | 100 | 500 | 5 × 5 μm sq. | 16 | 13D | 5 × 5 μm sq. | 12 | 42 | C |
| Case 8 | 5 | 70 | 8 | 500 | 5 × 5 μm sq. | 7 | 13D | 5 × 5 μm sq. | 5 | 57 | C |
| Case 9 | 10 | 200 | 10 | 500 | 50 × 50 μm sq. | 29 | 12F | 50 × 50 μm sq. | 28 | 58 | C |
| Case 10 | — | — | — | — | 5 × 5 μm sq. | 0 | 11B | 5 × 5 μm sq. | 0 | 50 | C |
| Case 11 | — | — | — | — | 5 × 5 μm sq. | 0 | 12F | 5 × 5 μm sq. | 0 | 54 | C |
| Case 12 | — | — | — | — | 5 × 5 μm sq. | 0 | 14 | 5 × 5 μm sq. | 0 | 50 | C |

As shown in Table 1, Cases 1 to 4 were found to demonstrate a surface roughness Sdr of the surface treatment layer, in the range of any measurement area of 5 to 50 μm square, of 30% or larger, and to excel in the liquid repellency.

### INDUSTRIAL APPLICABILITY

The article of the present disclosure is applicable, for example, to display device such as a touch panel display, optical element, semiconductor element, building material, automobile component, nanoimprint technology, and the like. The article of the present disclosure is also applicable to body, window glass (windshield, side glass, rear glass), mirror, bumper and the like in transportation equipment such as train, automobile, ship, and airplane. The surface treatment agent is applicable to outdoor article such as building exterior wall, tent, solar power generation module, sound insulating panel, concrete; fishing net, insect net, and water tank. The surface treatment agent is also applicable to kitchen, bathroom, wash basin, mirror, and toilet parts; chandelier, chinaware such as tile; artificial marble, and various indoor facility such as air conditioner. The surface treatment agent is also applicable to antifouling treatment for jigs, interior wall, pipe, and the like in factory. The surface treatment agent is also applicable to goggles, glasses, helmets, Japanese pinball machine, fiber, umbrella, playground equipment, and soccer ball. The article of the present disclosure is also applicable to various packaging materials such as food packaging materials, cosmetic packaging materials, and the inside of pot. The article of the present disclosure is also applicable to car navigation, mobile phone, smartphone, digital camera, digital video camera, PDA, portable audio player, car audio, game machine, spectacle lens, camera lens, lens filter, sunglasses, medical instrument such as a stomach camera, copy machine, PC, display (liquid crystal display, organic EL display, plasma display, and touch panel display, for example), touch panel, protective film, and optical component such as antireflection film.

### (Supplement)

The present disclosure includes the following aspects.

<1>

An article that includes a substrate, and a surface treatment layer arranged on the substrate and having a surface treated with a surface treatment agent,

the surface treatment layer has a surface roughness Sdr of 30% or larger within any measurement area of from 5 to 50 μm squares, and
the surface treatment agent contains a compound having a linear organo(poly)siloxane residue and a reactive silyl group.
   <2>

The article according to <1>, wherein the reactive silyl group is represented by formula (S1) below:

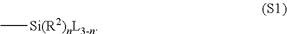

In formula (S1),
each R² independently represents a hydrocarbon group;
each L independently represents a hydrolyzable group, a group having a hydrolyzable group, or a hydroxy group; and
n represents an integer from 0 to 2.
   <3>

The article according to <1> or <2>, wherein the linear organo(poly)siloxane residue is represented by formula (B1) below:

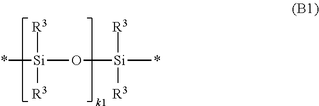

In formula (B1),
each R³ independently represents a hydrocarbon group;
k1 represents a number of 1 or larger; and
* indicates a bonding site with a neighboring atom.
   <4>

The article according to any one of <1> to <3>, wherein the compound having a linear organo(poly)siloxane residue and a reactive silyl group is represented by formula (C) or (D) below:

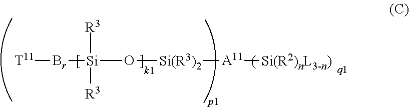

In formula (C),
T¹¹ represents a monovalent group that does not contain a reactive silyl group;
each B independently represents —O— or —C(═O)—;
each r independently represents 0 or 1;
each R³ independently represents a hydrocarbon group;
each k1 independently represents a number of 1 or larger;
p1 represents an integer of 1 or larger,
A¹¹ represents a (p1+q1)-valent linking group;
q1 represents an integer of 1 or larger,
each R² independently represents a hydrocarbon group;
each L independently represents a hydrolyzable group, a group having a hydrolyzable group, or a hydroxy group; and
each n independently represents an integer from 0 to 2.

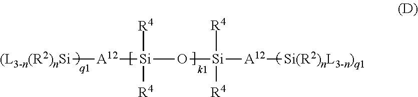

In formula (D),
each R⁴ independently represents a hydrocarbon group or T¹¹-Bᵣ—(SiR³₂—O)ₖ₁—,
each T¹¹ independently represents a monovalent group;
each B independently represents —O— or —C(═O)—;
each r independently represents 0 or 1,
each R³ independently represents a hydrocarbon group;
each k1 independently represents a number of 1 or larger;
each A¹² independently represents a (q1+1)-valent linking group;
each q1 independently represents an integer of 1 or larger;
each R² independently represents a hydrocarbon group;
each L independently represents a hydrolyzable group, a group having a hydrolyzable group, or a hydroxy group; and
each n independently represents an integer from 0 to 2.
   <5>

The article according to <4>, wherein k1 in formula (C) represents a number of 3 to 500; and
k1 in formula (D) represents a number from 3 to 500.
   <6>

The article according to <4> or <5>, wherein q1 in formula (C) represents an integer from 1 to 4; and
each q1 in formula (D) independently represents an integer from 1 to 4.
   <7>

The article according to any one of <1> to <6>, wherein the substrate is glass.

<8>

The article according to any one of <1> to <7>, given as an optical component.

<9>

The article according to any one of <1> to <8>, given as a display or a touch panel.

<10>

A method of producing an article, the method includes: subjecting a substrate to surface treatment with use of a surface treatment agent, to produce an article having the substrate and a surface treatment layer formed thereon,
the surface treatment layer has a surface roughness Sdr of 30% or larger within any measurement area of from 5 to 50 μm squares, and
the surface treatment agent contains a compound having a linear organo(poly)siloxane residue and a reactive silyl group.
   <11>

The method of producing an article according to <10>, wherein the substrate has a surface roughness Sdr of 30% or larger within any measurement area of from 5 to 50 μm squares.

<12>

The method of producing an article according to <10> or <11>, wherein the reactive silyl group is represented by formula (S1):

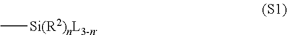

In formula (S1),
each R² independently represents a hydrocarbon group;
each L independently represents a hydrolyzable group, a group having a hydrolyzable group, or a hydroxy group; and
n represents an integer from 0 to 2.
   <13>

The method of producing an article according to any one of <10> to <12>, wherein the linear organo(poly)siloxane residue is represented by formula (B1) below:

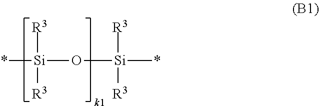

In formula (B1),
each R³ independently represents a hydrocarbon group;
k1 represents a number of 1 or larger; and
indicates a bonding site with a neighboring atom.
   <14>

The method of producing an article according to any one of <10> to <13>, wherein the compound having a linear organo(poly)siloxane residue and a reactive silyl group is represented by formula (C) or (D) below:

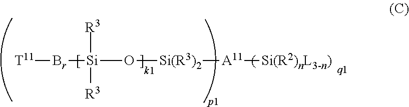

In formula (C),
T¹¹ represents a monovalent group that does not contain a reactive silyl group;
each B independently represents —O— or —C(═O)—;
each r independently represents 0 or 1;
each R³ independently represents a hydrocarbon group;
each k1 independently represents a number of 1 or larger;
p1 represents an integer of 1 or larger,
A¹¹ represents a (p1+q1)-valent linking group;
q1 represents an integer of 1 or larger,
each R² independently represents a hydrocarbon group;
each L independently represents a hydrolyzable group, a group having a hydrolyzable group, or a hydroxy group; and
each n independently represents an integer from 0 to 2.

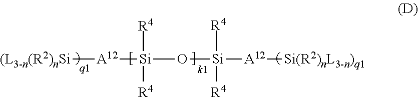

In formula (D),
each R⁴ independently represents a hydrocarbon group or T¹¹-Bᵣ—(SiR³₂—O)ₖ₁—,
each T¹¹ independently represents a monovalent group;
each B independently represents —O— or —C(═O)—;
each r independently represents 0 or 1,
each R³ independently represents a hydrocarbon group;
each k1 independently represents a number of 1 or larger;
each A¹² independently represents a (q1+1)-valent linking group;
each q1 independently represents an integer of 1 or larger;
each R² independently represents a hydrocarbon group;
each L independently represents a hydrolyzable group, a group having a hydrolyzable group, or a hydroxy group; and
each n independently represents an integer from 0 to 2.

The disclosure of Japanese Patent Application No. 2023-174764 filed on Oct. 6, 2023 is incorporated herein by reference in its entirety. All documents, patent applications, and technical standards described in this specification are incorporated herein by reference to the same extent as if each document, patent application, and technical standard were specifically and individually indicated to be incorporated by reference.

1. An article comprising a substrate, and a surface treatment layer arranged on the substrate and having a surface treated with a surface treatment agent,
the surface treatment layer having a surface roughness Sdr of 30% or larger within any measurement area of from 5 to 50 μm squares, and
the surface treatment agent containing a compound having a chain group and a reactive silyl group.

2. The article according to claim 1, wherein the compound having a chain group and a reactive silyl group is a compound having a linear organo(poly)siloxane residue and the reactive silyl group.

3. The article according to claim 1, wherein the reactive silyl group is represented by the following formula (S1) or (S3): 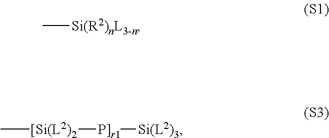
wherein, in formula (S1),
each R² independently represents a hydrocarbon group,
each L independently represents a hydrolyzable group, a group having a hydrolyzable group, or a hydroxy group, and
n represents an integer from 0 to 2; and
wherein, in formula (S3),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms, and
r1 represents an integer from 1 to 3.

4. The article according to claim 2, wherein the linear organo(poly)siloxane residue is represented by the following formula (B1): 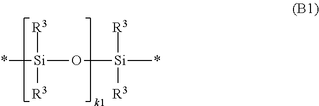
wherein, in formula (B1),
each R³ independently represents a hydrocarbon group,
k1 represents a number of 1 or larger, and
* indicates a bonding site with a neighboring atom.

5. The article according to claim 1, wherein the compound having a chain group and a reactive silyl group is represented by the following formula (C), (C2), (D), (D2), (E), or (E2): 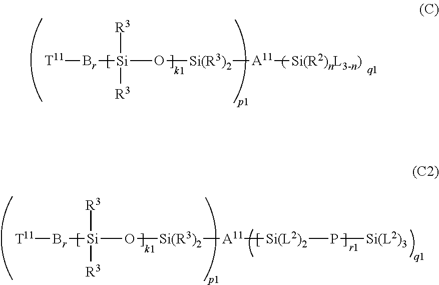
wherein, in formula (C),
T¹¹ represents a monovalent group that does not contain a reactive silyl group,
each B independently represents —O— or —C(═O)—,
each r independently represents 0 or 1,
each R³ independently represents a hydrocarbon group,
each k1 independently represents a number of 1 or larger,
p1 represents an integer of 1 or larger,
A¹¹ represents a (p1+q1)-valent linking group,
q1 represents an integer of 1 or larger,
each R² independently represents a hydrocarbon group,
each L independently represents a hydrolyzable group, a group having a hydrolyzable group, or a hydroxy group, and
each n independently represents an integer from 0 to 2;
wherein, in formula (C2),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms,
r1 represents an integer from 1 to 3, and
definitions for T¹¹, B, r, R³, k1, p1, A¹¹, and q1 are the same as definitions thereof in formula (C); 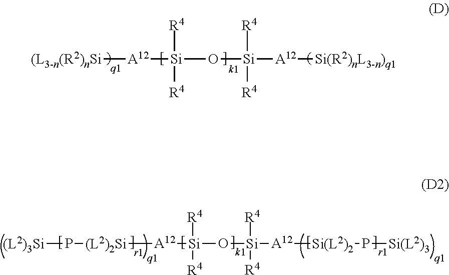
wherein, in formula (D),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number of 1 or larger,
each A¹² independently represents a (q1+1)-valent linking group,
each q1 independently represents an integer of 1 or larger,
each R² independently represents a hydrocarbon group,
each L independently represents a hydrolyzable group, a group having a hydrolyzable group, or a hydroxy group, and
each n independently represents an integer from 0 to 2;
wherein, in formula (D2),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms,
each r1 independently represents an integer from 1 to 3, and
definitions for R⁴, k1, A¹², and q1 are the same as definitions thereof in formula (D); 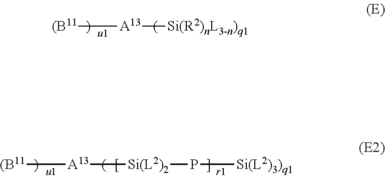
wherein, in formula (E),
B¹¹ represents a monovalent group having at least one selected from the group consisting of Si, Ge, and Sn to which a hydroxy group or a hydrolyzable group is not directly bonded, or a monovalent group having a branched alkyl group,
u1 represents an integer of 1 or larger,
A¹³ represents a (q1+u1)-valent linking group,
q1 represents an integer of 1 or larger,
each R² independently represents a hydrocarbon group,
each L independently represents a hydrolyzable group, a group having a hydrolyzable group, or a hydroxy group, and
each n independently represents an integer from 0 to 2; and
wherein, in formula (E2),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms,
each r1 independently represents an integer from 1 to 3, and
definitions of B¹¹, u1, A¹³, and q1 are the same as definitions thereof in formula (E).

6. The article according to claim 5, wherein:
k1 in formulae (C) and (C2) represents a number from 3 to 500; and
k1 in formulae (D) and (D2) represents a number from 3 to 500.

7. The article according to claim 5, wherein:
q1 in formulae (C), (C2), (E), and (E2) represents an integer from 1 to 4; and
each q1 in formulae (D) and (D2) independently represents an integer from 1 to 4.

8. The article according to claim 1, wherein the substrate is glass.

9. The article according to claim 1, which is an optical component.

10. The article according to claim 1, which is a display or a touch panel.

11. A method of producing an article, the method comprising: subjecting a substrate to surface treatment with use of a surface treatment agent, to produce an article having the substrate and a surface treatment layer formed thereon,
the surface treatment layer having a surface roughness Sdr of 30% or larger within any measurement area of from 5 to 50 μm squares, and
the surface treatment agent containing a compound having a chain group and a reactive silyl group.

12. The method of producing an article according to claim 11, wherein the compound having a chain group and a reactive silyl group is a compound having a linear organo(poly)siloxane residue and the reactive silyl group.

13. The method of producing an article according to claim 11, wherein the substrate has a surface roughness Sdr of 30% or larger within any measurement area of from 5 to 50 μm squares.

14. The method of producing an article according to claim 11, wherein the reactive silyl group is represented by the following formula (S1) or (S3): 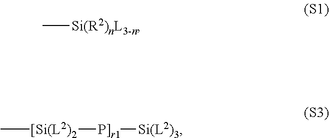
wherein, in formula (S1),
each R² independently represents a hydrocarbon group,
each L independently represents a hydrolyzable group, a group having a hydrolyzable group, or a hydroxy group, and
n represents an integer from 0 to 2; and
wherein, in formula (S3),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms, and
r1 represents an integer from 1 to 3.

15. The method of producing an article according to claim 12, wherein the linear organo(poly)siloxane residue is represented by the following formula (B1): 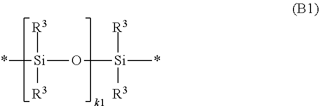
wherein, in formula (B1),
each R³ independently represents a hydrocarbon group,
k1 represents a number of 1 or larger, and
* indicates a bonding site with a neighboring atom.

16. The method of producing an article according to claim 11, wherein the compound having a chain group and a reactive silyl group is represented by the following formula (C), (C2), (D), (D2), (E), or (E2): 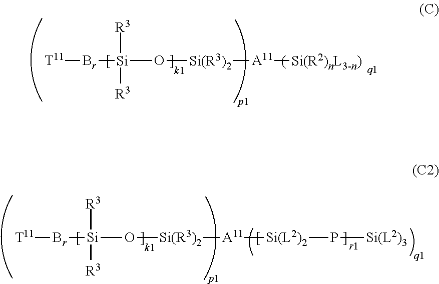
wherein, in formula (C),
T¹¹ represents a monovalent group that does not contain a reactive silyl group,
each B independently represents —O— or —C(═O)—,
each r independently represents 0 or 1,
each R³ independently represents a hydrocarbon group,
each k1 independently represents a number of 1 or larger,
p1 represents an integer of 1 or larger,
A¹¹ represents a (p1+q1)-valent linking group,
q1 represents an integer of 1 or larger,
each R² independently represents a hydrocarbon group,
each L independently represents a hydrolyzable group, a group having a hydrolyzable group, or a hydroxy group, and
each n independently represents an integer from 0 to 2;
wherein, in formula (C2),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms,
r1 represents an integer from 1 to 3, and
definitions for T¹¹, B, r, R³, k1, p1, A¹¹, and q1 are the same as definitions thereof in formula (C); 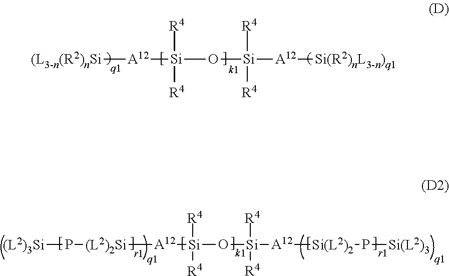
wherein, in formula (D),
each R⁴ independently represents a hydrocarbon group or T¹¹-Bᵣ—(SiR³₂—O)ₖ₁—,
each T¹¹ independently represents a monovalent group,
each B independently represents —O— or —C(═O)—,
each r independently represents 0 or 1,
each R³ independently represents a hydrocarbon group,
each k1 independently represents a number of 1 or larger,
each A¹² independently represents a (q1+1)-valent linking group,
each q1 independently represents an integer of 1 or larger,
each R² independently represents a hydrocarbon group,
each L independently represents a hydrolyzable group, a group having a hydrolyzable group, or a hydroxy group, and
each n independently represents an integer from 0 to 2;
wherein, in formula (D2),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms,
each r1 independently represents an integer from 1 to 3, and
definitions for R⁴, k1, A¹², and q1 are the same as definitions thereof in formula (D); 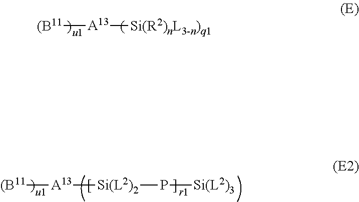
wherein, in formula (E),
B¹¹ represents a monovalent group having at least one selected from the group consisting of Si, Ge, and Sn to which a hydroxy group or a hydrolyzable group is not directly bonded, or a monovalent group having a branched alkyl group,
u1 represents an integer of 1 or larger,
A¹³ represents a (q1+u1)-valent linking group,
q1 represents an integer of 1 or larger,
each R² independently represents a hydrocarbon group,
each L independently represents a hydrolyzable group, a group having a hydrolyzable group, or a hydroxy group, and
each n independently represents an integer from 0 to 2; and
wherein, in formula (E2),
each L² independently represents a hydrolyzable group, a group having a hydrolyzable group, a hydroxy group, or a hydrocarbon group,
each of at least four L²s among all L²s represents a hydrolyzable group, a group having a hydrolyzable group, or a hydroxy group,
each P independently represents an oxygen atom, or an organic group having one carbon atom bonded to both neighboring Si atoms,
each r1 independently represents an integer from 1 to 3, and
definitions of B¹¹, u1, A¹³, and q1 are the same as definitions thereof in formula (E).
